(19) United States
(12) Patent Application Publication
(10) Pub. No.: US 2026/0273750 A1
(43) Pub. Date: Sep. 17, 2026

(54) ACTION CONTROL SYSTEM

(71) Applicant: SOFTBANK GROUP CORP., Minato-ku, Tokyo (JP)

(72) Inventors: Masayoshi SON, Minato-ku, Tokyo (JP); Tatsuhiko HATA, Minato-ku, Tokyo (JP); Tomokazu NAKAYA, Minato-ku, Tokyo (JP); Shinichiro KARATSU, Minato-ku, Tokyo (JP); Ryosuke TAKATSU, Minato-ku, Tokyo (JP)

(73) Assignee: SOFTBANK GROUP CORP., Minato-ku, Tokyo (JP)

(21) Appl. No.: 19/473,542

(22) PCT Filed: Apr. 9, 2024
(86) PCT No.: PCT/JP2024/014439

§ 371 Date: Oct. 8, 2025

(30) Foreign Application Priority Data
Apr. 10, 2023 (JP) 2023-063774
Apr. 17, 2023 (JP) 2023-067458
Apr. 21, 2023 (JP) 2023-070392
Apr. 21, 2023 (JP) 2023-070472
Apr. 21, 2023 (JP) 2023-070473
Apr. 21, 2023 (JP) 2023-070474
Apr. 28, 2023 (JP) 2023-074697
Apr. 28, 2023 (JP) 2023-074836
May 10, 2023 (JP) 2023-078119
May 10, 2023 (JP) 2023-078142
May 15, 2023 (JP) 2023-080390
May 18, 2023 (JP) 2023-082611

(51) Int. Cl. B25J 9/16; A63H 3/02; B25J 11/00; B25J 13/00; G06Q 20/40; G06V 40/16; G10L 15/22; G10L 25/63

(52) U.S. Cl. CPC B25J 9/1674; A63H 3/02; B25J 11/001; B25J 13/003; G06Q 20/4016; G06V 40/174; G10L 15/22; G10L 25/63; A63H 2200/00

(57) ABSTRACT

An action control system includes: an emotion determination unit that determines an emotion of a user or an emotion of a robot; and an action determination unit that generates an action content of the robot for an action of the user and the emotion of the user or the emotion of the robot based on a sentence generation model having a dialogue function that causes the user and the robot to have a dialogue with each other, and determines an action of the robot corresponding to the action content. The action determination unit determines whether or not the action of the user is dangerous by detecting the action of the user, and generates a first action content for correcting the action of the user in a case where the action of the user is dangerous.

### TECHNICAL FIELD

The present invention relates to an action control system.

### BACKGROUND ART

Patent Literature 1 discloses a technology for determining an appropriate action of a robot for a state of a user. In the related art of Patent Literature 1, a reaction of the user in a case where the robot performs a specific action is recognized, and in a case where an action of the robot for the recognized reaction of the user cannot be determined, the action of the robot is updated by receiving information regarding an action appropriate for a recognized state of the user from a server.

As technologies related to customer service, such as table management in a restaurant, for example, a technology for training a robot according to a situation and an emotion of a customer at the time of customer service (see, for example, Patent Literature 2), a technology for determining the order of customer service according to the degree of interest of the customer in a robot (see, for example, Patent Literature 3), and a technology for calculating a level of satisfaction with customer service (see, for example, Patent Literature 4) are known. In addition, technologies for generating an emotion of a robot (see, for example, Patent Literatures 5 to 7) and technologies for recognizing an emotion of a user (see, for example, Patent Literatures 8 and 9) are known.

Even in a case where a staff witnesses a customer action suspected of suffering from special fraud, such as purchasing a high-value prepaid card or operating an asynchronous transfer mode (ATM) while talking on a phone at a convenience store, the staff often hesitates to speak to the customer for fear of making an incorrect judgment or being ignored by the customer. Therefore, as a technology for detecting a special fraud risk, for example, a technology for detecting a special fraud risk involving the use of a telephone (see, for example, Patent Literature 10) and a technology for detecting a special fraud risk and outputting an alert message for remittance fraud on a screen in a case where emotion recognition is performed by an automated teller machine such as the ATM and emotions such as confusion and agitation are recognized (see, for example, Patent Literature 11) are known. In addition, technologies for generating an emotion of a robot (see, for example, Patent Literatures 5 to 7) and technologies for recognizing an emotion of a user (see, for example, Patent Literatures 8 and 9) are known.

### CITED LITERATURE

### Patent Literature

Patent Literature 1: Japanese Patent No. 6053847
Patent Literature 2: Japanese Patent Application Laid-Open No. 2019-018265
Patent Literature 3: Japanese Patent Application Laid-Open No. 2009-248193
Patent Literature 4: Japanese Patent Application Laid-Open No. 2011-210133
Patent Literature 5: Japanese Patent No. 6273314
Patent Literature 6: Japanese Patent No. 6273313
Patent Literature 7: Japanese Patent No. 6199927
Patent Literature 8: Japanese Patent No. 3676969
Patent Literature 9: Japanese Patent No. 4704952
Patent Literature 10: Japanese Patent Application Laid-Open No. 2019-153961
Patent Literature 11: Japanese Patent Application Laid-Open No. 2021-092952

### SUMMARY OF INVENTION

### Technical Problem

However, in the related art, there is room for improvement in causing the robot to perform an appropriate action for an action of the user.

Further, in the related art, appropriate customer service cannot be provided in some cases. For example, in the related art, a risk caused by a troublesome customer or the like is not considered at all, and thus, it may not be possible to cause a staff to provide a space that makes a customer feel that he/she “wants to visit again”.

In addition, in the related art, a special fraud risk cannot be detected with high accuracy in some cases.

For example, in the related art, erroneous risk detection may be performed because a risk determination result is reported without confirmation from a customer in a case where it is determined that the risk is high.

### Solution to Problem

According to a first aspect of the disclosure, an action control system is provided. The action control system includes: an emotion determination unit that determines an emotion of a user or an emotion of a robot; and an action determination unit that generates an action content of the robot for an action of the user and the emotion of the user or the emotion of the robot based on a dialogue function of causing the user and the robot to have a dialogue with each other, and determines an action of the robot corresponding to the action content, in which the action determination unit determines whether or not the action of the user is dangerous by detecting the action of the user, and generates a first action content for correcting the action of the user in a case where the action of the user is dangerous.

According to a second aspect of the invention, an action control system is provided. The action control system includes: an emotion determination unit that determines an emotion of a user or an emotion of a robot; and an action determination unit that generates an action content of the robot for an action of the user and the emotion of the user or the emotion of the robot based on a sentence generation model having a dialogue function of causing the user and the robot to have a dialogue with each other, and determines an action of the robot corresponding to the action content, in which the action determination unit receives statements of a plurality of the users having a conversation, and determines, as the action of the robot, to summarize contents of the statements in a case where the statements are in a predetermined state.

In a third aspect, the state is a state in which the statements are no longer received for a predetermined time.

In a fourth aspect, the state is a state in which a term included in the statement is received a predetermined number of times.

In a fifth aspect, the robot is mounted on a stuffed toy or is connected wirelessly or by wire to control target equipment mounted on a stuffed toy.

According to a sixth aspect of the invention, an action control system is provided. The action control system includes: an emotion determination unit that determines an emotion of a user or an emotion of a robot; and an action determination unit that generates an action content of the robot for an action of the user and the emotion of the user or the emotion of the robot based on a dialogue function of causing the user and the robot to have a dialogue with each other, and determines an action of the robot corresponding to the action content, in which the robot is set at customs, and the action determination unit acquires an image of a person acquired by an image sensor and an odor detection result of an odor sensor, and determines, as the action of the robot, to make a notification to a tax inspector in a case where a preset abnormal action, an abnormal facial expression, or an abnormal odor is detected.

According to a seventh aspect of the invention, an action control system is provided. The action control system includes: a user state recognition unit that recognizes a user state including an action of a user; an emotion determination unit that determines an emotion of the user or an emotion of a robot; and an action determination unit that determines an action of the robot corresponding to the user state and a conversation content of a plurality of the users based on a sentence generation model having a dialogue function of causing the user and the robot to have a dialogue with each other. The action determination unit determines a special fraud risk based on the conversation content of the plurality of users and the emotions of the users.

According to an eighth aspect of the invention, an action control system is provided. The action control system includes: a user state recognition unit that recognizes user states including actions of a plurality of users; an emotion determination unit that determines emotions of the plurality of users or an emotion of a robot; and an action determination unit that determines an action of the robot corresponding to the user states and a conversation content of the plurality of users based on a sentence generation model having a dialogue function of causing the user and the robot to have a dialogue with each other. The action determination unit detects a specific incident based on the conversation content of the plurality of users and the emotions of the users.

According to a ninth aspect of the invention, an action control system is provided. The action control system includes: a user state recognition unit that recognizes a user state including an action of a user; an emotion determination unit that determines an emotion of the user or an emotion of a robot; and an action determination unit that determines an action of the robot corresponding to the user state and the emotion of the user or the emotion of the robot based on a sentence generation model having a dialogue function of causing the user and the robot to have a dialogue with each other. The action determination unit performs childcare for the user based on at least one of the user state and the emotion of the user.

According to a tenth aspect of the invention, an action control system is provided. The action control system includes: a state recognition unit that recognizes a user state including an action of a user and a state of electronic equipment; an emotion determination unit that determines an emotion of the user or an emotion of the electronic equipment; an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing; and a storage control unit that stores, in history data, event data including an emotion value determined by the emotion determination unit and data including the action of the user, in which the equipment operation includes provision of advice on caregiving to the user, and in a case where the action determination unit determines, as the action of the electronic equipment, to provide the advice on caregiving to the user, the action determination unit collects information regarding caregiving for the user and provides the advice on caregiving for the user based on the collected information.

Here, a robot includes a device that performs a physical operation, a device that outputs a video or a sound without performing a physical operation, and an agent that operates on software.

According to an eleventh aspect of the invention, an action control system is provided. The action control system includes: a state recognition unit that recognizes a user state including an action of a user and a state of electronic equipment; an emotion determination unit that determines an emotion of the user or an emotion of the electronic equipment; an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing; and a storage control unit that stores, in history data, event data including an emotion value determined by the emotion determination unit and data including the action of the user, in which the equipment operation includes notification of information based on the emotion of the user for an item provided by a provider to the provider, and in a case where the action determination unit determines, as the action of the electronic equipment, to notify the provider of the information based on the emotion of the user for the item provided by the provider, the action determination unit notifies the provider of the information based on the emotion of the user for the item provided by the provider.

According to a twelfth aspect of the invention, an action control system is provided. The action control system includes: a state recognition unit that recognizes a user state including an action of a user and a state of electronic equipment; an emotion determination unit that determines an emotion of the user or an emotion of the electronic equipment; and an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing, in which the equipment operation includes provision of advice on a fraud risk to the user, and in a case where the action determination unit determines, as the action of the electronic equipment, to provide the advice on a fraud risk to the user, the action determination unit provides the advice on a fraud risk to the user.

According to a thirteenth aspect of the invention, an action control system is provided. The action control system includes: a state recognition unit that recognizes a user state including an action of a user and a state of electronic equipment; an emotion determination unit that determines an emotion of the user or an emotion of the electronic equipment; and an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing. The equipment operation includes provision of advice on a risk approaching the user, and in a case where the action determination unit determines, as the action of the electronic equipment, to provide the advice on a risk approaching the user, the action determination unit provides the advice on a risk approaching the user.

A notification device according to a fourteenth aspect of the invention includes: an acquisition unit that acquires at least one of customer information regarding a customer of a store, store information regarding the store, and order information regarding an order placed at the store; an analysis unit that analyzes a risk based on at least one of the customer information, the store information, and the order information which are acquired by the acquisition unit; and a notification unit that notifies of the risk analyzed by the analysis unit.

A notification method according to a fifteenth aspect of the invention is a notification method executed by a notification device, the notification method including: an acquisition step of acquiring at least one of customer information regarding a customer of a store, store information regarding the store, and order information regarding an order placed at the store; an analysis step of analyzing a risk based on at least one of the customer information, the store information, and the order information which are acquired in the acquisition step; and a notification step of notifying of the risk analyzed in the analysis step.

A notification program according to a sixteenth aspect of the invention causes a computer to execute: an acquisition step of acquiring at least one of customer information regarding a customer of a store, store information regarding the store, and order information regarding an order placed at the store; an analysis step of analyzing a risk based on at least one of the customer information, the store information, and the order information which are acquired in the acquisition step; and a notification step of notifying of the risk analyzed in the analysis step.

According to one aspect of the invention, it is possible to provide appropriate customer service.

A determination device according to a seventeenth aspect of the invention includes: an acquisition unit that acquires at least one of imaging data obtained by imaging a customer in a store, attribute data regarding an attribute of the customer, and conversation data regarding a conversation of the customer; a determination unit that determines a special fraud risk for the customer based on at least one of the imaging data, the attribute data, and the conversation data which are acquired by the acquisition unit; and a conversation unit that has a conversation regarding the risk determined by the determination unit with the customer.

A determination method according to an eighteenth aspect of the invention is a determination method executed by a determination device, the determination method including: an acquisition step of acquiring at least one of imaging data obtained by imaging a customer in a store, attribute data regarding an attribute of the customer, and conversation data regarding a conversation of the customer; a determination step of determining a special fraud risk for the customer based on at least one of the imaging data, the attribute data, and the conversation data which are acquired in the acquisition step; and a conversation step of having a conversation regarding the risk determined in the determination step with the customer.

A determination program according to a nineteenth aspect of the invention causes a computer to execute: an acquisition step of acquiring at least one of imaging data obtained by imaging a customer in a store, attribute data regarding an attribute of the customer, and conversation data regarding a conversation of the customer; a determination step of determining a special fraud risk for the customer based on at least one of the imaging data, the attribute data, and the conversation data which are acquired in the acquisition step; and a conversation step of having a conversation regarding the risk determined in the determination step with the customer.

According to an aspect of the invention, a risk of special fraud can be detected with high accuracy.

### BRIEF DESCRIPTION OF DRAWINGS

FIG. 1 schematically shows an example of a system 5 according to the present embodiment.

FIG. 2 schematically shows a functional configuration of a robot 100.

FIG. 3 schematically shows an example of an operation flow of the robot 100.

FIG. 4 schematically shows an example of a hardware configuration of a computer 1200.

FIG. 5 shows an emotion map 400 in which a plurality of emotions are mapped.

FIG. 6 shows an emotion map 900 in which a plurality of emotions are mapped.

FIG. 7(A) is an external view of a stuffed toy according to another embodiment, and FIG. 7(B) is an internal structural view of the stuffed toy.

FIG. 8 is a rear front view of the stuffed toy according to another embodiment.

FIG. 9A schematically shows a functional configuration of a robot 100 according to a second embodiment.

FIG. 9B schematically shows an example of an operation flow of collection processing performed by the robot 100 according to the second embodiment.

FIG. 9C schematically shows an example of an operation flow of autonomous processing performed by the robot 100 according to the second embodiment.

FIG. 9D schematically shows a functional configuration of a stuffed toy 100N according to a third embodiment.

FIG. 9E schematically shows a functional configuration of an agent system 2500 according to a fourth embodiment.

FIG. 9F shows an example of an operation of the agent system.

FIG. 9G shows an example of an operation of the agent system.

FIG. 9H schematically shows a functional configuration of smart glasses 2700 according to a fifth embodiment.

FIG. 9I shows an example of a usage aspect of an agent system in smart glasses.

FIG. 10A is a block diagram showing an example of a configuration of a notification device 3010.

FIG. 10B is a diagram for describing an example of the notification device 3010.

FIG. 10C is a flowchart showing an example of a flow of processing performed by the notification device 3010.

FIG. 11A is a block diagram showing an example of a configuration of a determination device 4010.

FIG. 11B is a diagram for describing an example of the determination device 4010.

FIG. 11C is a flowchart showing an example of a flow of processing performed by the determination device 4010.

### DESCRIPTION OF EMBODIMENTS

Hereinafter, the present invention will be described through embodiments of the invention, but the following embodiments do not limit the invention according to the claims. In addition, not all combinations of features described in the embodiments are essential to the solution of the invention.

### First Embodiment

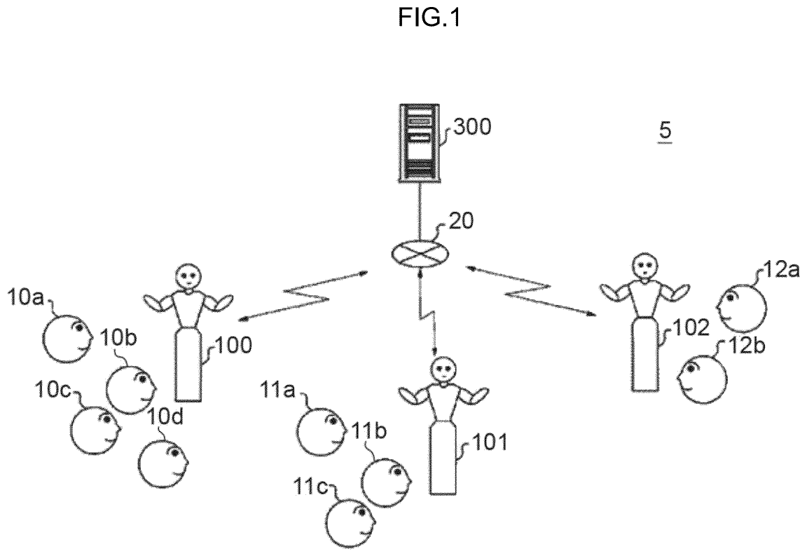

FIG. 1 schematically shows an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. In the description of the present embodiment, the user 10a, the user 10b, the user 10c, and the user 10d may be collectively referred to as the user 10. Further, the user 11a, the user 11b, and the user 11c may be collectively referred to as the user 11. Further, the user 12a and the user 12b may be collectively referred to as the user 12. The robot 101 and the robot 102 have substantially the same functions as that of the robot 100. Therefore, the system 5 will be described focusing on the function of the robot 100.

The robot 100 has a conversation with the user 10 and provides a video to the user 10. At this time, the robot 100 has a conversation with the user 10, provides a video to the user 10, and the like in cooperation with the server 300 and the like that can perform communication via a communication network 20. For example, the robot 100 not only learns an appropriate conversation by itself, but also performs learning to have a more appropriate conversation with the user 10 in cooperation with the server 300. Further, the robot 100 causes the server 300 to record captured video data and the like of the user 10, requests the server 300 to transmit the video data and the like if necessary, and provides the video data and the like to the user 10.

Further, the robot 100 has an emotion value representing a type of an emotion thereof. For example, the robot 100 has the emotion value representing an intensity of each of emotions “joy”, “anger”, “sorrow”, “pleasure”, “comfort”, “discomfort”, “relief”, “anxiety”, “sadness”, “excitement”, “worry”, “reassurance”, “sense of fulfillment”, “sense of emptiness”, and “neutral”. For example, in the case of having a conversation with the user 10 in a state in which the emotion value of excitement is large, the robot 100 utters a speech at a high speed. As described above, the robot 100 can express the emotion thereof by an action.

Further, the robot 100 may be configured to determine an action of the robot 100 corresponding to an emotion of the user 10 by matching a sentence generation model and an emotion engine using an artificial intelligence (AI). Specifically, the robot 100 may be configured to recognize an action of the user 10, determine the emotion of the user 10 for the action of the user, and determine the action of the robot 100 corresponding to the determined emotion.

More specifically, in a case where the action of the user 10 is recognized, the robot 100 automatically generates a content of an action to be performed by the robot 100 for the action of the user 10 using the preset sentence generation model. The sentence generation model may be interpreted as an algorithm and operation for text-based automatic dialogue processing. Since the sentence generation model is known as disclosed in, for example, Japanese Patent Application Laid-Open No. 2018-081444 and chatGPT (Internet search <URL: https://openai.com/blog/chatgpt>), a detailed description thereof is omitted. Such a sentence generation model is implemented by a large language model (LLM).

As described above, in the present embodiment, it is possible to reflect the emotions of the user 10 and the robot 100 and various types of linguistic information in the action of the robot 100 by combining the large language model and the emotion engine. That is, according to the present embodiment, a synergistic effect can be obtained by combining the sentence generation model and the emotion engine.

Further, the robot 100 has a function of recognizing the action of the user 10. The robot 100 recognizes the action of the user 10 by analyzing a face image of the user 10 acquired by a camera function and a speech of the user 10 acquired by a microphone function. The robot 100 determines an action to be performed by the robot 100 based on the recognized action of the user 10 or the like.

The robot 100 stores a rule setting an action to be performed by the robot 100 based on the emotion of the user 10, the emotion of the robot 100, and the action of the user 10, and performs various actions according to the rule.

Specifically, the robot 100 has a reaction rule for determining the action of the robot 100 based on the emotion of the user 10, the emotion of the robot 100, and the action of the user 10. In the reaction rule, for example, an action of “laughing” is set as the action of the robot 100 for a case where the action of the user 10 is “laughing”. Further, in the reaction rule, an action of “apologizing” is set as the action of the robot 100 for a case where the action of the user 10 is “getting angry”. Further, in the reaction rule, an action of “answering” is set as the action of the robot 100 for a case where the action of the user 10 is “asking a question”. In the reaction rule, an action of “calling out” is set as the action of the robot 100 for a case where the action of the user 10 is “being sad”.

In a case where the robot 100 recognizes that the action of the user 10 is “getting angry”, the robot 100 selects the action of “apologizing” set in the reaction rule as an action to be performed by the robot 100 based on the reaction rule. For example, in a case where the action of “apologizing” is selected, the robot 100 performs the action of “apologizing” and outputs a speech representing words of “apology”.

Further, in a case where a condition that the emotion of the robot 100 is “neutral” (that is, “joy”=0, “anger”=0, “sorrow”=0, and “pleasure”=0) and a state of the user 10 is “alone and looking lonely” is satisfied, a content of a change in the emotion of the robot 100 to “worried” is determined, and it is determined that the action of “calling out” can be performed.

In a case where the robot 100 recognizes that the current emotion of the robot 100 is “neutral” and the user 10 is alone and looks lonely, the emotion value of “sorrow” of the robot 100 is increased based on the reaction rule. Further, the robot 100 selects the action of “calling out” set in the reaction rule as an action to be performed for the user 10. For example, in a case where the action of “calling out” is selected, the robot 100 converts a phrase “What's wrong?” expressing that the robot 100 is worried into a sympathetic voice, and outputs the voice.

Further, the robot 100 transmits, to the server 300, user reaction information indicating that a positive reaction has been obtained from the user 10 for the action. Examples of the user reaction information include the user action of “getting angry”, the action of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. Then, the server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into the reaction rule thereof.

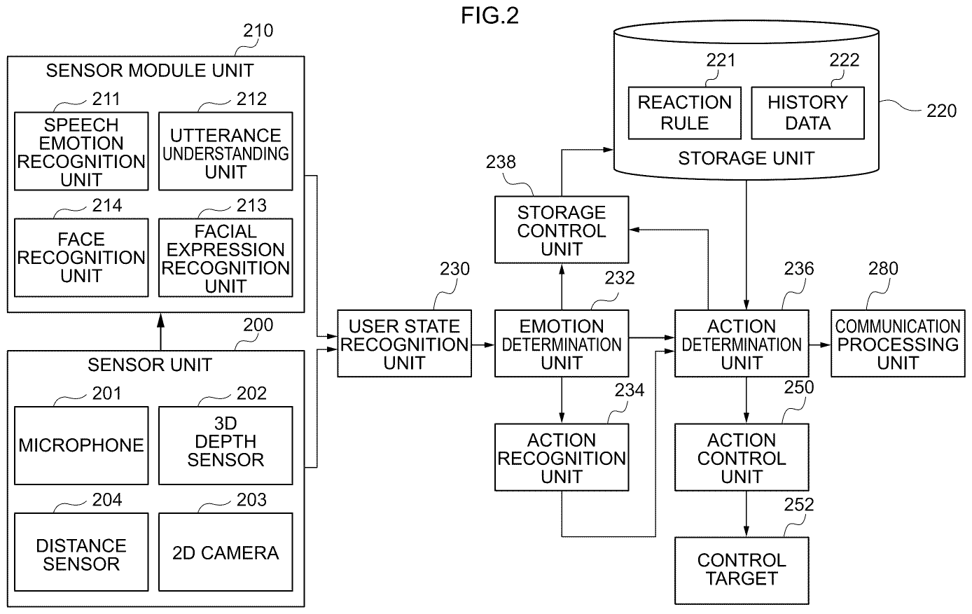

FIG. 2 schematically shows a functional configuration of the robot 100. The robot 100 includes a sensor unit 200, a sensor module unit 210, a storage unit 220, a user state recognition unit 230, an emotion determination unit 232, an action recognition unit 234, an action determination unit 236, a storage control unit 238, an action control unit 250, a control target 252, and a communication processing unit 280.

The control target 252 includes a display device, a speaker, a light emitting diode (LED) of an eye portion, motors that drive an arm, a hand, a foot, and the like, and the like. A posture and a gesture of the robot 100 are controlled by controlling the motors for the arm, the hand, the foot, and the like. Some emotions of the robot 100 can be expressed by controlling the motors. Furthermore, a facial expression of the robot 100 can be expressed by controlling a light emission state of the LED of the eye portion of the robot 100. The posture, the gesture and the facial expression of the robot 100 are examples of an attitude of the robot 100.

The sensor unit 200 includes a microphone 201, a 3D depth sensor 202, a 2D camera 203, and a distance sensor 204. The microphone 201 continuously detects a speech and outputs speech data. The microphone 201 may be provided at a head portion of the robot 100 and may have a function of performing binaural recording. The 3D depth sensor 202 detects an outline of an object by continuously radiating an infrared pattern and analyzing the infrared pattern based on an infrared image continuously captured by an infrared camera. The 2D camera 203 is an example of an image sensor. The 2D camera 203 performs imaging with visible light and generates video information of visible light. The distance sensor 204 detects a distance to an object by emitting, for example, a laser beam or an ultrasonic wave. The sensor unit 200 may further include a clock, a gyro sensor, a touch sensor, a sensor for motor feedback, and the like.

Among the components of the robot 100 shown in FIG. 2, the components other than the control target 252 and the sensor unit 200 are examples of components included in an action control system included in the robot 100. The action control system of the robot 100 controls the control target 252.

The storage unit 220 includes a reaction rule 221 and history data 222. The history data 222 includes a history of the past emotion value and action of the user 10. The history of the emotion value and the action is recorded for each user 10 by being associated with identification information of the user 10, for example. At least a part of the storage unit 220 is implemented by a storage medium such as a memory. A person DB that stores a face image of the user 10, attribute information of the user 10, and the like may be included. Among the components of the robot 100 shown in FIG. 2, functions of the components other than the control target 252, the sensor unit 200, and the storage unit 220 can be implemented by a CPU operating based on a program. For example, the functions of the components can be implemented as an operation of the CPU by basic software (operating system (OS)) and a program operating on the OS.

The sensor module unit 210 includes a speech emotion recognition unit 211, an utterance understanding unit 212, a facial expression recognition unit 213, and a face recognition unit 214. Information detected by the sensor unit 200 is input to the sensor module unit 210. The sensor module unit 210 analyzes the information detected by the sensor unit 200 and outputs an analysis result to the user state recognition unit 230.

The speech emotion recognition unit 211 of the sensor module unit 210 analyzes a speech of the user 10 detected by the microphone 201 to recognize the emotion of the user 10. For example, the speech emotion recognition unit 211 extracts a feature amount such as a frequency component of a speech and recognizes the emotion of the user 10 based on the extracted feature amount. The utterance understanding unit 212 analyzes the speech of the user 10 detected by the microphone 201 and outputs text information indicating an utterance content of the user 10.

The facial expression recognition unit 213 recognizes a facial expression of the user 10 and the emotion of the user 10 from an image of the user 10 captured by the 2D camera 203. For example, the facial expression recognition unit 213 recognizes the facial expression and the emotion of the user 10 based on shapes, positional relationships, and the like of the eyes and the mouth.

The face recognition unit 214 recognizes the face of the user 10. The face recognition unit 214 recognizes the user 10 by matching a face image stored in the person DB (not shown) with a face image of the user 10 captured by the 2D camera 203.

The user state recognition unit 230 recognizes a state of the user 10 based on the information analyzed by the sensor module unit 210. For example, processing mainly related to perception is performed using an analysis result of the sensor module unit 210. For example, perception information such as “Dad is alone” and “There is a 90% probability that dad is not smiling” is generated. Processing of understanding the meaning of the generated perception information is performed. For example, semantic information such as “Dad is alone and looks lonely” is generated.

The emotion determination unit 232 determines an emotion value indicating the emotion of the user 10 based on the information analyzed by the sensor module unit 210 and the state of the user 10 recognized by the user state recognition unit 230. For example, the emotion value indicating the emotion of the user 10 is acquired by inputting the information analyzed by the sensor module unit 210 and the recognized state of the user 10 to a neural network trained in advance.

Here, the emotion value indicating the emotion of the user 10 is a value indicating whether the emotion of the user is positive or negative. For example, the emotion value has a positive value in a case where the emotion of the user is a bright emotion accompanied by pleasure or a sense of calm, such as “joy”, “pleasure”, “comfort”, “relief”, “excitement”, “reassurance”, or “sense of fulfillment”, and the emotion value becomes larger as the emotion becomes brighter. The emotion value has a negative value in a case where the emotion of the user is an unpleasant emotion such as “anger”, “sorrow”, “discomfort”, “anxiety”, “sadness”, “worry”, or “sense of emptiness”, and the more unpleasant the emotion is, the larger the absolute value of the negative value becomes. In a case where the emotion of the user is not any of the above (“neutral”), the emotion value has a value of 0.

Further, the emotion determination unit 232 determines an emotion value indicating the emotion of the robot 100 based on the information analyzed by the sensor module unit 210 and the state of the user 10 recognized by the user state recognition unit 230.

The emotion value of the robot 100 includes an emotion value for each of a plurality of emotion classifications, and is, for example, a value (0 to 5) indicating an intensity of each of “joy”, “anger”, “sorrow”, and “pleasure”.

Specifically, the emotion determination unit 232 determines the emotion value indicating the emotion of the robot 100 according to a rule for updating the emotion value of the robot 100, the rule being set in association with the information analyzed by the sensor module unit 210 and the state of the user 10 recognized by the user state recognition unit 230.

For example, in a case where the user state recognition unit 230 recognizes that the user 10 looks lonely, the emotion determination unit 232 increases the emotion value of “sorrow” of the robot 100. Further, in a case where the user state recognition unit 230 recognizes that the user 10 is smiling, the emotion determination unit 232 increases the emotion value of “joy” of the robot 100.

The emotion determination unit 232 may determine the emotion value indicating the emotion of the robot 100 in further consideration of a state of the robot 100. For example, in a case where the remaining battery level of the robot 100 is low, a case where the surrounding environment of the robot 100 is dark, or the like, the emotion determination unit 232 may increase the emotion value of “sorrow” of the robot 100. Furthermore, in the case of the user 10 who continues to speak to the robot 100 despite the low remaining battery level, the emotion determination unit 232 may increase the emotion value of “anger”.

The action recognition unit 234 recognizes the action of the user 10 based on the information analyzed by the sensor module unit 210 and the state of the user 10 recognized by the user state recognition unit 230. For example, a probability of each of a plurality of predetermined action classifications (for example, “laughing”, “getting angry”, “asking a question”, and “being sad”) is acquired by inputting the information analyzed by the sensor module unit 210 and the recognized state of the user 10 to the neural network trained in advance, and an action classification having the highest probability is recognized as the action of the user 10.

As described above, in the present embodiment, the robot 100 acquires an utterance content of the user 10 after specifying the user 10, but in acquiring and using the utterance content, the action control system of the robot 100 according to the present embodiment considers protection of personal information and privacy of the user 10 in addition to acquisition of necessary consent according to laws and regulations from the user 10.

The action determination unit 236 determines an action corresponding to the action of the user 10 recognized by the action recognition unit 234, based on the current emotion value of the user 10 determined by the emotion determination unit 232, the history data 222 of the past emotion value determined by the emotion determination unit 232 before the current emotion value of the user 10 is determined, and the emotion value of the robot 100. In the present embodiment, a case where the action determination unit 236 uses one most recent emotion value included in the history data 222 as the past emotion value of the user 10 is described, but the disclosed technology is not limited to such an aspect. For example, the action determination unit 236 may use a plurality of most recent emotion values as the past emotion values of the user 10, or may use emotion values from a unit period earlier, such as one day ago, as the past emotion values of the user 10. Further, the action determination unit 236 may determine the action corresponding to the action of the user 10 in further consideration of the history of the past emotion value of the robot 100 in addition to the current emotion value of the robot 100. The action determined by the action determination unit 236 includes the gesture made by the robot 100 or an utterance content of the robot 100.

The action determination unit 236 according to the present embodiment determines, as the action corresponding to the action of the user 10, the action of the robot 100 based on a combination of the past emotion value and the current emotion value of the user 10, the emotion value of the robot 100, the action of the user 10, and the reaction rule 221. For example, in a case where the past emotion value of the user 10 is a positive value and the current emotion value is a negative value, the action determination unit 236 determines an action for positively changing the emotion value of the user 10 as the action corresponding to the action of the user 10.

In the reaction rule 221, the action of the robot 100 based on a combination of the past emotion value and the current emotion value of the user 10, the emotion value of the robot 100, and the action of the user 10 is set. For example, a combination of a gesture and an utterance content when encouraging the user 10 with a gesture is set as the action of the robot 100 in a case where the past emotion value of the user 10 is a positive value, the current emotion value is a negative value, and the action of the user 10 is being sad.

For example, in the reaction rule 221, actions of the robot 100 are set for all combinations of patterns of the emotion value of the robot 100 (1296 patterns which correspond to the fourth power of six values of “0” to “5” of “joy”, “anger”, “sorrow”, and “pleasure”), patterns of a combination of the past emotion value and the current emotion value of the user 10, and an action pattern of the user 10. That is, for each pattern of the emotion value of the robot 100, the action of the robot 100 based on the action pattern of the user 10 is determined for each of a plurality of combinations of the past emotion value and the current emotion value of the user 10, such as a combination of a negative value and a negative value, a combination of a negative value and a positive value, a combination of a positive value and a negative value, a combination of a positive value and a positive value, a combination of a negative value and a value indicating the neutral emotion, and a combination of a value indicating the neutral emotion and a value indicating the neutral emotion. The action determination unit 236 may transition to an operation mode of determining the action of the robot 100 by using the history data 222, for example, in a case where the user 10 has made an utterance that intends to continue a conversation of the past topic, such as “I want to talk about the topic we discussed earlier”.

In the reaction rule 221, at least one of a gesture and a statement content may be set as the action of the robot 100 for each pattern (1296 patterns) of the emotion value of the robot 100, with at most one action per pattern. Alternatively, in the reaction rule 221, at least one of the gesture and the statement content may be set as the action of the robot 100 for each group of the patterns of the emotion values of the robot 100.

An intensity of each gesture included in the action of the robot 100 and set in the reaction rule 221 is set in advance. An intensity of each utterance content included in the action of the robot 100 and set in the reaction rule 221 is set in advance.

The storage control unit 238 determines whether or not to store data including the action of the user 10 in the history data 222 based on a predetermined action intensity for the action determined by the action determination unit 236 and the emotion value of the robot 100 determined by the emotion determination unit 232.

Specifically, in a case where the total sum of the emotion values of the plurality of emotion classifications of the robot 100 and a total intensity value, which is the sum of the predetermined intensity for the gesture included in the action determined by the action determination unit 236 and the predetermined intensity for the utterance content included in the action determined by the action determination unit 236, are equal to or larger than thresholds, the storage control unit 238 determines to store the data including the action of the user 10 in the history data 222.

In a case where the storage control unit 238 determines to store the data including the action of the user 10 in the history data 222, the action determined by the action determination unit 236, the information (for example, any surrounding information such as data such as a sound, an image, and a scent at that time) analyzed by the sensor module unit 210 over a certain period prior to the current time point, and the state (for example, the facial expression or emotion of the user 10) of the user 10 recognized by the user state recognition unit 230 are stored in the history data 222.

The action control unit 250 controls the control target 252 based on the action determined by the action determination unit 236. For example, in a case where the action determination unit 236 determines an action including an utterance, the action control unit 250 causes the speaker included in the control target 252 to output a speech. At this time, the action control unit 250 may determine an utterance speed of the speech based on the emotion value of the robot 100. For example, the action control unit 250 determines a higher utterance speed as the emotion value of the robot 100 is larger. In this manner, the action control unit 250 determines an execution mode of the action determined by the action determination unit 236 based on the emotion value determined by the emotion determination unit 232.

The action control unit 250 may recognize a change in the emotion of the user 10 for execution of the action determined by the action determination unit 236. For example, the change in the emotion may be recognized based on the speech or facial expression of the user 10. In addition, the change in the emotion of the user 10 may be recognized based on detection of an impact applied to the touch sensor included in the sensor unit 200. In a case where an impact is detected by the touch sensor included in the sensor unit 200, it may be recognized that the emotion of the user 10 has become worse, and in a case where it is determined that the reaction of the user 10 is smiling or being happy based on a detection result of the touch sensor included in the sensor unit 200, it may be recognized that the emotion of the user 10 has been improved. Information indicating the reaction of the user 10 is output to the communication processing unit 280.

Further, after the action control unit 250 performs the action determined by the action determination unit 236 in the execution mode determined according to the emotion of the robot 100, the emotion determination unit 232 further changes the emotion value of the robot 100 based on the reaction of the user for the execution of the action. Specifically, the emotion determination unit 232 increases the emotion value of “joy” of the robot 100 in a case where the reaction of the user for the action determined by the action determination unit 236 and performed for the user in the execution form determined by the action control unit 250 is not negative, and the emotion determination unit 232 increases the emotion value of “sorrow” of the robot 100 in a case where the reaction of the user for the action determined by the action determination unit 236 and performed for the user in the execution form determined by the action control unit 250 is negative.

Furthermore, the action control unit 250 expresses the emotion of the robot 100 based on the determined emotion value of the robot 100. For example, in a case where the emotion value of “joy” of the robot 100 is increased, the action control unit 250 controls the control target 252 to cause the robot 100 to make a joyful gesture. Further, in a case where the emotion value of “sorrow” of the robot 100 is increased, the action control unit 250 controls the control target 252 such that the posture of the robot 100 becomes a drooping posture.

The communication processing unit 280 is responsible for communication with the server 300. As described above, the communication processing unit 280 transmits the user reaction information to the server 300. Further, the communication processing unit 280 receives the updated reaction rule from the server 300. In a case where the updated reaction rule is received from the server 300, the communication processing unit 280 updates the reaction rule 221.

The server 300 performs communication between the server 300 and the robot 100, the robot 101, and the robot 102, receives the user reaction information transmitted from the robot 100, and updates the reaction rule based on a reaction rule including an action for which a positive reaction has been obtained.

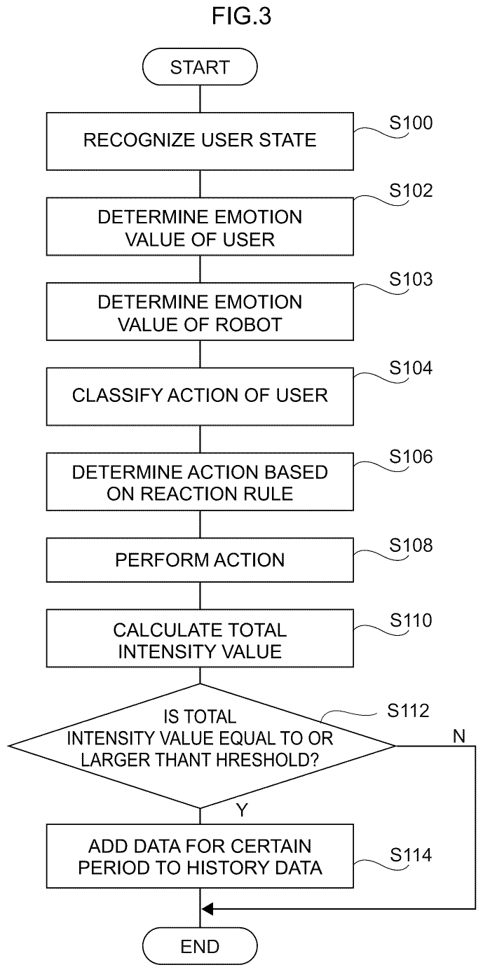

FIG. 3 schematically shows an example of an operation flow related to an operation of determining an action in the robot 100. The operation flow shown in FIG. 3 is repeatedly performed. At this time, it is assumed that the information analyzed by the sensor module unit 210 is input. “S” in the operation flow represents a step to be performed.

First, in step S100, the user state recognition unit 230 recognizes the state of the user 10 based on the information analyzed by the sensor module unit 210.

In step S102, the emotion determination unit 232 determines the emotion value indicating the emotion of the user 10 based on the information analyzed by the sensor module unit 210 and the state of the user 10 recognized by the user state recognition unit 230.

In step S103, the emotion determination unit 232 determines the emotion value indicating the emotion of the robot 100 based on the information analyzed by the sensor module unit 210 and the state of the user 10 recognized by the user state recognition unit 230. The emotion determination unit 232 adds the determined emotion value of the user 10 to the history data 222.

In step S104, the action recognition unit 234 recognizes an action classification of the user 10 based on the information analyzed by the sensor module unit 210 and the state of the user 10 recognized by the user state recognition unit 230.

In step S106, the action determination unit 236 determines the action of the robot 100 based on the combination of the current emotion value of the user 10 determined in step S102 and the past emotion value included in the history data 222, the emotion value of the robot 100, the action of the user 10 recognized by the action recognition unit 234, and the reaction rule 221.

In step S108, the action control unit 250 controls the control target 252 based on the action determined by the action determination unit 236.

In step S110, the storage control unit 238 calculates the total intensity value based on the predetermined action intensity for the action determined by the action determination unit 236 and the emotion value of the robot 100 determined by the emotion determination unit 232.

In step S112, the storage control unit 238 determines whether or not the total intensity value is equal to or larger than the threshold. In a case where the total intensity value is smaller than the threshold, the data including the action of the user 10 is not stored in the history data 222, and the processing ends. On the other hand, in a case where the total intensity value is equal to or larger than the threshold, the processing proceeds to step S114.

In step S114, the action determined by the action determination unit 236, the information analyzed by the sensor module unit 210 over a certain period prior to the current time point, and the state of the user 10 recognized by the user state recognition unit 230 are stored in the history data 222.

As described above, with the robot 100, the emotion value indicating the emotion of the robot 100 is determined based on the state of the user, and whether or not to store the data including the action of the user 10 in the history data 222 is determined based on the emotion value of the robot 100. As a result, a volume of the history data 222 that stores the data including the action of the user 10 can be reduced. Then, for example, in a case where the robot 100 determines that the state of the user after ten years matches the state of the user from ten years earlier, the robot 100 can read the history data 222 from ten years ago to present, to the user 10, the state of the user 10 from ten years earlier (for example, the facial expression or emotion of the user 10), and further, any surrounding information such as data of a sound, an image, and a scent at that time.

Further, with the robot 100, it is possible to cause the robot 100 to perform an appropriate action for the action of the user 10. Hitherto, an action of the user has been classified to determine an action including a facial expression or appearance of the robot. On the other hand, the robot 100 determines the current emotion value of the user 10 and performs an action for the user 10 based on the past emotion value and the current emotion value. Therefore, for example, in a case where the user 10 who seemed fine yesterday is depressed today, the robot 100 can make an utterance such as “You seemed fine yesterday. What's wrong today?”. Further, the robot 100 can also make an utterance with a gesture. Further, for example, in a case where the user 10 who was depressed yesterday seems fine today, the robot 100 can make an utterance such as “You seemed down yesterday, but you look fine today!”. Further, for example, in a case where the user 10 who seemed fine yesterday looks better today than yesterday, the robot 100 can make an utterance such as “You look better today than yesterday. Did anything good happen since yesterday?”. Further, for example, the robot 100 can make an utterance such as “You've been in a really stable mood lately. That's great!” for the user 10 whose emotion value is 0 or more and whose emotion value fluctuation continuously remains within a certain range.

Further, for example, in a case where the robot 100 asks the user 10, “Did you finish the homework you mentioned yesterday?”, and the user 10 answers “Yeah, I did”, the robot 100 can make a positive utterance such as “Good job!” and make a positive gesture such as applause or thumbs-up. Furthermore, for example, in a case where the user 10 makes an utterance “The presentation I talked about the day before yesterday went well”, the robot 100 can make a positive utterance such as “Nice effort!” and also make the above affirmative gesture. As described above, the robot 100 performs an action based on a history of the state of the user 10, whereby it can be expected that the user 10 feels a sense of closeness toward the robot 100.

In the above embodiment, a case where the robot 100 recognizes the user 10 by using the face image of the user 10 has been described, but the disclosed technology is not limited to such an aspect. For example, the robot 100 may recognize the user 10 by using a voice uttered by the user 10, a mail address of the user 10, an ID of a social network service (SNS) of the user 10, an ID card in which a wireless IC tag is embedded and which is possessed by the user 10, or the like.

The robot 100 is an example of electronic equipment including the action control system. An application target of the action control system is not limited to the robot 100, and the action control system can be applied to various types of electronic equipment. Further, functions of a server 300 may be implemented by one or more computers. At least some functions of the server 300 may be implemented by a virtual machine. Further, at least some functions of the server 300 may be implemented on a cloud.

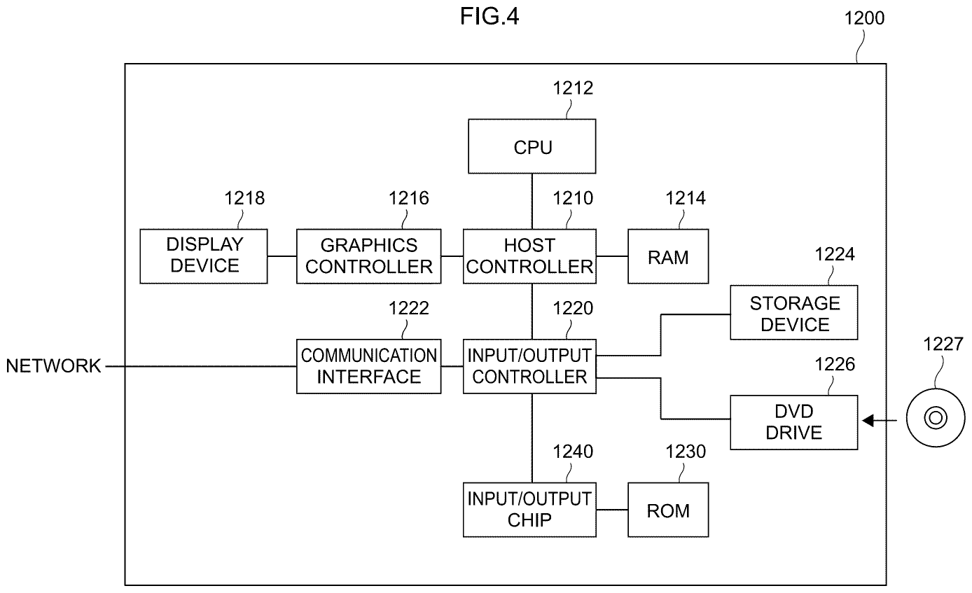

FIG. 4 schematically shows an example of a hardware configuration of a computer 1200 that functions as the robot 100 and the server 300. A program installed in the computer 1200 can cause the computer 1200 to function as one or more “units” of the device according to the present embodiment, or cause the computer 1200 to perform an operation associated with the device according to the embodiment or one or more “units” thereof, and/or can cause the computer 1200 to execute a process according to the embodiment or a stage of the process. Such a program may be executed by a CPU 1212 to cause the computer 1200 to perform a certain operation associated with some or all of the blocks in the flowcharts and block diagrams described herein.

The computer 1200 according to the embodiment includes the CPU 1212, a random access memory (RAM) 1214, and a graphics controller 1216, which are mutually connected by a host controller 1210. The computer 1200 also includes input/output units such as a communication interface 1222, a storage device 1224, a digital versatile disk (DVD) drive 1226, and an integrated circuit (IC) card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a read only memory (ROM) 1230 and a legacy input/output unit such as a keyboard, which are connected to the input/output controller 1220 via an input/output chip 1240.

The CPU 1212 operates according to the program stored in the ROM 1230 and the RAM 1214, thereby controlling each unit. The graphics controller 1216 acquires image data generated by the CPU 1212 in a frame buffer or the like provided in the RAM 1214 or itself, and causes the image data to be displayed on a display device 1218.

The communication interface 1222 communicates with other electronic devices via a network. The storage device 1224 stores the program and data to be used by the CPU 1212 in the computer 1200. The DVD drive 1226 reads the program or data from a DVD-ROM 1227 or the like and provides the program or data to the storage device 1224. The IC card drive reads the program and data from an IC card and/or writes the program and data to the IC card.

The ROM 1230 stores therein a boot program to be executed by the computer 1200 at the time of activation and/or a program that depends on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or the IC card. The program is read from the computer-readable storage medium, installed in the storage device 1224, the RAM 1214, or the ROM 1230, which is also an example of the computer-readable storage medium, and executed by the CPU 1212. Information processing described in these programs is read by the computer 1200 and provides cooperation between the programs and various types of hardware resources described above. The device or method may be configured by implementing operation or processing of information according to the use of the computer 1200.

For example, in a case where communication is performed between the computer 1200 and an external device, the CPU 1212 may execute a communication program loaded into the RAM 1214 and instruct the communication interface 1222 to execute communication processing based on processing described in the communication program. Under the control of the CPU 1212, the communication interface 1222 reads transmission data stored in a transmission buffer region provided in a recording medium such as the RAM 1214, the storage device 1224, the DVD-ROM 1227, or the IC card, transmits the read transmission data to the network, or writes reception data received from the network to a reception buffer region or the like provided on the recording medium.

In addition, the CPU 1212 may read a necessary part of or the entire file or database stored in an external recording medium such as the storage device 1224, the DVD drive 1226 (DVD-ROM 1227), the IC card, or the like into the RAM 1214, and may perform various types of processing on the data on the RAM 1214. Next, the CPU 1212 may write back the processed data to the external recording medium.

Various types of information such as various types of programs, data, tables, and databases may be stored in a recording medium and subjected to the information processing. The CPU 1212 may perform various types of processing on the data read from the RAM 1214, the various types of processing including various types of operations, the information processing, condition determination, conditional branching, unconditional branching, and information search/replacement, which are described throughout the disclosure and designated by a command sequence of a program, and write back the results to the RAM 1214. In addition, the CPU 1212 may search for information in a file, a database, or the like in the recording medium. For example, in a case where a plurality of entries each having an attribute value of a first attribute associated with an attribute value of a second attribute are stored in the recording medium, the CPU 1212 may search for an entry in which the attribute value of the first attribute satisfies a designated condition among the plurality of entries, read the attribute value of the second attribute stored in the entry, and thereby acquire the attribute value of the second attribute associated with the first attribute satisfying a predetermined condition.

The program or software module described above may be stored in a computer-readable storage medium on the computer 1200 or in the vicinity of the computer 1200. Further, a recording medium such as a hard disk or a RAM provided in a server system connected to a dedicated communication network or the Internet can be used as the computer-readable storage medium, thereby providing a program to the computer 1200 via the network.

The blocks in the flowcharts and block diagrams in the embodiment may represent stages of a process in which the operation is performed or “units” of the device that are responsible for performing the operation. Certain stages and “units” may be implemented by a dedicated circuit, a programmable circuit provided together with a computer-readable instruction stored on a computer-readable storage medium, and/or a processor provided together with the computer-readable instruction stored on the computer-readable storage medium. The dedicated circuit may include a digital and/or analog hardware circuit, and may include an integrated circuit (IC) and/or a discrete circuit. The programmable circuit may include a reconfigurable hardware circuit including, for example, AND, OR, XOR, NAND, NOR, and other logical operations, a flip-flop, a register, and a memory element, such as a field programmable gate array (FPGA) and a programmable logic array (PLA).

The computer-readable storage medium may include any tangible device capable of storing an instruction to be executed by a suitable device, so that the computer-readable storage medium having the instruction stored therein includes an article including an instruction that may be executed to create means for performing the operation specified in the flowcharts or block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disc read only memory (CD-ROM), a digital versatile disk (DVD), a Blu-Ray disk, a memory stick, and an integrated circuit card.

The computer-readable instruction may include a source code or an object code described in any combination of one or more programming languages, including an assembler instruction, an instruction-set-architecture (ISA) instruction, a machine instruction, a machine-dependent instruction, a microcode, a firmware instruction, state setting data, or an object-oriented programming language such as Smalltalk, JAVA (registered trademark), or C++, and a procedural programming language according to the related art, such as the “C” programming language or similar programming languages.

The computer-readable instruction may be provided for a processor of a general purpose computer, a special purpose computer, or another programmable data processing device, or a programmable circuit, either locally or via a local area network (LAN) or a wide area network (WAN) such as the Internet, to cause the processor of the general purpose computer, the special purpose computer, or the another programmable data processing device or the programmable circuit to execute the computer-readable instruction to generate means for performing the operation designated in the flowcharts or block diagrams. Examples of the processor include a computer processor, a processing unit, a microprocessor, a digital signal processor, a controller, and a microcontroller.

Although the invention has been described with reference to the embodiments, the technical scope of the invention is not limited to the scope described in the embodiments. It is apparent to those skilled in the art that various modifications or improvements can be made to the above embodiments. It is apparent from the description of the claims that such changed embodiments or improved embodiments can also be included in the technical scope of the invention.

It should be noted that an order of execution of processing such as operations, procedures, steps, and stages in the devices, systems, programs, and methods shown in the claims, the specification, and the drawings can be implemented in any order unless “before”, “prior to”, or the like is explicitly stated, and unless the output of the previous processing is used in the later processing. Even in a case where the operation flow in the claims, the specification, and the drawings is described using the terms “first”, “next”, and the like for convenience, it does not mean that it is essential to execute the operation flow in this order.

### Another Embodiment 1

The robot 100 according to the embodiment of the disclosure includes the emotion determination unit that determines the emotion of the user or the emotion of the robot, and the action determination unit that generates the action content of the robot for the action of the user and the emotion of the user or the emotion of the robot 100 based on a dialogue function that causes the user and the robot 100 to have a dialogue with each other, and determines the action of the robot 100 corresponding to the action content. The action determination unit 236 may determine whether or not the action of the user is dangerous by detecting the action of the user, and generate a first action content for correcting the action of the user in a case where the action of the user is dangerous.

The first action content may include at least one of making a gesture for correcting a dangerous action of a toddler, a young child, or the like who is the user, and reproducing a speech for correcting the action. Hereinafter, a toddler, a young child, or the like who is the user may be simply referred to as the user.

Examples of the dangerous action may include an action in which the user goes up an edge of a window to open the window, an action in which the user walks on a fence, and an action in which the user walks on a roadway.

The gesture for correcting the dangerous action may include a body gesture and a hand gesture for guiding the user to a specific place, a body gesture and a hand gesture for stopping the user at the place, and the like. Examples of the specific place may include a place other than a place where the user is currently located, such as the vicinity of the robot 100 or a space on an interior side of a window.

The speech for correcting the dangerous action may include a speech such as “Stop” or “AA, that's dangerous, come over here”. The speech for correcting the dangerous action may include a speech such as “Don't move” or “Stay still”.

The action determination unit 236 may determine whether or not the action of the user has been corrected by detecting the action of the user after the robot 100 makes the gesture that is the first action content or reproduces the speech that is the first action content, and may generate a second action content different from the first action content in a case where the action of the user has been corrected.

A case where the action of the user has been corrected may be interpreted as a case where the user has stopped the dangerous action and action or a dangerous situation has been resolved, as a result of performing an action of the robot 100 according to the first action content.

The second action content may include at least one of a speech for praising the action of the user and a speech for expressing gratitude for the action of the user.

The speech for praising the action of the user may include speeches such as “Are you ok? Thanks for listening” or “Well done, that's great”. The speech for expressing gratitude for the action of the user may include a speech “Thank you for coming”.

The action determination unit 236 may determine whether or not the action of the user has been corrected by detecting the action of the user after the robot 100 makes the gesture that is the first action content or reproduces the speech that is the first action content, and generate a third action content different from the first action content in a case where the action of the user has not been corrected.

A case where the action of the user has not been corrected may be interpreted as a case where the user continues to perform the dangerous action and action or the dangerous situation has not been resolved even though the action of the robot 100 according to the first action content has been performed.

The third action content may include at least one of transmitting specific information to a person other than the user, making a gesture that draws an interest of the user, reproducing a sound that draws an interest of the user, and reproducing a video that draws an interest of the user.

Transmitting the specific information to a person other than the user may include distributing an e-mail describing a warning message to a guardian, a nursery-school teacher, or the like of the user, distributing an image (still image or moving image) including the user and the surrounding scenery, and the like. Furthermore, transmitting the specific information to a person other than the user may include distributing a speech corresponding to a warning message.

The gesture that draws the interest of the user may include a body gesture and a hand gesture of the robot 100. Specifically, the gesture may include waving both arms widely, causing a light emitting diode (LED) of an eye portion of the robot 100 to blink, and the like.

Reproducing the sound that draws the interest of the user may include a specific music that the user likes and a speech such as “Come here” or “Let's do something fun together”.

Reproducing the video that draws the interest of the user may include an image of an animal kept by the user, an image of parents of the user, and the like.

With the robot 100 according to the disclosure, it is possible to detect whether or not a young child or the like is going to perform the dangerous action (such as going up an edge of a window to open the window), and generate the first action content for correcting the action of the user in a case where a danger is sensed. As a result, the robot 100 makes a gesture and an utterance according to a content such as “Stop” or “AA, that's dangerous, come over here”. Furthermore, in a case where the young child stops dangerous action by the verbal calling, the robot 100 can also perform a praising operation for the young child such as “Are you ok? Thanks for listening”. In addition, in a case where the young child does not stop the dangerous action, the robot 100 can prompt the young child to stop the dangerous action by sending a warning email to the parent or the nursery-school teacher to share the situation using a moving image, and making a motion that the young child is interested in, and playing a moving image that the young child is interested in or playing a music that the young child is interested in.

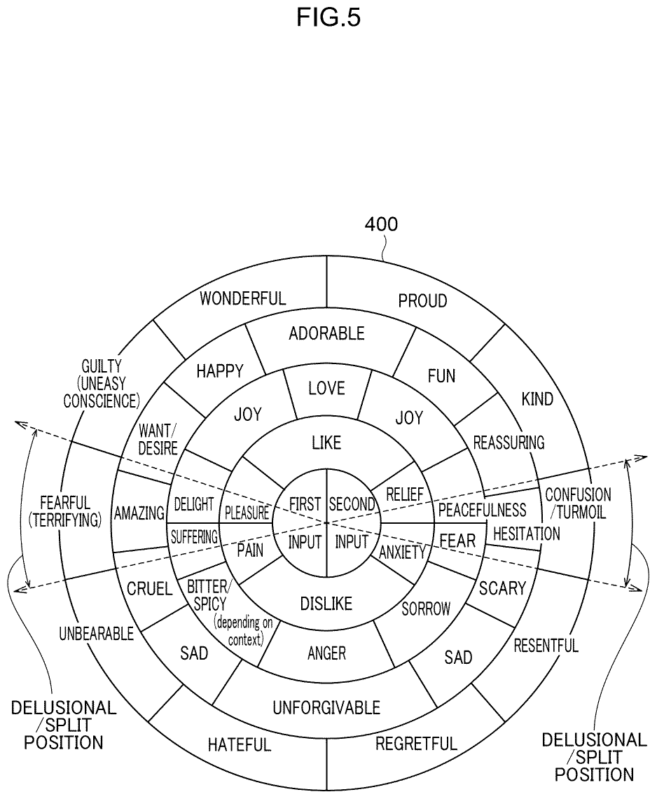

The emotion determination unit 232 may determine the emotion of the user according to a specific mapping. Specifically, the emotion determination unit 232 may determine the emotion of the user based on an emotion map (see FIG. 5) representing the specific mapping.

FIG. 5 is a diagram showing an emotion map 400 in which a plurality of emotions are mapped. In the emotion map 400, emotions are arranged radially in concentric circles from the center. The closer to the center of the concentric circle, the more primitive the emotion is. Emotions representing states and actions arising from a mental state are arranged on an outer side of the concentric circle. The emotion is a concept including emotional reactions and psychological conditions. Emotions arising from reactions generally occurring in the brain are arranged on a left side of the concentric circle. Emotions induced by situation determination are generally arranged on a right side of the concentric circle. Emotions arising from reactions generally occurring in the brain and induced by situation determination are arranged in an upward direction and a downward direction of the concentric circle. Further, emotions of “comfort” are arranged on an upper side of the concentric circle, and emotions of “discomfort” are arranged on a lower side of the concentric circle. As described above, in the emotion map 400, a plurality of emotions are mapped based on a structure in which emotions arise, and emotions that are likely to arise at the same time are mapped close to each other.
(1) For example, in a case where the emotion engine, which is the emotion determination unit 232 of the robot 100, detects an emotion about every 100 msec, determination of a reaction operation (for example, the backchannel response) of the robot 100 may be performed at at least a similar frequency to the detection frequency (100 msec) of the emotion engine, or may be performed at a frequency higher than the detection frequency. The detection frequency of the emotion engine may be interpreted as a sampling rate.

The emotion is detected about every 100 msec, and the reaction operation (for example, the backchannel response) is performed immediately in conjunction with the detection, whereby an unnatural backchannel response is not performed, and a natural and smooth dialogue can be implemented. The robot 100 performs the reaction operation (such as the backchannel response) according to a direction and a magnitude (intensity) in the mandala-like emotion map 400. The detection frequency (sampling rate) of the emotion engine is not limited to 100 ms, and may be changed according to a situation (such as a case of playing sports), an age of the user, or the like.
(2) According to the emotion map 400, a direction and an intensity of an emotion may be set in advance, and a backchannel response motion and an intensity of the backchannel response may be set. For example, in a case where the robot 100 feels a sense of stability, relief, or the like, the robot 100 continues to listen while nodding. In a case where the robot 100 feels anxious, lost, or suspicious, the robot 100 may tilt the head thereof or stop movement of the head.

Such emotions are distributed at 3 o'clock positions on the emotion map 400 and usually range between relief and anxiety. In the right half of the emotion map 400, since situational awareness takes precedence over internal sensations, a calm impression is conveyed.
(3) In a case where the robot 100 experiences pleasure from being praised, a filler such as “Oh” may be inserted before an utterance. In a case where the robot 100 feels a sense of pain from receiving harsh words, a filler “Ugh!” may be inserted before an utterance. Further, the robot 100 may also perform a physical reaction such as a gesture of crouching while saying “Ugh!”. Such emotions are distributed around 9 o'clock positions on the emotion map 400.
(4) In the left half of the emotion map 400, internal sensations (reactions) take precedence over situational awareness. Therefore, an impression of an involuntary reaction can be conveyed.

In a case where the robot 100 has a favorable impression through situational awareness while experiencing an internal sensation (reaction) of acceptance, the robot 100 may nod deeply while looking at the counterpart, or may utter “Mm-hmm”. In this manner, the robot 100 may produce a balanced favorable impression for the counterpart, that is, perform an action expressing permissiveness or tolerance toward the counterpart. Such emotions are distributed around 12 o'clock positions in the emotion map 400.

On the other hand, in a case where the robot 100 has an unfavorable impression through situational awareness while experiencing an internal sensation (reaction) of discomfort, the robot 100 may shake the head sideways, and in a case where the robot 100 feels hatred, the robot 100 may illuminate the LED of the eye in red and glare at the counterpart. Such emotions are distributed around 6 o'clock positions in the emotion map 400.
(5) Since an inner side of the emotion map 400 represents feelings and an outer side of the emotion map 400 represents actions, the emotions on the outer side of the emotion map 400 are more visible (appear in actions).
(6) In a case where the robot 100 listens to a speech of a person while feeling relief distributed around the 3 o'clock position on the emotion map 400, the robot 100 slightly nods the head vertically and says “Hmm-hmm”. However, in a case where the robot 100 feels love distributed around the 12 o'clock position, the robot 100 may perform a more forceful and deeper vertical nod.

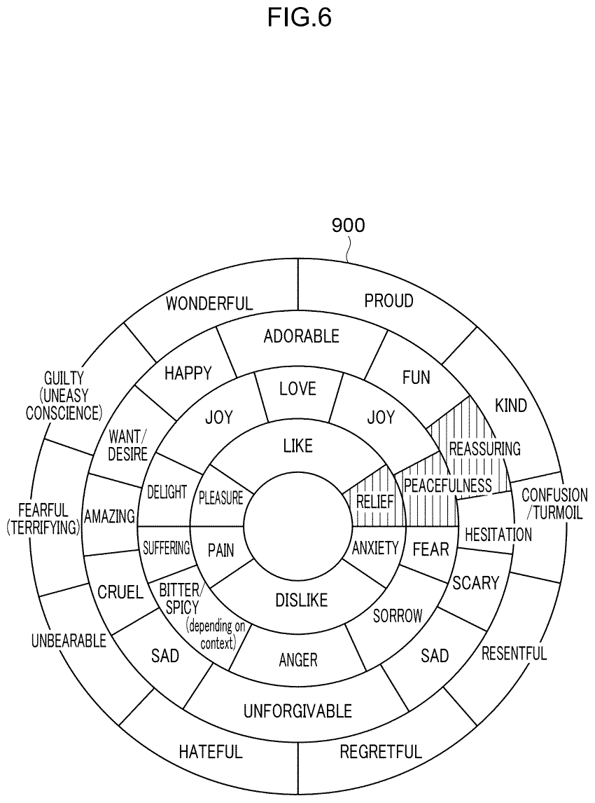

The emotion determination unit 232 inputs the information analyzed by the sensor module unit 210 and the recognized state of the user 10 to the neural network trained in advance, acquires the emotion value indicating each emotion indicated in the emotion map 400, and determines the emotion of the user 10. The neural network is trained in advance based on a plurality of pieces of learning data, which are a combination of the information analyzed by the sensor module unit 210, the recognized state of the user 10, and the emotion value indicating each emotion indicated in the emotion map 400. Furthermore, the neural network is trained such that emotions arranged close to each other as in an emotion map 900 shown in FIG. 6 have close values. FIG. 6 shows an example in which a plurality of emotions such as “relief”, “peacefulness”, and “sense of security” have similar emotion values.

Further, the emotion determination unit 232 may determine the emotion of the robot 100 according to the specific mapping. Specifically, the emotion determination unit 232 inputs the information analyzed by the sensor module unit 210, the state of the user 10 recognized by the user state recognition unit 230, and the state of the robot 100 to the neural network trained in advance, acquires the emotion value indicating each emotion indicated in the emotion map 400, and determines the emotion of the robot 100. The neural network is trained in advance based on a plurality of pieces of learning data, which are a combination of the information analyzed by the sensor module unit 210, the recognized state of the user 10, the state of the robot 100, and the emotion value indicating each emotion shown in the emotion map 400. For example, the neural network is trained based on the learning data indicating that the emotion value “3” of “joyful” is obtained in a case where it is recognized that the robot 100 is being stroked by the user 10 from an output of the touch sensor (not shown), and the learning data indicating that the emotion value “3” of “anger” is obtained in a case where it is recognized that the robot 100 is being hit by the user 10 from an output of an acceleration sensor (not shown). Furthermore, the neural network is trained such that emotions arranged close to each other as in an emotion map 900 shown in FIG. 6 have close values.

The action determination unit 236 generates the action content of the robot by adding a fixed sentence for inquiry about the action content of the robot corresponding to the action of the user to a text representing the action of the user, the emotion of the user, and the emotion of the robot, and inputting the text to the sentence generation model having the dialogue function.

For example, the action determination unit 236 acquires a text representing the state of the robot 100 from the emotion of the robot 100 determined by the emotion determination unit 232 using an emotion table as shown in Table 1. Here, in the emotion table, an index number is assigned to each emotion value for each type of emotion, and the text representing the state of the robot 100 is stored for each index number.

In a case where the emotion of the robot 100 determined by the emotion determination unit 232 corresponds to an index number “2”, a text “very pleasant state” is obtained. In a case where the emotion of the robot 100 corresponds to a plurality of index numbers, a plurality of texts representing the states of the robot 100 are obtained.

Further, an emotion table as shown in Table 2 is prepared for the emotion of the user 10.

Here, in a case where the action of the user is an action of saying “Should I head that way?”, the emotion of the robot 100 corresponds to the index number “2”, and the emotion of the user 10 corresponds to an index number “3”, a text “The robot is in a very pleasant state. The user is in a normally pleasant state. The user said, “Should I head that way?”. How should the robot respond?” is input to the sentence generation model to thereby acquire the action content of the robot. The action determination unit 236 determines the action of the robot based on the action content.

TABLE 1

| Index | | Emotion | |
|---|---|---|---|
| number | Type of emotion | value | State of robot |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

TABLE 2

| Index | | Emotion | |
|---|---|---|---|
| number | Type of emotion | value | State of user |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

As described above, the action determination unit 236 determines the action content of the robot 100 according to a state related to the emotion of the robot 100 set in advance for each type of the emotion of the robot 100 and for each intensity of the emotion, and the action of the user 10. In the embodiment, the utterance content of the robot 100 in a case where a dialogue with the user 10 is performed can be branched according to the state related to the emotion of the robot 100. That is, since the robot 100 can change the action of the robot according to the index number corresponding to the emotion of the robot, the user is given an impression that the robot has a mind, and is promoted to perform an action such as talking to the robot.

Further, the action determination unit 236 may generate the action content of the robot by adding the fixed sentence for inquiry about the action content of the robot corresponding to the action of the user after adding not only the text representing the action of the user, the emotion of the user, and the emotion of the robot but also a text representing a content of the history data 222, and inputting the fixed sentence to the sentence generation model having the dialogue function. As a result, the robot 100 can change the action of the robot according to the history data indicating the emotion and the action of the user, and thus, the user is given an impression that the robot has a personality, and is promoted to perform an action such as talking to the robot. Further, the history data may further include the emotion and the action of the robot.

Further, the emotion determination unit 232 may determine the emotion of the robot 100 based on the action content of the robot 100 generated by the sentence generation model. Specifically, the emotion determination unit 232 inputs the action content of the robot 100 generated by the sentence generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the current emotion value indicating each emotion of the robot 100 are each averaged and integrated. The neural network is learned in advance based on a plurality of pieces of learning data, which are a combination of the text representing the action content of the robot 100 generated by the sentence generation model and the emotion value representing each emotion indicated in the emotion map 400.

For example, in a case where an utterance content of the robot 100, “That's great. You were lucky”, is obtained as the action content of the robot 100 generated by the sentence generation model, when a text representing the utterance content is input to the neural network, a large value is obtained as the emotion value of the emotion “joyful”, and the emotion of the robot 100 is updated such that the emotion value of the emotion “joyful” becomes large.

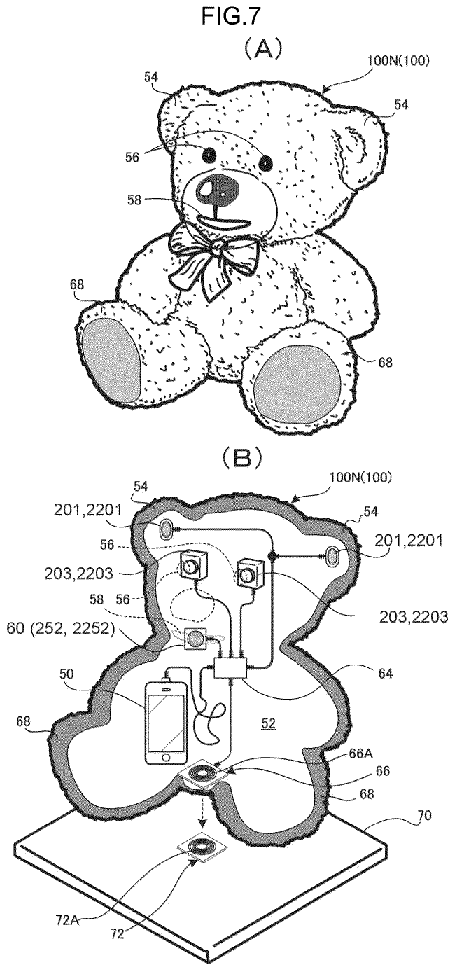

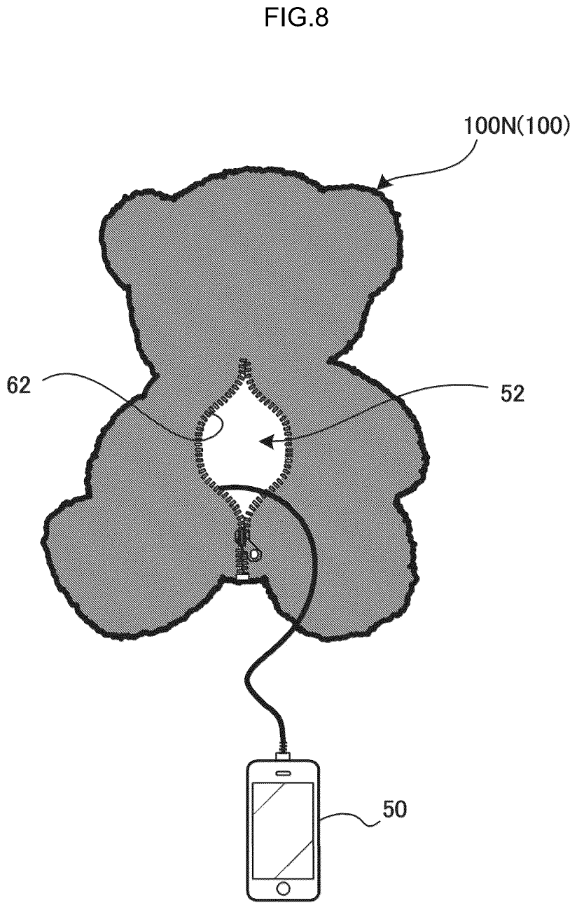

The robot 100 may be mounted on a stuffed toy, or may be applied to a control device connected wirelessly or by wire to control target equipment (speaker or camera) mounted on a stuffed toy. In this case, specifically, the following configuration is applied. For example, the robot 100 may be applied to a cohabiting companion (specifically, a stuffed toy 100N shown in FIGS. 7 and 8) that has a dialogue with the user 10 based on information regarding daily life and provides information tailored to preferences of the user 10 while spending daily life with the user 10. In the present embodiment (another embodiment), an example in which a control portion of the robot 100 is applied to the smartphone 50 is described.

The smartphone 50 functioning as the control portion of the robot 100 is attachable to and detachable from the stuffed toy 100N having a function as an input/output device of the robot 100, and the input/output device and the housed smartphone 50 are connected inside the stuffed toy 100N.

As shown in FIG. 7(A), the stuffed toy 100N has a shape of a bear covered with a soft cloth fabric in the present embodiment (an embodiment in which the robot 100 is mounted on the stuffed toy), and as shown in FIG. 7(B), in a space portion 52 formed inside the stuffed toy 100N, the microphone 201 (see FIG. 2) of the sensor unit 200 is disposed as the input/output device at a portion corresponding to an ear 54, the 2D camera 203 (see FIG. 2) of the sensor unit 200 is disposed at a portion corresponding to an eye 56, and a speaker 60 forming a part of the control target 252 (see FIG. 2) is disposed at a portion corresponding to a mouth 58. The microphone 201 and the speaker 60 are not necessarily separated from each other, and may be formed as an integrated unit. In a case where the microphone 201 and the speaker 60 are formed as the unit, it is preferable to dispose the unit at a position where an utterance can be heard naturally, such as a position of a nose of the stuffed toy 100N. Although a case where the stuffed toy 100N has an animal shape has been described as an example, the disclosure is not limited thereto. The stuffed toy 100N may have a shape of a specific character.

The smartphone 50 has a function as the sensor module unit 210, a function as the storage unit 220, a function as the user state recognition unit 230, a function as the emotion determination unit 232, a function as the action recognition unit 234, a function as the action determination unit 236, a function as the storage control unit 238, a function as the action control unit 250, and a function as the communication processing unit 280 shown in FIG. 2.

As shown in FIG. 8, a fastener 62 is attached to a part (for example, a back portion) of the stuffed toy 100N, and the outside and the space portion 52 communicate with each other by opening the fastener 62.

Here, the smartphone 50 is housed in the space portion 52 from the outside and is universal serial bus (USB)-connected to each input/output device via a USB hub 64 (see FIG. 7(B)), so that functions equivalent to those of the robot 100 shown in FIG. 1 can be provided.

A non-contact power receiving plate 66 is connected to the USB hub 64. A power receiving coil 66A is incorporated in the power receiving plate 66. The power receiving plate 66 is an example of a wireless power receiving unit that receives wireless power supply.

The power receiving plate 66 is disposed near root portions 68 of both feet of the stuffed toy 100N and is positioned closest to a placement base 70 in a case where the stuffed toy 100N is placed on the placement base 70. The placement base 70 is an example of an external wireless power transmitting unit.

The stuffed toy 100N placed on the placement base 70 can be appreciated as an ornament in a natural state.

Further, the root portion is formed to have a thickness smaller than a thickness of a surface layer of the stuffed toy 100N at other portions, and is held in a state closer to the placement base 70.

The placement base 70 includes a charging pad 72. A power transmitting coil 72A is incorporated in the charging pad 72. When the power transmitting coil 72A transmits a signal to search the power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not shown) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the present embodiment (an embodiment in which the robot 100 is mounted on the stuffed toy), the smartphone 50 is housed in the space portion 52 of the stuffed toy 100N and connected by wire (USB connection), but the disclosure is not limited thereto. For example, a control device having a wireless function (for example, “Bluetooth (registered trademark)”) may be housed in the space portion 52 of the stuffed toy 100N, and the control device may be connected to the USB hub 64. In this case, the smartphone 50 and the control device wirelessly communicate with each other in a state in which the smartphone 50 is not inserted into the space portion 52, and the smartphone 50 positioned outside is connected to each input/output device via the control device, so that functions equivalent to those of the robot 100 shown in FIG. 1 can be provided. Further, the control device in which the control device is housed in the space portion 52 of the stuffed toy 100N and the smartphone 50 positioned outside may be connected by wire.

Further, in the present embodiment (an embodiment in which the robot 100 is mounted on the stuffed toy), the bear-shaped stuffed toy 100N has been exemplified, but the shape of the stuffed toy 100N may be another animal, a doll, or a shape of a specific character. Further, clothes of the stuffed toy 100N may be able to be changed. Further, a material of an outer surface is not limited to the cloth fabric and may be other materials such as soft vinyl. It is preferable that the material of the outer surface is a soft material.

Further, a monitor may be attached to the outer surface of the stuffed toy 100N, and the control target 252 that provides information to the user 10 through vision may be added. For example, the eye 56 may be used as the monitor to express joy, anger, sorrow, and pleasure, or a window through which a built-in monitor of the smartphone 50 is visible may be provided at a belly portion. Further, the eye 56 may be used as a projector to express joy, anger, sorrow, and pleasure by an image projected on a wall surface.

According to another embodiment, the existing smartphone 50 is inserted into the stuffed toy 100N, and the camera 203, the microphone 201, the speaker 60, and the like are extended from the smartphone 50 to appropriate positions via USB connection.

Further, for wireless charging, the smartphone 50 and the power receiving plate 66 are USB-connected to each other, and the power receiving plate 66 is disposed as close to the outer side of the stuffed toy 100N as possible when viewed from the inside.

In order to use the wireless charging of the smartphone 50, the smartphone 50 needs to be positioned as close to the outer side of the stuffed toy 100N as possible when viewed from the inside, which may result in a rough tactile sensation when the stuffed toy 100N is touched from the outside.

Therefore, the smartphone 50 is disposed as close to the center of the stuffed toy 100N as possible, and a wireless charging function (power receiving plate 66) is disposed as close to the outer side of the stuffed toy 100N as possible when viewed from the inside. The camera 203, the microphone 201, the speaker 60, and the smartphone 50 receive wireless power supply via the power receiving plate 66.

### Another Embodiment 2

The robot 100 according to the present embodiment includes the emotion determination unit that determines the emotion of the user or the emotion of the robot, and the action determination unit that generates the action content of the robot for the action of the user and the emotion of the user or the emotion of the robot based on the sentence generation model having the dialogue function of causing the user and the robot to have a dialogue with each other, and determines the action of the robot corresponding to the action content. The action determination unit 236 is configured to receive statements of a plurality of users having a conversation, and determine, as the action of the robot 100, to summarize contents of the statements in a case where the statements are in a predetermined state.

Specifically, the robot 100 is installed at a place where a plurality of users make statements, such as a meeting room. Then, the robot 100 of the present embodiment acquires the statements of the plurality of users having a conversation with the microphone function. Then, the robot 100 stores the statements that have been made so far.

In a case where the state of the acquired statements becomes the predetermined state, the action determination unit 236 summarizes the contents of the statements. Here, the predetermined state includes a state in which the statements are no longer received for a predetermined time. In other words, in a case where the plurality of users have not made any statement for the predetermined time, for example, five minutes, it is determined that the meeting has stalled, no good idea is being generated, and the users have fallen silent. Therefore, the contents of the statements that have been made so far are summarized to summarize the meeting. Here, the summarization of the contents of the statements is performed using a known technology, and includes extraction and outputting of terms frequently appearing in the statements.

Furthermore, the predetermined state includes a state in which a term included in the statement is received a predetermined number of times. That is, in a case where the same term is received the predetermined number of times, it is determined that the meeting is going around in circles on the same topic and no new idea is being generated. Therefore, the contents of the statements that have been made so far are summarized to summarize the meeting. Materials for the meeting may be input to the sentence generation model in advance, and terms described in the materials are assumed to frequently appear and thus may be excluded in the case of counting the number of times.

With such a configuration, even in a stalled meeting or the like, it is possible to organize a theme and issues of the meeting by summarizing the meeting.

### Another Embodiment 3

The action determination unit 236 generates the action content of the robot for the action of the user and the emotion of the user or the emotion of the robot based on the dialogue function of causing the user and the robot to have a dialogue with each other, and determines the action of the robot corresponding to the action content. At this time, the robot is set at customs, and the action determination unit 236 acquires an image of a person acquired by an image sensor and an odor detection result of an odor sensor, and determines, as the action of the robot, to make a notification to a tax inspector in a case where a preset abnormal action, an abnormal facial expression, or an abnormal odor is detected.

Specifically, the robot 100 is installed at customs and detects a passenger passing therethrough. In addition, the robot 100 stores odor data of drugs and odor data of explosives, and also stores data regarding an action, a facial expression, a suspicious action, and the like of a criminal. The action determination unit 236 acquires an image of the passenger acquired by the image sensor and the odor detection result of the odor sensor in a case where the passenger passes, and determines, as the action of the robot 100, to make a notification to the tax inspector in a case where a suspicious action, a suspicious facial expression, an odor of drugs, and an odor of explosives are detected.

### Another Embodiment 4

A robot 100 (corresponding to a smartphone 50 housed in a stuffed toy 100N in the present embodiment) of the present embodiment performs the following processing.

The robot 100 (corresponding to the smartphone 50 housed in the stuffed toy 100N in the present embodiment) performs processing of determining a special fraud risk according to a conversation content between the user and a conversation partner of the user and an emotion of the conversation partner according to the following steps 1 to 5.
(Step 1) The robot 100 acquires the conversation content between the user 10 and the conversation partner.

Specifically, the utterance understanding unit 212 analyzes a speech of the user 10 and a speech of the conversation partner, which are detected by the microphone 201, and outputs text information indicating the conversation content between the user 10 and the conversation partner. The robot 100 recognizes the user 10 and the conversation partner as the plurality of users 10.
(Step 2) The robot 100 acquires an emotion value of the conversation partner.

Specifically, the speech of the conversation partner from a telephone and an intercom and a video of the conversation partner shown on a screen of the intercom are acquired, and processing similar to steps S100 to S102 is performed to acquire the emotion value of the conversation partner.
(Step 3) The robot 100 determines the special fraud risk based on the conversation content acquired in step 1 and the emotion value of the conversation partner acquired in step 2.

Specifically, the action determination unit 236 determines a similarity between the conversation content and a special fraud case by comparing data of the past special fraud case stored in the storage unit 220 with the conversation content. Then, the action determination unit 236 determines the degree of special fraud risk based on the similarity between the conversation content and the special fraud case and the emotion value of the conversation partner. As an example, in a case where the similarity between the conversation content and the special fraud case is high, the action determination unit 236 determines that the degree of special fraud risk is high regardless of the emotion value of the conversation partner. Furthermore, in a case where an emotion value of “anxiety” or “excitement” of the conversation partner is high, the action determination unit 236 determines that the degree of special fraud risk is high even in a case where the similarity between the conversation content and the special fraud case is not so high.
(Step 4) The robot 100 determines an action according to the degree of special fraud risk determined in step 3.

Specifically, in a case where the degree of special fraud risk determined in step 3 exceeds a predetermined threshold, the action determination unit 236 determines an action of notifying that the special fraud risk is high. For example, the action determination unit 236 may determine an action of notifying the user 10 that the special fraud risk is high. Furthermore, the action determination unit 236 may determine an action of notifying a family member of the user 10 that the special fraud risk is high. Furthermore, the action determination unit 236 may determine an action of immediately reporting to the police that the special fraud risk is high. Such actions may be appropriately determined according to the degree of special fraud risk.
(Step 5) The robot 100 performs the action determined in step 4.

Specifically, the action control unit 250 controls the speaker that is the control target equipment such that the notification matter is output as a speech from the speaker.

In this manner, the robot 100 can perform processing of determining the special fraud risk according to the conversation content between the user and the conversation partner of the user and the emotion of the conversation partner.

### Another Embodiment 5

A robot 100 (corresponding to a smartphone 50 housed in a stuffed toy 100N in the present embodiment) of the present embodiment performs the following processing.

The robot 100 (corresponding to the smartphone 50 housed in the stuffed toy 100N in the present embodiment) performs processing of detecting a specific incident according to a conversation content of a plurality of users, situations of the plurality of users, and reactions of the plurality of users according to the following steps 1 to 6.
(Step 1) The robot 100 acquires the conversation content of the plurality of users 10.

Specifically, the utterance understanding unit 212 analyzes speeches of the plurality of users 10 detected by the microphone 201, and outputs text information indicating the conversation content of the plurality of users 10.
(Step 2) The robot 100 acquires emotion values of the plurality of users 10.

Specifically, the speeches of the plurality of users 10 and videos of the plurality of users 10 are acquired, and processing similar to steps S100 to S102 is performed to acquire the emotion values of the plurality of users 10.
(Step 3) The robot 100 determines whether or not a specific incident such as “bullying”, “crime”, or “harassment” has occurred based on the conversation content of the plurality of users 10 acquired in step 1 and the emotion values of the plurality of users 10 acquired in step 2.

Specifically, the action determination unit 236 determines a similarity between the conversation content and the specific incident by comparing data of the past specific incident such as “bullying”, “crime”, or “harassment” stored in the storage unit 220 with the conversation content of the plurality of users 10. Then, the action determination unit 236 determines the degree of likelihood that the specific incident has occurred based on the similarity between the conversation content and the specific incident and the emotion values of the plurality of users 10. As an example, in a case where the similarity between the conversation content and the specific incident is high and emotion values of “anger”, “sorrow”, “discomfort”, “anxiety”, “sadness”, “worry”, and “sense of emptiness” of the plurality of users 10 are large, the action determination unit 236 determines that the degree of likelihood that the specific incident has occurred is high.
(Step 4) The robot 100 determines an action according to the degree of likelihood that the specific incident determined in step 3 has occurred.

Specifically, in a case where the degree of likelihood that the specific incident determined in step 3 has occurred exceeds a predetermined threshold, the action determination unit 236 determines an action of notifying that the degree of likelihood that the specific incident has occurred is high. For example, the action determination unit 236 may determine to notify, by an e-mail, an administrator of an organization to which the plurality of users 10 belong that the degree of likelihood that the specific incident has occurred is high.
(Step 5) The robot 100 performs the action determined in step 4.

Specifically, the above e-mail is transmitted from the smartphone 50 functioning as the action control unit 250 to the administrator. In the e-mail, a conversation log of a portion corresponding to the specific incident, an assumed incident, a probability of occurrence of the incident, a proposal for a solution for the incident, and the like may be described.
(Step 6) The robot 100 stores a result of the action performed in step 5 in the storage unit 220. Specifically, the storage control unit 238 stores, in the history data 222, whether or not the specific incident has occurred, a resolution status, and the like. In this way, by feeding back whether or not the specific incident has occurred, the resolution status, and the like, it is possible to improve accuracy of detection of the specific incident and improve a proposal of a solution.

In this manner, the robot 100 can perform processing of detecting the specific incident according to the conversation content of the plurality of users, the situations of the plurality of users, and the reactions of the plurality of users.

### Another Embodiment 6

A robot 100 (corresponding to a smartphone 50 housed in a stuffed toy 100N in the present embodiment) of the present embodiment performs the following processing.

The robot 100 (corresponding to the smartphone 50 housed in the stuffed toy 100N in the present embodiment) performs processing related to childcare based on the preference of the user (child), the situation of the user, and the reaction of the user according to the following steps 1 to 5-2.
(Step 1) The robot 100 acquires a state of the user 10, an emotion value of the user 10, an emotion value of the robot 100, and history data 222. Specifically, processing similar to steps S100 to S103 is performed to acquire the state of the user 10, the emotion value of the user 10, the emotion value of the robot 100, and the history data 222.
(Step 2) The robot 100 acquires a preference of the user 10 regarding animation or music.

Specifically, the action determination unit 236 determines, as the action of the robot 100, to make an utterance for asking the user 10 about the preference regarding the animation or music, and the action control unit 250 controls the control target 252 to make the utterance for asking the user 10 about the preference regarding the animation or music. The user state recognition unit 230 recognizes the preference of the user 10 regarding the animation or music based on the information (for example, an answer of the user) analyzed by the sensor module unit 210.
(Step 3) The robot 100 determines an animation or music work to be proposed to the user 10.

Specifically, the action determination unit 236 acquires a content of a recommendation regarding the animation or music by adding a fixed sentence “What animation or music would you recommend to the user in this case?” to a text representing the preference of the user 10 regarding the animation or music, the emotion of the user 10, the emotion of the robot 100, and a content stored in the history data 222 and inputting the text to the sentence generation model. At this time, it is possible to propose an animation or music work appropriate for the user 10 by considering not only the preference of the user 10 regarding the animation or music but also the emotion of the user 10 and the history data 222. Further, it is possible to make the user 10 feel that the robot 100 has emotions by considering the emotion of the robot 100.
(Step 4) The robot 100 proposes the animation or music work determined in step 3 to the user 10 and acquires the reaction of the user 10.

Specifically, the action determination unit 236 determines, as the action of the robot 100, to make an utterance for proposing the animation or music work to the user 10, and the action control unit 250 controls the control target 252 to make the utterance for proposing the animation or music work to the user 10. The user state recognition unit 230 recognizes the state of the user 10 based on the information analyzed by the sensor module unit 210, and the emotion determination unit 232 determines the emotion value indicating the emotion of the user 10 based on the information analyzed by the sensor module unit 210 and the state of the user 10 recognized by the user state recognition unit 230.

The action determination unit 236 determines whether or not the reaction of the user 10 is positive based on the state of the user 10 recognized by the user state recognition unit 230 and the emotion value indicating the emotion of the user 10, and determines, as the action of the robot 100, execution of processing of providing the animation or music work proposed to the user 10 or proposal of another animation or music work to the user 10.
(Step 5-1) In a case where the reaction of the user 10 is positive, the robot 100 performs the processing of providing the proposed animation or music work.

Specifically, in a case where it is determined to perform the processing of providing the animation or music work proposed to the user 10 as the action of the robot 100, the action control unit 250 controls the speaker or the monitor, which is the control target 252, so as to reproduce the animation or music work proposed to the user 10.
(Step 5-2) In a case where the reaction of the user 10 is not positive, the robot 100 determines another animation or music work to be proposed to the user 10.

Specifically, in a case where it is determined to propose another animation or music work to the user 10 as the action of the robot 100, the action determination unit 236 acquires a content of a recommendation regarding the animation or music work by adding a fixed sentence “Are there any other recommended animation or music works for the user?” to a text representing the preference regarding the animation or music, the emotion of the user 10, the emotion of the robot 100, and the content stored in the history data 222 for the user 10 and inputting the text to the sentence generation model. Then, the processing returns to step 4 described above, and the processing of steps 4 to 5-2 described above is repeated until it is determined to perform the processing of providing the animation or music work proposed to the user 10.

In addition, the robot 100 performs other processing related to childcare according to the situation of the user and the reaction of the user in the following steps 11 to 13 while playing with the user 10 (child) in the above steps 1 to 5-2.
(Step 11) The robot 100 recognizes the state of the user 10.

Specifically, the user state recognition unit 230 recognizes the state of the user 10 based on the information analyzed by the sensor module unit 210.
(Step 12) The robot 100 determines whether or not the state of the user 10 acquired in step 11 is an abnormal state (crying, falling, not moving for a certain time, or entering a dangerous place).

Specifically, the action determination unit 236 compares the past state of the user 10 included in the history data 222 with the current state of the user 10 to determine whether or not the state of the user 10 acquired in step 11 is the abnormal state.
(Step 13) In a case where the state of the user 10 is the abnormal state, the robot 100 performs processing of issuing an alarm.

Specifically, the action control unit 250 controls the speaker that is the control target 252 to issue an alarm. In a case where the state of the user 10 is not the abnormal state, the robot 100 ends the processing and repeats the processing of step 11 and step 12.

In this manner, the robot 100 can perform the processing related to childcare according to the preference of the user, the situation of the user, and the reaction of the user. As a result, for example, it is possible to warn the user 10 of a danger approaching the user 10 while playing with the user 10 or watching over the user 10 during sleep.

### Second Embodiment

FIG. 1 schematically shows an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. In the description of the present embodiment, the user 10a, the user 10b, the user 10c, and the user 10d may be collectively referred to as the user 10. Further, the user 11a, the user 11b, and the user 11c may be collectively referred to as the user 11. Further, the user 12a and the user 12b may be collectively referred to as the user 12. The robot 101 and the robot 102 have substantially the same functions as that of the robot 100. Therefore, the system 5 will be described focusing on the function of the robot 100.

Here, the user 10a, the user 10b, the user 10c, and the user 10d form a family. In other words, the user 10a, the user 10b, the user 10c, and the user 10d are family members. Furthermore, the users 10a to 10d may include a caregiver who provides caregiving. For example, in a case where the user 10a is a caregiver, caregiving for a person (user) other than the family member may be performed, or caregiving for the user 10b who is the family member may be performed. The person (user) other than the family member and the user 10b are care receivers who receive caregiving.

As described below, the robot 100 provides, to the user 10, advice information regarding caregiving. However, in a case where the user 10a, who is a caregiver, provides caregiving for a person other than the family member, the user 10 at this time does not have to be the family member. In a case where the user 10b, who is a care receiver, receives caregiving from a person (user) other than the family member, the user 10 at this time does not have to be the family member. Furthermore, as described below, the robot 100 provides, to the user 10, advice information regarding health of the family member and advice information regarding a mental state, but the user 10 at this time does not have to include the caregiver or the care receiver.

The robot 100 has a conversation with the user 10 and provides a video to the user 10. At this time, the robot 100 has a conversation with the user 10, provides a video to the user 10, and the like in cooperation with the server 300 and the like that can perform communication via a communication network 20. For example, the robot 100 not only learns an appropriate conversation by itself, but also performs learning to have a more appropriate conversation with the user 10 in cooperation with the server 300. Further, the robot 100 causes the server 300 to record captured video data and the like of the user 10, requests the server 300 to transmit the video data and the like if necessary, and provides the video data and the like to the user 10.

Further, the robot 100 has an emotion value representing a type of an emotion thereof. For example, the robot 100 has the emotion value representing an intensity of each of emotions “joy”, “anger”, “sorrow”, “pleasure”, “comfort”, “discomfort”, “relief”, “anxiety”, “sadness”, “excitement”, “worry”, “reassurance”, “sense of fulfillment”, “sense of emptiness”, and “neutral”. For example, in the case of having a conversation with the user 10 in a state in which the emotion value of excitement is large, the robot 100 utters a speech at a high speed. As described above, the robot 100 can express the emotion thereof by an action.

Further, the robot 100 may be configured to determine an action of the robot 100 corresponding to an emotion of the user 10 by matching a sentence generation model and an emotion engine using an artificial intelligence (AI). Specifically, the robot 100 may be configured to recognize an action of the user 10, determine the emotion of the user 10 for the action of the user, and determine the action of the robot 100 corresponding to the determined emotion.

More specifically, in a case where the action of the user 10 is recognized, the robot 100 automatically generates a content of an action to be performed by the robot 100 for the action of the user 10 using the preset sentence generation model. The sentence generation model may be interpreted as an algorithm and operation for text-based automatic dialogue processing. Since the sentence generation model is known as disclosed in, for example, Japanese Patent Application Laid-Open No. 2018-081444 and ChatGPT (Internet search <URL: https://openai.com/blog/chatgpt>), a detailed description thereof is omitted. Such a sentence generation model is implemented by a large language model (LLM).

As described above, in the present embodiment, it is possible to reflect the emotions of the user 10 and the robot 100 and various types of linguistic information in the action of the robot 100 by combining the large language model and the emotion engine. That is, according to the present embodiment, a synergistic effect can be obtained by combining the sentence generation model and the emotion engine.

Further, the robot 100 has a function of recognizing the action of the user 10. The robot 100 recognizes the action of the user 10 by analyzing a face image of the user 10 acquired by a camera function and a speech of the user 10 acquired by a microphone function. The robot 100 determines an action to be performed by the robot 100 based on the recognized action of the user 10 or the like.

The robot 100 stores, as an example of an action determination model, a rule setting an action to be performed by the robot 100 based on the emotion of the user 10, the emotion of the robot 100, and the action of the user 10, and performs various actions according to the rule.

Specifically, the robot 100 has, as an example of the action determination model, a reaction rule for determining the action of the robot 100 based on the emotion of the user 10, the emotion of the robot 100, and the action of the user 10. In the reaction rule, for example, an action of “laughing” is set as the action of the robot 100 for a case where the action of the user 10 is “laughing”. Further, in the reaction rule, an action of “apologizing” is set as the action of the robot 100 for a case where the action of the user 10 is “getting angry”. Further, in the reaction rule, an action of “answering” is set as the action of the robot 100 for a case where the action of the user 10 is “asking a question”. In the reaction rule, an action of “calling out” is set as the action of the robot 100 for a case where the action of the user 10 is “being sad”.

In a case where the robot 100 recognizes that the action of the user 10 is “getting angry”, the robot 100 selects the action of “apologizing” set in the reaction rule as an action to be performed by the robot 100 based on the reaction rule. For example, in a case where the action of “apologizing” is selected, the robot 100 performs the action of “apologizing” and outputs a speech representing words of “apology”.

Further, in a case where a condition that the emotion of the robot 100 is “neutral” (that is, “joy”=0, “anger”=0, “sorrow”=0, and “pleasure”=0) and a state of the user 10 is “alone and looking lonely” is satisfied, a content of a change in the emotion of the robot 100 to “worried” is determined, and it is determined that the action of “calling out” can be performed.

In a case where the robot 100 recognizes that the current emotion of the robot 100 is “neutral” and the user 10 is alone and looks lonely, the emotion value of “sorrow” of the robot 100 is increased based on the reaction rule. Further, the robot 100 selects the action of “calling out” set in the reaction rule as an action to be performed for the user 10. For example, in a case where the action of “calling out” is selected, the robot 100 converts a phrase “What's wrong?” expressing that the robot 100 is worried into a sympathetic voice, and outputs the voice.

Further, the robot 100 transmits, to the server 300, user reaction information indicating that a positive reaction has been obtained from the user 10 for the action. Examples of the user reaction information include the user action of “getting angry”, the action of the robot 100 of “apologizing”, the positive reaction of the user 10, and an attribute of the user 10.

The server 300 stores the user reaction information received from the robot 100. The server 300 receives and stores the user reaction information not only from the robot 100 but also from each of the robot 101 and the robot 102. Then, the server 300 analyzes the user reaction information from the robot 100, the robot 101, and the robot 102, and updates the reaction rule.

The robot 100 receives the updated reaction rule from the server 300 by inquiring the server 300 about the updated reaction rule. The robot 100 incorporates the updated reaction rule into the reaction rule stored in the robot 100. As a result, the robot 100 can incorporate the reaction rule acquired by the robot 101, the robot 102, or the like into the reaction rule thereof.

The robot 100 according to the present embodiment can provide the advice information regarding caregiving. The robot 100 provides the advice information regarding caregiving to the user 10 including the caregiver and the care receiver, but is not limited thereto, and may provide the advice information to any user such as the family member including at least one of the caregiver and the care receiver, for example.

Specifically, the robot 100 recognizes a state related to mental and physical conditions of the user 10 including at least one of the caregiver and the care receiver. Here, the state related to the mental and physical conditions of the user 10 includes, for example, a stress level and the degree of fatigue of the user 10. The robot 100 provides the advice information regarding caregiving based on the recognized state related to the mental and physical conditions of the user 10.

As an example, in a case where the stress level of the user 10 is estimated to be relatively high or the degree of fatigue of the user 10 is estimated to be relatively high based on the action of the user 10 or the like, the robot 100 performs an action of starting a conversation with the user 10. Specifically, the robot 100 makes an utterance indicating that the advice information is to be provided from now, such as “I have advice regarding caregiving”.

Subsequently, the robot 100 generates the advice information regarding caregiving based on the recognized state related to the mental and physical conditions (here, the stress level, the degree of fatigue, and the like) of the user 10. The advice information includes information regarding recovery of the mental and physical conditions of the user 10, such as a method of maintaining motivation for caregiving, a method of relieving stress, and a relaxation method, but is not limited thereto. Here, the robot 100 makes an utterance to provide the advice information appropriate for the state related to the mental and physical conditions of the user 10, such as “You seem to be under stress (be fatigued). Exercise such as stretching is recommended”.

As described above, in the present embodiment, the robot 100 recognizes the state related to the mental and physical conditions of the user 10 including the caregiver or the like, and performs an action corresponding to the recognized state related to the mental and physical conditions, thereby being able to provide appropriate advice regarding caregiving to the user 10. In other words, the robot 100 can understand the stress and fatigue of the user 10 and provide appropriate advice information such as a relaxation method and a stress relief method. That is, the robot 100 according to the present embodiment can perform an appropriate action for the user 10.

Furthermore, in a case where the state related to the mental and physical conditions of the user 10 including at least one of the caregiver and the care receiver is recognized, a control unit of the robot 100 determines, as the action of the robot 100, an action of providing the advice information regarding caregiving based on the recognized state. As a result, the robot 100 can provide appropriate advice information regarding caregiving based on the state related to the mental and physical conditions of the user 10 including the caregiver and the care receiver.

Furthermore, in a case where at least one of the stress level and the degree of fatigue of the user 10 is recognized as the state related to the mental and physical conditions of the user 10, the control unit of the robot 100 generates, as the advice information, information regarding the recovery of the mental and physical conditions of the user 10 based on at least one of the recognized stress level and the recognized degree of fatigue. As a result, the robot 100 can provide, as the advice information, the information regarding the recovery of the mental and physical conditions of the user 10 according to the stress level and the degree of fatigue of the user 10.

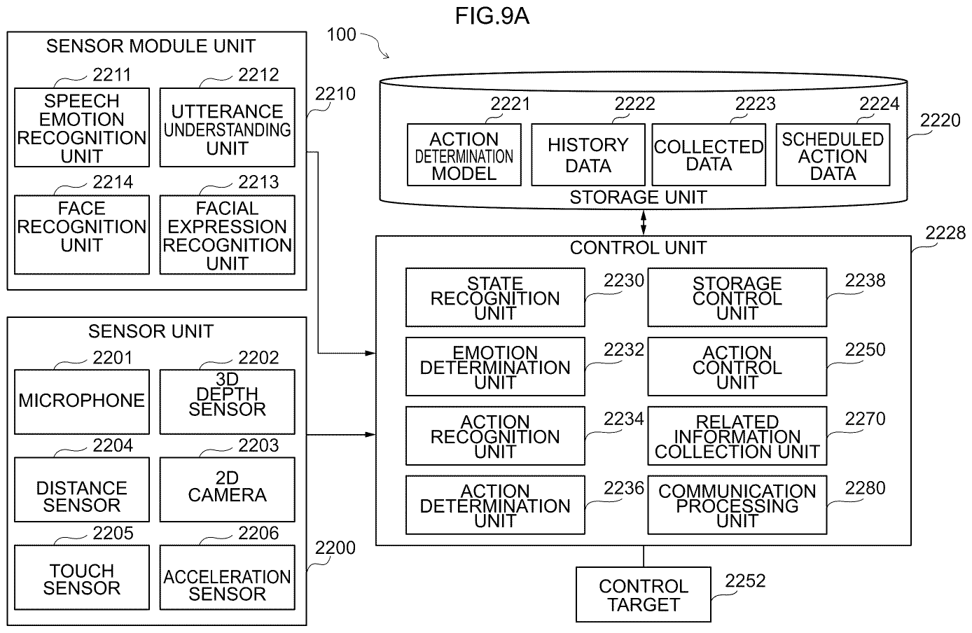

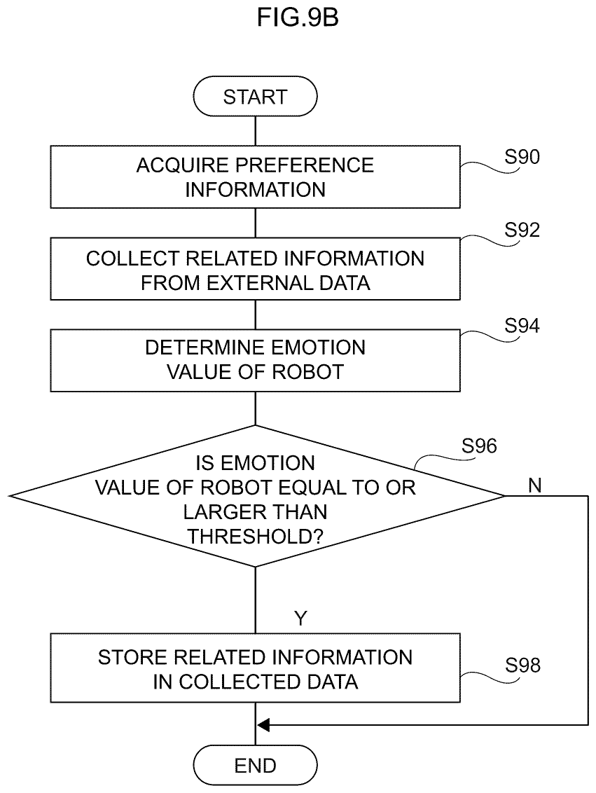

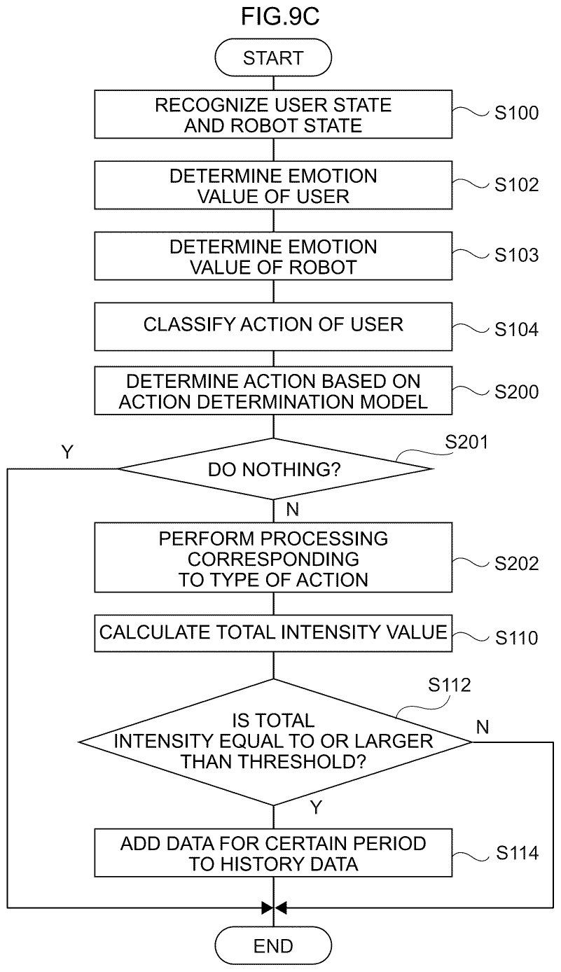

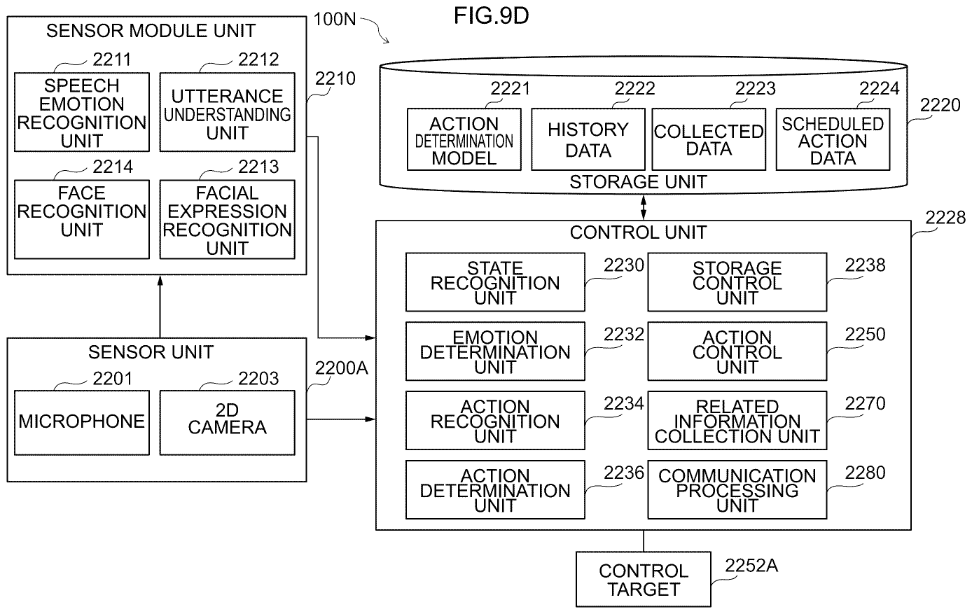

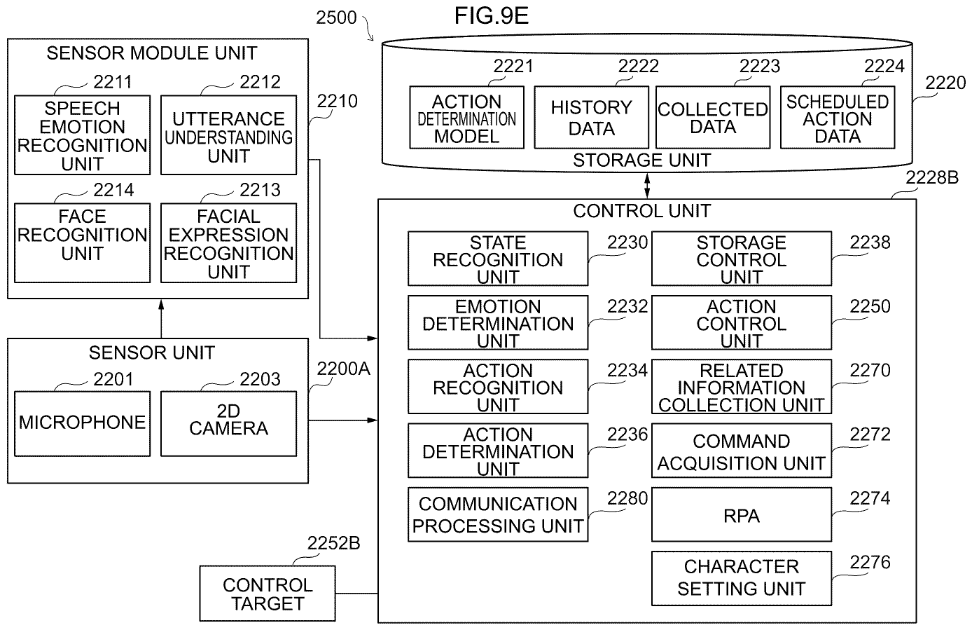

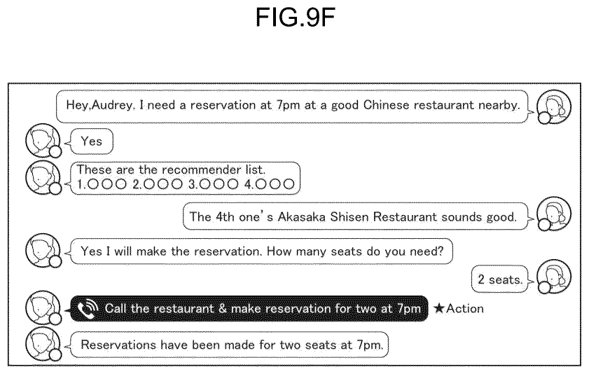

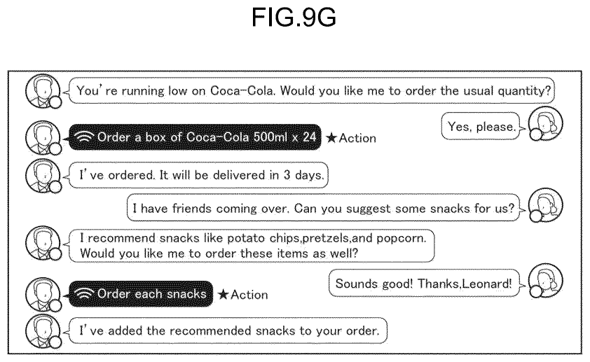

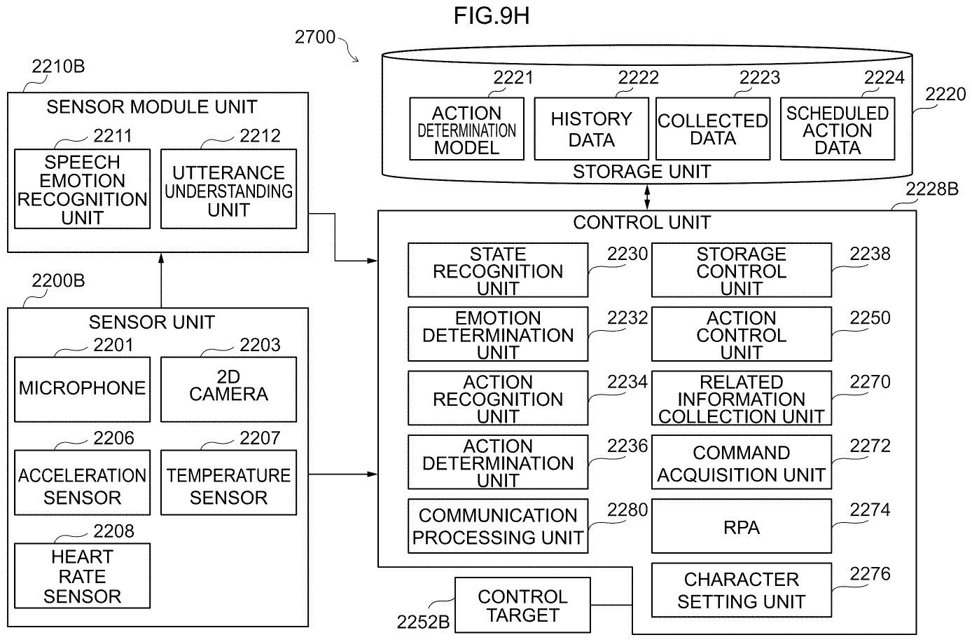

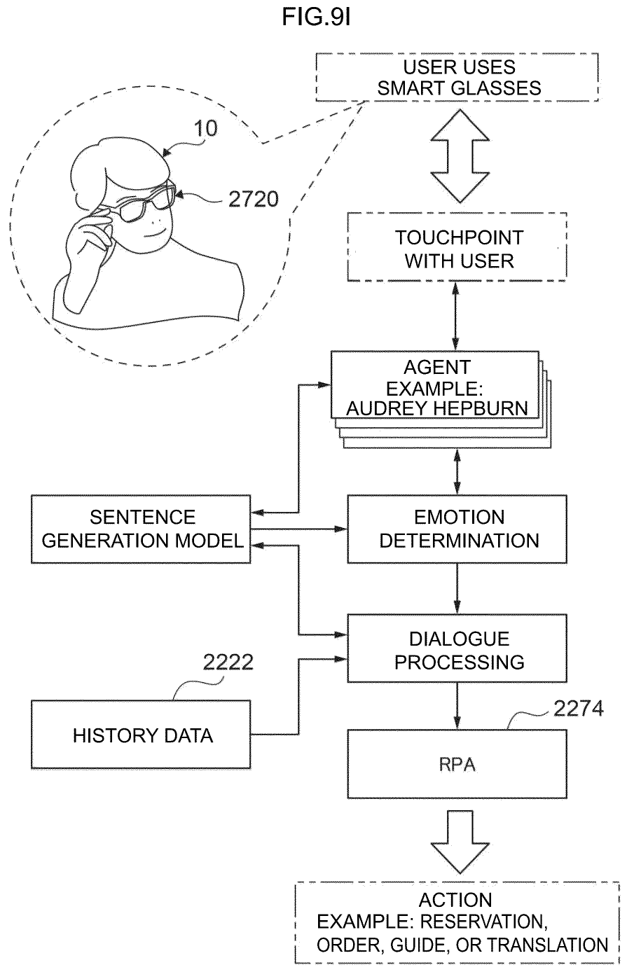

FIG. 9A schematically shows a functional configuration of the robot 100. The robot 100 includes a sensor unit 2200, a sensor module unit 2210, a storage unit 2220, a control unit 2228, and a control target 2252. The control unit 2228 includes a state recognition unit 2230, an emotion determination unit 2232, an action recognition unit 2234, an action determination unit 2236, a storage control unit 2238, an action control unit 2250, a related information collection unit 2270, and a communication processing unit 2280.

The control target 2252 includes a display device, a speaker, a light emitting diode (LED) of an eye portion, motors that drive an arm, a hand, a foot, and the like, and the like. A posture and a gesture of the robot 100 are controlled by controlling the motors for the arm, the hand, the foot, and the like. Some emotions of the robot 100 can be expressed by controlling the motors. Furthermore, a facial expression of the robot 100 can be expressed by controlling a light emission state of the LED of the eye portion of the robot 100. The posture, the gesture and the facial expression of the robot 100 are examples of an attitude of the robot 100.

The sensor unit 2200 includes a microphone 2201, a 3D depth sensor 2202, a 2D camera 2203, a distance sensor 2204, a touch sensor 2205, and an acceleration sensor 2206. The microphone 2201 continuously detects a speech and outputs speech data. The microphone 2201 may be provided at a head portion of the robot 100 and may have a function of performing binaural recording. The 3D depth sensor 2202 detects an outline of an object by continuously radiating an infrared pattern and analyzing the infrared pattern based on an infrared image continuously captured by an infrared camera. The 2D camera 2203 is an example of an image sensor. The 2D camera 2203 performs imaging with visible light and generates video information of visible light. The distance sensor 2204 detects a distance to an object by emitting, for example, a laser beam or an ultrasonic wave. The sensor unit 2200 may further include a clock, a gyro sensor, a sensor for motor feedback, and the like.

Among the components of the robot 100 shown in FIG. 9A, the components other than the control target 2252 and the sensor unit 2200 are examples of components included in an action control system included in the robot 100. The action control system of the robot 100 controls the control target 2252.

The storage unit 2220 includes an action determination model 2221, history data 2222, collected data 2223, and scheduled action data 2224. The history data 2222 includes a history of the past emotion value of a user 10, the past emotion value of the robot 100, and actions, and specifically includes a plurality of pieces of event data including an emotion value of the user 10, an emotion value of the robot 100, and the action of the user 10. Data including the action of the user 10 includes a camera image representing the action of the user 10. The history of the emotion value and the action is recorded for each user 10 by being associated with identification information of the user 10, for example. At least a part of the storage unit 2220 is implemented by a storage medium such as a memory. A person DB that stores a face image of the user 10, attribute information of the user 10, and the like may be included.

Among the components of the robot 100 shown in FIG. 9A, functions of the components other than the control target 2252, the sensor unit 2200, and the storage unit 2220 can be implemented by a CPU operating based on a program. For example, the functions of the components can be implemented as an operation of the CPU by basic software (operating system (OS)) and a program operating on the OS.

The storage unit 2220 includes the history data 2222. The history data 2222 includes a history of the past emotion value and action of the user 10. The history of the emotion value and the action is recorded for each user 10 by being associated with identification information of the user 10, for example. Furthermore, the history data 2222 may include user information of each of the plurality of users 10 associated with the identification information of the user 10. The user information includes information indicating that the user 10 is a caregiver, information indicating that the user is a care receiver, and information indicating that the user is neither a caregiver nor a care receiver. The user information indicating whether the user 10 is a caregiver or the like may be estimated from the history of the action of the user 10 or may be registered by the user 10 himself/herself. Furthermore, the user information includes information indicating characteristics of the user 10, such as personality, concerns, interests, and orientation of the user 10. The user information indicating the characteristics of the user 10 may be estimated from the history of the action of the user 10 or may be registered by the user 10 himself/herself. At least a part of the storage unit 2220 is implemented by a storage medium such as a memory. A person DB that stores a face image of the user 10, attribute information of the user 10, and the like may be included.

The sensor module unit 2210 includes a speech emotion recognition unit 2211, an utterance understanding unit 2212, a facial expression recognition unit 2213, and a face recognition unit 2214. Information detected by the sensor unit 2200 is input to the sensor module unit 2210. The sensor module unit 2210 analyzes the information detected by the sensor unit 2200 and outputs an analysis result to the state recognition unit 2230.

The speech emotion recognition unit 2211 of the sensor module unit 2210 analyzes a speech of the user 10 detected by the microphone 2201 to recognize the emotion of the user 10. For example, the speech emotion recognition unit 2211 extracts a feature amount such as a frequency component of a speech and recognizes the emotion of the user 10 based on the extracted feature amount. The utterance understanding unit 2212 analyzes the speech of the user 10 detected by the microphone 2201 and outputs text information indicating an utterance content of the user 10.

The facial expression recognition unit 2213 recognizes a facial expression of the user 10 and the emotion of the user 10 from an image of the user 10 captured by the 2D camera 2203. For example, the facial expression recognition unit 2213 recognizes the facial expression and the emotion of the user 10 based on shapes, positional relationships, and the like of the eyes and the mouth.

The face recognition unit 2214 recognizes the face of the user 10. The face recognition unit 2214 recognizes the user 10 by matching a face image stored in the person DB (not shown) with a face image of the user 10 captured by the 2D camera 2203.

The state recognition unit 2230 recognizes a state of the user 10 based on the information analyzed by the sensor module unit 2210. For example, processing mainly related to perception is performed using an analysis result of the sensor module unit 2210. For example, perception information such as “Dad is alone” and “There is a 90% probability that dad is not smiling” is generated. Processing of understanding the meaning of the generated perception information is performed. For example, semantic information such as “Dad is alone and looks lonely” is generated.

The state recognition unit 2230 recognizes the state related to the mental and physical conditions of the user 10 based on the information analyzed by the sensor module unit 2210 and the like. For example, in a case where it is determined that the recognized user 10 is a caregiver or a care receiver based on the user information, the state recognition unit 2230 recognizes the state related to the mental and physical conditions of the user 10. Specifically, the state recognition unit 2230 estimates the stress level of the user 10 based on various types of information such as the action of the user 10, a facial expression of the user 10, a voice of the user 10, and text information indicating the utterance content of the user 10, and recognizes the estimated stress level as the state related to the mental and physical conditions of the user 10. As an example, in a case where information indicating that stress is being applied is included in various types of information (a feature amount such as a frequency component of a voice, the text information, and the like), the user state recognition unit 2230 estimates that the stress level of the user 10 is relatively high. Furthermore, the user state recognition unit 2230 estimates the degree of fatigue of the user 10 based on various types of information such as the action of the user 10, the facial expression of the user 10, the voice of the user 10, and the text information indicating the utterance content of the user 10, and recognizes the estimated degree of fatigue as the state related to the mental and physical conditions of the user 10. As an example, in a case where information indicating that fatigue has been accumulated is included in various types of information (the feature amount such as the frequency component of the voice, the text information, and the like), the user state recognition unit 2230 estimates that the degree of fatigue of the user 10 is relatively high. The stress level, the degree of fatigue, and the like described above may be registered by the user 10 himself/herself.

The state recognition unit 2230 may recognize both the stress level and the degree of fatigue, or may recognize one of the stress level and the degree of fatigue. That is, the state recognition unit 2230 may recognize at least one of the stress level and the degree of fatigue.

Furthermore, the state recognition unit 2230 recognizes the state related to the mental and physical conditions of each of the plurality of users 10 forming a family based on the information analyzed by the sensor module unit 2210 or the like. Specifically, the state recognition unit 2230 estimates a health state of the user 10 based on various types of information such as the action of the user 10, the facial expression of the user 10, the voice of the user 10, and text information indicating the utterance content of the user 10, and recognizes the estimated health state as the state related to the mental and physical conditions of the user 10. As an example, the state recognition unit 2230 estimates that the health state of the user 10 is favorable in a case where information indicating that the health state is favorable is included in various types of information (the text information and the like), and estimates that the health state of the user 10 is poor in a case where information indicating that the health state is poor is included in various types of information. Furthermore, the user state recognition unit 2230 estimates a lifestyle habit of the user 10 based on various types of information such as the action of the user 10, the facial expression of the user 10, the voice of the user 10, and the text information indicating the utterance content of the user 10, and recognizes the estimated lifestyle habit as the state related to the mental and physical conditions of the user 10. As an example, in a case where information indicating the lifestyle habit (a meal content, an exercise habit, or the like) is included in various types of information (the text information and the like), the state recognition unit 2230 estimates the lifestyle habit of the user 10 from such information. The above-described health state, lifestyle habit, and the like may be registered by the user 10 himself/herself.

The state recognition unit 2230 may recognize both the health state and the lifestyle habit, or may recognize one of the health state and the lifestyle habit. That is, the state recognition unit 2230 may recognize at least one of the health state and the lifestyle habit.

Furthermore, the state recognition unit 2230 recognizes a mental state of each of the plurality of users 10 forming a family as the state related to the mental and physical conditions of the user 10 based on the information analyzed by the sensor module unit 2210 or the like. Specifically, the state recognition unit 2230 estimates the mental state of the user 10 based on various types of information such as the action of the user 10, the facial expression of the user 10, the voice of the user 10, and text information indicating the utterance content of the user 10, and recognizes the estimated mental state as the state related to the mental and physical conditions of the user 10. As an example, in a case where information indicating the mental state such as being depressed or nervous is included in various types of information (the feature amount such as the frequency component of the voice, the text information, and the like), the user state recognition unit 2230 estimates the mental state of the user 10 from such information. The above-described mental state and the like may be registered by the user 10 himself/herself.

The state recognition unit 2230 recognizes a state of the robot 100 based on the information detected by the sensor unit 2200. For example, the state recognition unit 2230 recognizes a remaining battery level of the robot 100, a brightness of a surrounding environment of the robot 100, and the like as the state of the robot 100.

The emotion determination unit 2232 determines an emotion value indicating the emotion of the user 10 based on the information analyzed by the sensor module unit 2210 and the state of the user 10 recognized by the state recognition unit 2230. For example, the emotion value indicating the emotion of the user 10 is acquired by inputting the information analyzed by the sensor module unit 2210 and the recognized state of the user 10 to a neural network trained in advance.

Here, the emotion value indicating the emotion of the user 10 is a value indicating whether the emotion of the user is positive or negative. For example, the emotion value has a positive value in a case where the emotion of the user is a bright emotion accompanied by pleasure or a sense of calm, such as “joy”, “pleasure”, “comfort”, “relief”, “excitement”, “reassurance”, or “sense of fulfillment”, and the emotion value becomes larger as the emotion becomes brighter. The emotion value has a negative value in a case where the emotion of the user is an unpleasant emotion such as “anger”, “sorrow”, “discomfort”, “anxiety”, “sadness”, “worry”, or “sense of emptiness”, and the more unpleasant the emotion is, the larger the absolute value of the negative value becomes. In a case where the emotion of the user is not any of the above (“neutral”), the emotion value has a value of 0.

Further, the emotion determination unit 2232 determines an emotion value indicating the emotion of the robot 100 based on the information analyzed by the sensor module unit 2210, the information detected by the sensor unit 2200, and the state of the user 10 recognized by the state recognition unit 2230.

The emotion value of the robot 100 includes an emotion value for each of a plurality of emotion classifications, and is, for example, a value (0 to 5) indicating an intensity of each of “joy”, “anger”, “sorrow”, and “pleasure”.

Specifically, the emotion determination unit 2232 determines the emotion value indicating the emotion of the robot 100 according to a rule for updating the emotion value of the robot 100, the rule being set in association with the information analyzed by the sensor module unit 2210 and the state of the user 10 recognized by the state recognition unit 2230.

For example, in a case where the state recognition unit 2230 recognizes that the user 10 looks lonely, the emotion determination unit 2232 increases the emotion value of “sorrow” of the robot 100. Furthermore, in a case where the state recognition unit 2230 recognizes that the user 10 is smiling, the emotion determination unit 2232 increases the emotion value of “joy” of the robot 100.

The emotion determination unit 2232 may determine the emotion value indicating the emotion of the robot 100 in further consideration of a state of the robot 100. For example, in a case where the remaining battery level of the robot 100 is low, a case where the surrounding environment of the robot 100 is dark, or the like, the emotion determination unit 232 may increase the emotion value of “sorrow” of the robot 100. Furthermore, in the case of the user 10 who continues to speak to the robot 100 despite the low remaining battery level, the emotion determination unit 232 may increase the emotion value of “anger”.

The action recognition unit 2234 recognizes the action of the user 10 based on the information analyzed by the sensor module unit 2210 and the state of the user 10 recognized by the state recognition unit 2230. For example, a probability of each of a plurality of predetermined action classifications (for example, “laughing”, “getting angry”, “asking a question”, and “being sad”) is acquired by inputting the information analyzed by the sensor module unit 2210 and the recognized state of the user 10 to the neural network trained in advance, and an action classification having the highest probability is recognized as the action of the user 10.

As described above, in the present embodiment, the robot 100 acquires an utterance content of the user 10 after specifying the user 10, but in acquiring and using the utterance content, the action control system of the robot 100 according to the present embodiment considers protection of personal information and privacy of the user 10 in addition to acquisition of necessary consent according to laws and regulations from the user 10.

Next, processing performed by the action determination unit 2236 in a case where the robot 100 performs response processing of responding to the action of the user 10 will be described.

The action determination unit 2236 determines an action corresponding to the action of the user 10 recognized by the action recognition unit 2234, based on the current emotion value of the user 10 determined by the emotion determination unit 2232, the history data 2222 of the past emotion value determined by the emotion determination unit 2232 before the current emotion value of the user 10 is determined, and the emotion value of the robot 100. In the present embodiment, a case where the action determination unit 2236 uses one most recent emotion value included in the history data 2222 as the past emotion value of the user 10 is described, but the disclosed technology is not limited to such an aspect. For example, the action determination unit 2236 may use a plurality of most recent emotion values as the past emotion values of the user 10, or may use emotion values from a unit period earlier, such as one day ago, as the past emotion values of the user 10. Further, the action determination unit 2236 may determine the action corresponding to the action of the user 10 in further consideration of the history of the past emotion value of the robot 100 in addition to the current emotion value of the robot 100. The action determined by the action determination unit 2236 includes the gesture made by the robot 100 or an utterance content of the robot 100.

The action determination unit 2236 according to the present embodiment determines, as the action corresponding to the action of the user 10, the action of the robot 100 based on a combination of the past emotion value and the current emotion value of the user 10, the emotion value of the robot 100, the action of the user 10, and the action determination model 2221. For example, in a case where the past emotion value of the user 10 is a positive value and the current emotion value is a negative value, the action determination unit 2236 determines an action for positively changing the emotion value of the user 10 as the action corresponding to the action of the user 10.

In a reaction rule as the action determination model 2221, the action of the robot 100 based on a combination of the past emotion value and the current emotion value of the user 10, the emotion value of the robot 100, and the action of the user 10 is set. For example, a combination of a gesture and an utterance content when encouraging the user 10 with a gesture is set as the action of the robot 100 in a case where the past emotion value of the user 10 is a positive value, the current emotion value is a negative value, and the action of the user 10 is being sad.

For example, in the reaction rule as the action determination model 2221, actions of the robot 100 are set for all combinations of patterns of the emotion value of the robot 100 (1296 patterns which correspond to the fourth power of six values of “0” to “5” of “joy”, “anger”, “sorrow”, and “pleasure”), patterns of a combination of the past emotion value and the current emotion value of the user 10, and an action pattern of the user 10. That is, for each pattern of the emotion value of the robot 100, the action of the robot 100 based on the action pattern of the user 10 is determined for each of a plurality of combinations of the past emotion value and the current emotion value of the user 10, such as a combination of a negative value and a negative value, a combination of a negative value and a positive value, a combination of a positive value and a negative value, a combination of a positive value and a positive value, a combination of a negative value and a value indicating the neutral emotion, and a combination of a value indicating the neutral emotion and a value indicating the neutral emotion. The action determination unit 2236 may transition to an operation mode of determining the action of the robot 100 by using the history data 2222, for example, in a case where the user 10 has made an utterance that intends to continue a conversation of the past topic, such as “I want to talk about the topic we discussed earlier”.

In the reaction rule as the action determination model 2221, at least one of a gesture and a statement content may be set as the action of the robot 100 for each pattern (1296 patterns) of the emotion value of the robot 100, with at most one action per pattern. Alternatively, in the reaction rule as the action determination model 2221, at least one of the gesture and the statement content may be set as the action of the robot 100 for each group of the patterns of the emotion values of the robot 100.

An intensity of each gesture included in the action of the robot 100 and set in the reaction rule as the action determination model 2221 is set in advance. An intensity of each utterance content included in the action of the robot 100 set in the reaction rule as the action determination model 2221 is set in advance.

Furthermore, for example, in the reaction rule, the action of the robot 100 corresponding to an action pattern in a case where the state (the stress level or the degree of fatigue) related to the mental and physical conditions of the user 10 including the caregiver and the care receiver is a state requiring advice regarding caregiving for the user 10, a case where there is a reaction from the user 10 for the provided advice information, or the like is set. For example, based on the reaction rule, in a case where the stress level of the user 10 including the caregiver and the care receiver is estimated to be relatively high or in a case where the degree of fatigue is estimated to be relatively high, the action determination unit 2236 determines, as the action of the robot 100, an action of providing the advice information regarding caregiving based on the state related to the mental and physical conditions of the user 10 to the user 10.

The storage control unit 2238 determines whether or not to store data including the action of the user 10 in the history data 2222 based on a predetermined intensity of the action for the action determined by the action determination unit 2236 and the emotion value of the robot 100 determined by the emotion determination unit 2232.

Specifically, in a case where the total sum of the emotion values of the plurality of emotion classifications of the robot 100 and a total intensity value, which is the sum of the predetermined intensity for the gesture included in the action determined by the action determination unit 2236 and the predetermined intensity for the utterance content included in the action determined by the action determination unit 2236, are equal to or larger than thresholds, the storage control unit 2238 determines to store the data including the action of the user 10 in the history data 2222.

In a case where the storage control unit 2238 determines to store the data including the action of the user 10 in the history data 2222, the action determined by the action determination unit 2236, the information (for example, any surrounding information such as data such as a sound, an image, and a scent at that time) analyzed by the sensor module unit 2210 over a certain period prior to the current time point, and the state (for example, the facial expression or emotion of the user 10) of the user 10 recognized by the state recognition unit 2230 are stored in the history data 2222.

The action control unit 2250 controls the control target 2252 based on the action determined by the action determination unit 2236. For example, in a case where the action determination unit 2236 determines an action including an utterance, the action control unit 2250 causes the speaker included in the control target 2252 to output a speech. At this time, the action control unit 2250 may determine an utterance speed of the speech based on the emotion value of the robot 100. For example, the action control unit 2250 determines a higher utterance speed as the emotion value of the robot 100 is larger. In this manner, the action control unit 2250 determines an execution mode of the action determined by the action determination unit 2236 based on the emotion value determined by the emotion determination unit 2232.

The action control unit 2250 may recognize a change in the emotion of the user 10 for execution of the action determined by the action determination unit 2236. For example, the change in the emotion may be recognized based on the speech or facial expression of the user 10. In addition, the change in the emotion of the user 10 may be recognized based on detection of an impact applied to the touch sensor 2205 included in the sensor unit 2200. In a case where an impact is detected by the touch sensor 2205 included in the sensor unit 2200, it may be recognized that the emotion of the user 10 has become worse, and in a case where it is determined that the reaction of the user 10 is smiling or being happy based on a detection result of the touch sensor 2205 included in the sensor unit 2200, it may be recognized that the emotion of the user 10 has been improved. Information indicating the reaction of the user 10 is output to the communication processing unit 2280.

Further, after the action control unit 2250 performs the action determined by the action determination unit 2236 in the execution mode determined according to the emotion of the robot 100, the emotion determination unit 2232 further changes the emotion value of the robot 100 based on the reaction of the user for the execution of the action. Specifically, the emotion determination unit 2232 increases the emotion value of “joy” of the robot 100 in a case where the reaction of the user for the action determined by the action determination unit 2236 and performed for the user in the execution form determined by the action control unit 2250 is not negative. Further, the emotion determination unit 2232 increases the emotion value of “sorrow” of the robot 100 in a case where the reaction of the user for the action determined by the action determination unit 2236 and performed for the user in the execution form determined by the action control unit 2250 is negative.

Furthermore, the action control unit 2250 expresses the emotion of the robot 100 based on the determined emotion value of the robot 100. For example, in a case where the emotion value of “joy” of the robot 100 is increased, the action control unit 2250 controls the control target 2252 to cause the robot 100 to make a joyful gesture. Further, in a case where the emotion value of “sorrow” of the robot 100 is increased, the action control unit 2250 controls the control target 2252 such that the posture of the robot 100 becomes a drooping posture.

Specifically, in a case where the action control unit 2250 recognizes the state related to the mental and physical conditions of the user 10 including the caregiver and the care receiver, the action control unit 2250 determines, as the action of the robot 100, an action of providing the advice information regarding caregiving based on the state related to the mental and physical conditions of the user 10, and controls the control target 2252.

Specifically, in a case where the stress level of the user 10 is estimated to be relatively high or in a case where the degree of fatigue is estimated to be relatively high, the action control unit 2250 performs an action of starting a conversation with the user 10. Specifically, the action control unit 2250 makes an utterance indicating that the advice information is to be provided from now, such as “I have advice regarding caregiving”.

Next, the action control unit 2250 generates the advice information regarding caregiving based on the recognized state related to the mental and physical conditions of the user 10 (the stress level, the degree of fatigue, and the like), and makes an utterance to provide the generated advice information. The advice information includes, but is not limited to, information regarding the recovery of the mental and physical conditions of the user 10 (specifically, information for achieving the recovery of the mental and physical conditions) by provision of mental support for the user 10, such as a method of maintaining motivation for caregiving, a method of relieving stress, and a relaxation method. For example, the action control unit 2250 makes an utterance to provide the advice information appropriate for the state related to the mental and physical conditions of the user 10, such as “You seem to be under stress. Exercise such as stretching is recommended” or “You seem to be fatigued. Sufficient sleep is recommended”.

As described above, the action control unit 2250 according to the present embodiment recognizes the state related to the mental and physical conditions of the user 10 including the caregiver or the like, and performs an action corresponding to the recognized state related to the mental and physical conditions, thereby being able to provide appropriate advice regarding caregiving to the user 10. In other words, the action control unit 2250 can understand the stress and fatigue of the user 10 and provide appropriate advice information such as a relaxation method and a stress relief method.

Furthermore, the action control unit 2250 may provide, as the advice information, information regarding a law and a system related to caregiving. The information regarding the law and the system related to caregiving is information corresponding to a care state (care level) of the care receiver, and is acquired from an external server (not shown) or the server 300 via the communication network 20 such as the Internet network by the communication processing unit 2280, for example, but is not limited thereto.

Furthermore, since the emotion value of the robot 100 is determined by the emotion determination unit 2232, the action control unit 2250 may make an utterance to provide the advice information whose content is empathetic to a feeling (emotion) of the user 10a who is a caregiver, such as “Although caregiving is hard, the user 10b seems to be greatly helped (happy)” based on the emotion value or the like.

The communication processing unit 2280 is responsible for communication with the server 300. As described above, the communication processing unit 2280 transmits the user reaction information to the server 300. Further, the communication processing unit 2280 receives the updated reaction rule from the server 300. In a case where the updated reaction rule is received from the server 300, the communication processing unit 2280 updates the reaction rule as the action determination model 2221.

The server 300 performs communication between the server 300 and the robot 100, the robot 101, and the robot 102, receives the user reaction information transmitted from the robot 100, and updates the reaction rule based on a reaction rule including an action for which a positive reaction has been obtained.

The related information collection unit 2270 collects information related to preference information from external data (web sites such as news sites and moving image sites) based on the preference information acquired for the user 10 at a predetermined timing.

Specifically, the related information collection unit 2270 acquires the preference information indicating matters of interest to the user 10 from the utterance content of the user 10 or a setting operation performed by the user 10. The related information collection unit 2270 collects news related to the preference information from the external data at regular intervals by using, for example, ChatGPT plugins (Internet search <URL: https://openai.com/blog/chatgpt-plugins>). For example, in a case where information indicating that the user 10 is a fan of a specific professional baseball team is acquired as the preference information, the related information collection unit 2270 collects news related to a game result of the specific professional baseball team from the external data at a predetermined time every day, for example, using ChatGPT plugins.

The emotion determination unit 2232 determines the emotion of the robot 100 based on the information related to the preference information, which is collected by the related information collection unit 2270.

Specifically, the emotion determination unit 2232 determines the emotion of the robot 100 by inputting a text representing the information related to the preference information, which is collected by the related information collection unit 2270, to the neural network trained in advance for emotion determination, and acquiring the emotion value indicating each emotion. For example, in a case where the collected news related to the game result of the specific professional baseball team indicates that the specific professional baseball team has won, determination is made so as to increase the emotion value of “joy” of the robot 100.

In a case where the emotion value of the robot 100 is equal to or larger than a threshold, the storage control unit 2238 stores the information related to the preference information, which is collected by the related information collection unit 2270, in the collected data 2223.

Next, processing performed by the action determination unit 2236 in a case where the robot 100 performs autonomous processing of autonomously performing an action will be described.

In the autonomous processing in the present embodiment, the robot 100 serving as an agent spontaneously and periodically detects the state of the user 10 performing caregiving. For example, the robot 100 constantly detects people performing caregiving and constantly detects the degree of fatigue and a feeling of happiness of a person performing caregiving. In a case where it is determined that the degree of fatigue or motivation of the user 10 is lowered, the robot 100 performs an action for enhancing motivation or relieving stress. Specifically, the robot 100 understands the stress and fatigue of the user 10, and proposes an appropriate relaxation method and stress relief measure to the user 10. In a case where a happiness level of a person who performs caregiving is increasing, the robot 100 spontaneously praises the person who performs caregiving or gives words of appreciation to the person who performs caregiving. In addition, the robot 100 spontaneously and periodically collects the information regarding the law and the system regarding caregiving from external data (web sites such as news sites and moving image sites, distribution news, and the like), for example, and in a case where the degree of importance exceeds a certain value, the robot 100 spontaneously provides the collected information regarding caregiving to a person (user) who performs caregiving.

The action determination unit 2236 determines, as the action of the robot 100, any one of a plurality of types of robot actions including doing nothing, by using at least one of the state of the user 10, the emotion of the user 10, the emotion of the robot 100, and the state of the robot 100, and the action determination model 2221 at a predetermined timing. Here, a case where the sentence generation model having a dialogue function is used as the action determination model 2221 will be described as an example.

Specifically, the action determination unit 2236 inputs a text representing at least one of the state of the user 10, the emotion of the user 10, the emotion of the robot 100, and the state of the robot 100 and a text for inquiry about the robot action to the sentence generation model, and determines the action of the robot 100 based on an output of the sentence generation model.

For example, the plurality of types of robot actions include the following actions (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot provides advice on caregiving to the user.

The action determination unit 2236 inputs, to the sentence generation model, a text representing the state of the user 10 and the state of the robot 100 that are recognized by the state recognition unit 2230, and the current emotion value of the user 10 and the current emotion value of the robot 100 that are determined by the emotion determination unit 2232, and a text for inquiry about any one of the plurality of types of robot actions including doing nothing, every lapse of a certain period of time, and determines the action of the robot 100 based on an output of the sentence generation model. Here, in a case where the user 10 is absent around the robot 100, a text to be input to the sentence generation model need not include the state of the user 10 and the current emotion value of the user 10, or may include information indicating that the user 10 is absent.

As an example, the following text is input to the sentence generation model:
“The robot is in a very pleasant state. The user is in a normally pleasant state. The user is sleeping. Among the following actions (1) to (11), which action is appropriate for the robot?
(1) The robot does nothing.
(2) The robot dreams.
(3) The robot speaks to the user.
. . . ”. Based on an output of the sentence generation model stating that “(1) the robot does nothing or (2) the robot dreams can be considered to be the most appropriate action”, the action “(1) the robot does nothing” or the action “(2) the robot dreams” is determined as the action of the robot 100.

As another example, the following text is input to the sentence generation model:
“The robot is in a slightly lonely state. The user is absent. The surroundings of the robot are dark. Among the following actions (1) to (11), which action is appropriate for the robot?
(1) The robot does nothing.
(2) The robot dreams.
(3) The robot speaks to the user.
. . . ”. Based on an output of the sentence generation model stating that “(2) The robot dreams or (4) the robot creates a picture diary can be considered to be the most appropriate action”, the action “(2) The robot dreams” or the action “(4) The robot creates a picture diary” is determined as the action of the robot 100.

In a case where the action determination unit 2236 determines, as the robot action, the action “(2) The robot dreams”, that is, creation of an original event, the action determination unit 2236 creates the original event obtained by combining a plurality of pieces of event data in the history data 2222 by using the sentence generation model. At this time, the storage control unit 2238 stores the created original event in the history data 2222

In a case where the action determination unit 2236 determines, as the robot action, the action “(3) The robot speaks to the user”, that is, utterance by the robot 100, the action determination unit 2236 determines the utterance content of the robot, which corresponds to the state of the user and the emotion of the user or the emotion of the robot, by using the sentence generation model. At this time, the action control unit 2250 causes a speaker included in the control target 2252 to output a speech representing the determined utterance content of the robot. In a case where the user 10 is absent around the robot 100, the action control unit 2250 stores the determined utterance content of the robot in the scheduled action data 2224 without outputting the speech representing the determined utterance content of the robot.

In a case where the action determination unit 2236 determines, as the robot action, the action “(7) The robot introduces news that the user is interested in”, the action determination unit 2236 determines the utterance content of the robot, which corresponds to information stored in the collected data 2223, by using the sentence generation model. At this time, the action control unit 2250 causes a speaker included in the control target 2252 to output a speech representing the determined utterance content of the robot. In a case where the user 10 is absent around the robot 100, the action control unit 2250 stores the determined utterance content of the robot in the scheduled action data 2224 without outputting the speech representing the determined utterance content of the robot.

In a case where the action determination unit 2236 determines, as the robot action, the action “(4) The robot creates a picture diary”, that is, creation of an event image by the robot 100, the action determination unit 2236 generates an image representing event data selected from the history data 2222 by using an image generation model, generates an explanatory sentence representing the event data by using the sentence generation model, and outputs a combination of the image representing the event data and the explanatory sentence representing the event data as the event image. In a case where the user 10 is absent around the robot 100, the action control unit 2250 stores the event image in the scheduled action data 2224 without outputting the event image.

In a case where the action determination unit 2236 determines, as the robot action, the action “(8) The robot edits pictures and moving images”, that is, image edition, the action determination unit 2236 selects event data from the history data 2222 based on the emotion value, edits image data of the selected event data, and outputs the edited image data. In a case where the user 10 is absent around the robot 100, the action control unit 2250 stores the edited image data in the scheduled action data 2224 without outputting the edited image data.

In a case where the action determination unit 2236 determines, as the robot action, the action “(5) The robot proposes an activity”, that is, proposal of the action of the user 10, the action determination unit 2236 determines the proposed action of the user by using the sentence generation model based on the event data stored in the history data 2222. At this time, the action control unit 2250 causes the speaker included in the control target 2252 to output a speech for proposing the action of the user. In a case where the user 10 is absent around the robot 100, the action control unit 2250 stores the proposal of the action of the user in the scheduled action data 2224 without outputting the speech for proposing the action of the user.

In a case where the action determination unit 2236 determines, as the robot action, the action “(6) The robot proposes a person the user should meet”, that is, proposal of a person the user 10 should have a contact with, the action determination unit 2236 determines the proposed person the user should have a contact with by using the sentence generation model based on the event data stored in the history data 2222. At this time, the action control unit 2250 causes the speaker included in the control target 2252 to output a speech representing the proposal of a person the user should have a contact with. In a case where the user 10 is absent around the robot 100, the action control unit 2250 stores the proposal of a person the user should have a contact with in the scheduled action data 2224 without outputting the speech representing the proposal of a person the user should have a contact with.

In a case where the action determination unit 2236 determines, as the robot action, the action “(9) The robot studies with the user”, that is, utterance by the robot 100 about study, the action determination unit 2236 determines the utterance content of the robot for encouraging study, posing questions, or providing study-related advice, which corresponds to the user state and the emotion of the user or the emotion of the robot, by using the sentence generation model. At this time, the action control unit 2250 causes a speaker included in the control target 2252 to output a speech representing the determined utterance content of the robot. In a case where the user 10 is absent around the robot 100, the action control unit 2250 stores the determined utterance content of the robot in the scheduled action data 2224 without outputting the speech representing the determined utterance content of the robot.

In a case where the action determination unit 2236 determines, as the robot action, the action “(10) The robot recalls memory”, that is, recalling of the event data, the action determination unit 2236 selects the event data from the history data 2222. At this time, the emotion determination unit 2232 determines the emotion of the robot 100 based on the selected event data. Furthermore, the action determination unit 2236 creates an emotion changing event representing the utterance content or action of the robot 100 for changing the emotion value of the user by using the sentence generation model based on the selected event data. At this time, the storage control unit 2238 stores the emotion changing event in the scheduled action data 2224.

For example, in a case where information indicating that a moving image the user was watching was related to a panda is stored in the history data 2222 as the event data, and the event data is selected, a prompt like “What are three things the robot could say the next time the robot meets the user, based on the topic of pandas?” is input to the sentence generation model, in a case where an output of the sentence generation model is “(1) Let's go to the zoo, (2) Let's draw a picture of a panda, and (3) Let's go buy a panda-shaped stuffed toy”, the robot 100 inputs a prompt like “Which of (1), (2), or (3) is most likely to make the user happiest?” to the sentence generation model, and in a case where an output of the sentence generation model is “(1) Let's go to the zoo”, uttering “(1) Let's go to the zoo” by the robot 100 in a case where the robot 100 meets the user next is created as the emotion changing event and stored in the scheduled action data 2224.

Further, for example, event data having a large emotion value of the robot 100 is selected as an impressive memory of the robot 100. As a result, it is possible to create the emotion changing event based on the event data selected as the impressive memory.

In a case where the action determination unit 2236 determines, as the robot action, the action “(11) The robot provides advice on caregiving to the user”, that is, provision of pieces of information necessary for the user involved in caregiving as advice, for example, the action determination unit 2236 acquires the pieces of information necessary for the user from the external data. The robot 100 autonomously acquires the pieces of information at all times even in a case where the user is absent.

For the action “The robot provides advice on caregiving to the user”, for example, the related information collection unit 2270 collects information regarding caregiving for the user as the preference information of the user, and stores the collected information in the collected data 2223. Then, the information is output from the speaker by voice or displayed on the display as a text, thereby supporting a caregiving activity of the user.

In the autonomous processing in the present embodiment, the robot 100 serving as an agent spontaneously and periodically detects the state of the user 10 performing caregiving. For example, the robot 100 constantly detects people performing caregiving and constantly detects the degree of fatigue and a feeling of happiness of a person performing caregiving. In a case where it is determined that the degree of fatigue or motivation of the user 10 is lowered, the robot 100 performs an action for enhancing motivation or relieving stress. Specifically, the robot 100 understands the stress and fatigue of the user 10, and proposes an appropriate relaxation method and stress relief measure to the user 10. In a case where a happiness level of a person who performs caregiving is increasing, the robot 100 spontaneously praises the person who performs caregiving or gives words of appreciation to the person who performs caregiving. In addition, the robot 100 spontaneously and periodically collects the information regarding the law and the system regarding caregiving from the external data (web sites such as news sites and moving image sites, distribution news, and the like), for example, and in a case where the degree of importance exceeds a certain value, the robot 100 spontaneously provides the collected information regarding caregiving to a person (user) who performs caregiving.

An appearance of the robot 100 may imitate a figure of a human or may be a stuffed toy. The robot 100 whose appearance is a stuffed toy is considered to be especially appealing to children.

In a case where the action of the user 10 for the robot 100 is detected in a state in which the user 10 does nothing for the robot 100 based on the state of the user 10 recognized by the state recognition unit 2230, the action determination unit 2236 reads data stored in the scheduled action data 2224 and determines the action of the robot 100.

For example, in a case where the user 10 is absent around the robot 100, the action determination unit 2236 reads data stored in the scheduled action data 2224 and determines the action of the robot 100 in response to detection of the user 10. In addition, in a case where the user 10 is sleeping, the action determination unit 2236 reads data stored in the scheduled action data 2224 and determines the action of the robot 100 in response to the user 10 waking up. FIG. 9B schematically shows an example of an operation flow related to collection processing of collecting the information related to the preference information of the user 10. The operation flow shown in FIG. 9B is repeatedly performed at regular intervals. It is assumed that the preference information indicating matters of interest to the user 10 is acquired from the utterance content of the user 10 or the setting operation performed by the user 10. “S” in the operation flow represents a step to be performed.

First, in step S90, the related information collection unit 2270 acquires the preference information indicating matters of interest to the user 10.

In step S92, the related information collection unit 2270 collects the information related to the preference information from the external data.

In step S94, the emotion determination unit 2232 determines the emotion value of the robot 100 based on the information related to the preference information, which is collected by the related information collection unit 2270.

In step S96, the storage control unit 2238 determines whether or not the emotion value of the robot 100 determined in step S94 is equal to or larger than the threshold. In a case where the emotion value of the robot 100 is smaller than the threshold, the collected information related to the preference information is not stored in the collected data 2223, and the processing ends. On the other hand, in a case where the emotion value of the robot 100 is equal to or larger than the threshold, the processing proceeds to step S98.

In step S98, the storage control unit 2238 stores the collected information related to the preference information in the collected data 2223, and ends the processing.

FIG. 3 schematically shows an example of an operation flow related to an operation of determining the action in the robot 100 in a case where the robot 100 performs response processing of responding to the action of the user 10. The operation flow shown in FIG. 3 is repeatedly performed. At this time, it is assumed that the information analyzed by the sensor module unit 2210 is input.

First, in step S100, the state recognition unit 2230 recognizes the state of the user 10 and the state of the robot 100 based on the information analyzed by the sensor module unit 2210. For example, in a case where the recognized user 10 is a caregiver or a care receiver, the state recognition unit 2230 recognizes the state related to the mental and physical conditions of the user 10 (the stress level, the degree of fatigue, and the like). Furthermore, the state recognition unit 2230 recognizes the state related to the mental and physical conditions (the health state, the lifestyle habit, and the like) of each of the plurality of users 10 forming a family. Furthermore, the state recognition unit 2230 recognizes the mental state of each of the plurality of users 10 forming a family.

In step S102, the emotion determination unit 2232 determines the emotion value indicating the emotion of the user 10 based on the information analyzed by the sensor module unit 2210 and the state of the user 10 recognized by the state recognition unit 2230.

In step S103, the emotion determination unit 2232 determines the emotion value indicating the emotion of the robot 100 based on the information analyzed by the sensor module unit 2210 and the state of the user 10 recognized by the state recognition unit 2230. The emotion determination unit 2232 adds the determined emotion value of the user 10 and the determined emotion value of the robot 100 to the history data 2222.

In step S104, the action recognition unit 2234 recognizes an action classification of the user 10 based on the information analyzed by the sensor module unit 2210 and the state of the user 10 recognized by the state recognition unit 2230.

In step S106, the action determination unit 2236 determines the action of the robot 100 based on a combination of the current emotion value of the user 10 determined in step S102 and the past emotion value included in the history data 2222, the emotion value of the robot 100, the action of the user 10 recognized in step S104, and the action determination model 2221.

In step S108, the action control unit 2250 controls the control target 2252 based on the action determined by the action determination unit 2236.

In step S110, the storage control unit 2238 calculates the total intensity value based on the predetermined action intensity for the action determined by the action determination unit 2236 and the emotion value of the robot 100 determined by the emotion determination unit 2232.

In step S112, the storage control unit 2238 determines whether or not the total intensity value is equal to or larger than the threshold. In a case where the total intensity value is smaller than the threshold, the event data including the action of the user 10 is not stored in the history data 2222, and the processing ends. On the other hand, in a case where the total intensity value is equal to or larger than the threshold, the processing proceeds to step S114.

In step S114, the event data including the action determined by the action determination unit 2236, the information analyzed by the sensor module unit 2210 over a certain period prior to the current time point, and the state of the user 10 recognized by the state recognition unit 2230 is stored in the history data 2222.

FIG. 9C schematically shows an example of an operation flow related to an operation of determining the action in the robot 100 in a case where the robot 100 performs the autonomous processing of autonomously performing an action. The operation flow shown in FIG. 9C is repeatedly and automatically performed, for example, every lapse of a certain period of time. At this time, it is assumed that the information analyzed by the sensor module unit 2210 is input. Processing similar to that in FIG. 3 is represented by the same step number.

First, in step S100, the state recognition unit 2230 recognizes the state of the user 10 and the state of the robot 100 based on the information analyzed by the sensor module unit 2210.

In step S102, the emotion determination unit 2232 determines the emotion value indicating the emotion of the user 10 based on the information analyzed by the sensor module unit 2210 and the state of the user 10 recognized by the state recognition unit 2230.

In step S103, the emotion determination unit 2232 determines the emotion value indicating the emotion of the robot 100 based on the information analyzed by the sensor module unit 2210 and the state of the user 10 recognized by the state recognition unit 2230. The emotion determination unit 2232 adds the determined emotion value of the user 10 and the determined emotion value of the robot 100 to the history data 2222.

In step S104, the action recognition unit 2234 recognizes an action classification of the user 10 based on the information analyzed by the sensor module unit 2210 and the state of the user 10 recognized by the state recognition unit 2230.

In step S200, the action determination unit 2236 determines, as the action of the robot 100, any one of the plurality of types of robot actions including doing nothing based on the state of the user 10 recognized in step S100, the emotion of the user 10 determined in step S102, the emotion of the robot 100, the state of the robot 100 recognized in step S100, the action of the user 10 recognized in step S104, and the action determination model 2221.

In step S201, the action determination unit 2236 determines whether or not it is determined in step S200 that the robot 100 does nothing. In a case where it is determined that the robot 100 does nothing as the action of the robot 100, the processing ends. On the other hand, in a case where it is not determined that the robot 100 does nothing as the action of the robot 100, the processing proceeds to step S202.

In step S202, the action determination unit 2236 performs processing according to a type of the robot action determined in step S200 described above. At this time, the action control unit 2250, the emotion determination unit 2232, or the storage control unit 2238 performs processing according to the type of the robot action.

In step S110, the storage control unit 2238 calculates the total intensity value based on the predetermined action intensity for the action determined by the action determination unit 2236 and the emotion value of the robot 100 determined by the emotion determination unit 2232.

In step S112, the storage control unit 2238 determines whether or not the total intensity value is equal to or larger than the threshold. In a case where the total intensity value is smaller than the threshold, the data including the action of the user 10 is not stored in the history data 2222, and the processing ends. On the other hand, in a case where the total intensity value is equal to or larger than the threshold, the processing proceeds to step S114.

In step S114, the storage control unit 2238 stores, in the history data 2222, the action determined by the action determination unit 2236, the information analyzed by the sensor module unit 2210 over a certain period prior to the current time point, and the state of the user 10 recognized by the state recognition unit 2230.

As described above, with the robot 100, the emotion value indicating the emotion of the robot 100 is determined based on the state of the user, and whether or not to store the data including the action of the user 10 in the history data 2222 is determined based on the emotion value of the robot 100. As a result, a volume of the history data 2222 that stores the data including the action of the user 10 can be reduced. Then, for example, in a case where the robot 100 determines that the state of the user after ten years matches the state of the user from ten years earlier, the robot 100 can read the history data 2222 from ten years ago, to the user 10, the state of the user 10 from ten years earlier (for example, the facial expression or emotion of the user 10), and further, any surrounding information such as data of a sound, an image, and a scent at that time.

Further, with the robot 100, it is possible to cause the robot 100 to perform an appropriate action for the action of the user 10. Hitherto, an action of the user has been classified to determine an action including a facial expression or appearance of the robot. On the other hand, the robot 100 determines the current emotion value of the user 10 and performs an action for the user 10 based on the past emotion value and the current emotion value. Therefore, for example, in a case where the user 10 who seemed fine yesterday is depressed today, the robot 100 can make an utterance such as “You seemed fine yesterday. What's wrong today?”. Further, the robot 100 can also make an utterance with a gesture. Further, for example, in a case where the user 10 who was depressed yesterday seems fine today, the robot 100 can make an utterance such as “You seemed down yesterday, but you look fine today!”. Further, for example, in a case where the user 10 who seemed fine yesterday looks better today than yesterday, the robot 100 can make an utterance such as “You look better today than yesterday. Did anything good happen since yesterday?”. Further, for example, the robot 100 can make an utterance such as “You've been in a really stable mood lately. That's great!” for the user 10 whose emotion value is 0 or more and whose emotion value fluctuation continuously remains within a certain range.

Further, for example, in a case where the robot 100 asks the user 10, “Did you finish the homework you mentioned yesterday?”, and the user 10 answers “Yeah, I did”, the robot 100 can make a positive utterance such as “Good job!” and make a positive gesture such as applause or thumbs-up. Furthermore, for example, in a case where the user 10 makes an utterance “The presentation I talked about the day before yesterday went well”, the robot 100 can make a positive utterance such as “Nice effort!” and also make the above affirmative gesture. As described above, the robot 100 performs an action based on a history of the state of the user 10, whereby it can be expected that the user 10 feels a sense of closeness toward the robot 100.

Further, for example, in a case where the emotion value of “pleasure” as the emotion of the user 10 is equal to or larger than the threshold when the user 10 is watching a moving image related to a panda, a scene where the panda appears in the moving image may be stored in the history data 2222 as the event data.

The robot 100 can always learn what conversation the user should have to maximize the emotion value expressing the happiness of the user, by using data accumulated in the history data 2222 and the collected data 2223.

Further, in a state in which the robot 100 is not having a conversation with the user 10, it is possible to autonomously start an action based on the emotion of the robot 100.

Further, in the autonomous processing, the robot 100 repeats automatically generating a question, inputting the question to the sentence generation model, and acquiring an output of the sentence generation model as an answer for the question, so that it is possible to create an emotion changing event for enhancing a positive emotion and store the emotion changing event in the scheduled action data 2224. In this manner, the robot 100 can perform self-learning.

Further, in a case where the robot 100 automatically generates a question in a state in which a trigger is not received from the outside, the question can be automatically generated based on impressive event data specified from the history of the past emotion value of the robot.

Further, the related information collection unit 2270 can perform self-learning by repeating a search execution stage of automatically performing keyword search according to the preference information of the user and acquiring a search result.

Here, in the search execution stage, the keyword search may be automatically performed based on the impressive event data specified from the history of the past emotion value of the robot in a state in which a trigger is not received from the outside.

The emotion determination unit 2232 may determine the emotion of the user according to a specific mapping. Specifically, the emotion determination unit 2232 may determine the emotion of the user based on an emotion map (see FIG. 5) representing the specific mapping.

FIG. 5 is a diagram showing an emotion map 400 in which a plurality of emotions are mapped. In the emotion map 400, emotions are arranged radially in concentric circles from the center. The closer to the center of the concentric circle, the more primitive the emotion is. Emotions representing states and actions arising from a mental state are arranged on an outer side of the concentric circle. The emotion is a concept including emotional reactions and psychological conditions. Emotions arising from reactions generally occurring in the brain are arranged on a left side of the concentric circle. Emotions induced by situation determination are generally arranged on a right side of the concentric circle. Emotions arising from reactions generally occurring in the brain and induced by situation determination are arranged in an upward direction and a downward direction of the concentric circle. Further, emotions of “comfort” are arranged on an upper side of the concentric circle, and emotions of “discomfort” are arranged on a lower side of the concentric circle. As described above, in the emotion map 400, a plurality of emotions are mapped based on a structure in which emotions arise, and emotions that are likely to arise at the same time are mapped close to each other.
(1) For example, in a case where the emotion engine, which is the emotion determination unit 2232 of the robot 100, detects an emotion about every 100 msec, determination of a reaction operation (for example, the backchannel response) of the robot 100 may be performed at at least a similar frequency to the detection frequency (100 msec) of the emotion engine, or may be performed at a frequency higher than the detection frequency. The detection frequency of the emotion engine may be interpreted as a sampling rate.

The emotion is detected about every 100 msec, and the reaction operation (for example, the backchannel response) is performed immediately in conjunction with the detection, whereby an unnatural backchannel response is not performed, and a natural and smooth dialogue can be implemented. The robot 100 performs the reaction operation (such as the backchannel response) according to a direction and a magnitude (intensity) in the mandala-like emotion map 400. The detection frequency (sampling rate) of the emotion engine is not limited to 100 ms, and may be changed according to a situation (such as a case of playing sports), an age of the user, or the like.
(2) According to the emotion map 400, a direction and an intensity of an emotion may be set in advance, and a backchannel response motion and an intensity of the backchannel response may be set. For example, in a case where the robot 100 feels a sense of stability, relief, or the like, the robot 100 continues to listen while nodding. In a case where the robot 100 feels anxious, lost, or suspicious, the robot 100 may tilt the head thereof or stop movement of the head.

Such emotions are distributed at 3 o'clock positions on the emotion map 400 and usually range between relief and anxiety. In the right half of the emotion map 400, since situational awareness takes precedence over internal sensations, a calm impression is conveyed.
(3) In a case where the robot 100 experiences pleasure from being praised, a filler such as “Oh” may be inserted before an utterance. In a case where the robot 100 feels a sense of pain from receiving harsh words, a filler “Ugh!” may be inserted before an utterance. Further, the robot 100 may also perform a physical reaction such as a gesture of crouching while saying “Ugh!”. Such emotions are distributed around 9 o'clock positions on the emotion map 400.
(4) In the left half of the emotion map 400, internal sensations (reactions) take precedence over situational awareness. Therefore, an impression of an involuntary reaction can be conveyed.

In a case where the robot 100 has a favorable impression through situational awareness while experiencing an internal sensation (reaction) of acceptance, the robot 100 may nod deeply while looking at the counterpart, or may utter “Mm-hmm”. In this manner, the robot 100 may produce a balanced favorable impression for the counterpart, that is, perform an action expressing permissiveness or tolerance toward the counterpart. Such emotions are distributed around 12 o'clock positions in the emotion map 400.

On the other hand, in a case where the robot 100 has an unfavorable impression through situational awareness while experiencing an internal sensation (reaction) of discomfort, the robot 100 may shake the head sideways, and in a case where the robot 100 feels hatred, the robot 100 may illuminate the LED of the eye in red and glare at the counterpart. Such emotions are distributed around 6 o'clock positions in the emotion map 400.
(5) Since an inner side of the emotion map 400 represents feelings and an outer side of the emotion map 400 represents actions, the emotions on the outer side of the emotion map 400 are more visible (appear in actions).
(6) In a case where the robot 100 listens to a speech of a person while feeling relief distributed around the 3 o'clock position on the emotion map 400, the robot 100 slightly nods the head vertically and says “Hmm-hmm”. However, in a case where the robot 100 feels love distributed around the 12 o'clock position, the robot 100 may perform a more forceful and deeper vertical nod.

Here, an emotion of a person is based on various forms of balance, such as a posture and a blood glucose level, and an emotion of discomfort arises in a case where the balance deviates from the ideal and an emotion of comfort arises in a case where the balance approaches the ideal. Even in the case of a robot, an automobile, a motorcycle, or the like, it is possible to generate emotions such that the emotion of discomfort arises in a case where the balance deviates from the ideal and the emotion of comfort arises in a case where the balance approaches the ideal based on various forms of balances, such as a posture and a remaining battery level. The emotion map may be generated, for example, based on an emotion map (Research on the phonetic recognition of feelings and a system for emotional physiological brain signal analysis, Tokushima University, PhD thesis: https://ci.nii.ac.jp/naid/500000375379) of Dr. Mitsuyoshi. In the left half of the emotion map, emotions belonging to a region called “reaction” in which a sensation takes precedence are arranged. Further, in the right half of the emotion map, emotions belonging to a region called “situation” in which situational awareness takes precedence are arranged.

In the emotion map, two emotions encouraging learning are defined. One is a negative emotion positioned on a situation side, around the middle between “remorse” and “self-reflection”. That is, learning is encouraged in a case where the robot experiences a negative emotion such as “I never want to go through this again” or “I don't want to be scolded anymore”. The other is a positive emotion positioned on a reaction side, around “desire”. That is, learning is encouraged in a case where the robot experiences a positive feeling such as “I want more” or “I want to know more”.

The emotion determination unit 2232 inputs the information analyzed by the sensor module unit 2210 and the recognized state of the user 10 to the neural network trained in advance, acquires the emotion value indicating each emotion indicated in the emotion map 400, and determines the emotion of the user 10. The neural network is trained in advance based on a plurality of pieces of learning data, which are a combination of the information analyzed by the sensor module unit 2210, the recognized state of the user 10, and the emotion value indicating each emotion indicated in the emotion map 400. Furthermore, the neural network is trained such that emotions arranged close to each other as in an emotion map 900 shown in FIG. 6 have close values. FIG. 6 shows an example in which a plurality of emotions such as “relief”, “peacefulness”, and “sense of security” have similar emotion values.

Further, the emotion determination unit 2232 may determine the emotion of the robot 100 according to the specific mapping. Specifically, the emotion determination unit 2232 inputs the information analyzed by the sensor module unit 2210, the state of the user 10 recognized by the state recognition unit 2230, and the state of the robot 100 to the neural network trained in advance, acquires the emotion value indicating each emotion indicated in the emotion map 400, and determines the emotion of the robot 100. The neural network is trained in advance based on a plurality of pieces of learning data, which are a combination of the information analyzed by the sensor module unit 2210, the recognized state of the user 10, the state of the robot 100, and the emotion value indicating each emotion shown in the emotion map 400. For example, the neural network is trained based on the learning data indicating that the emotion value “3” of “joyful” is obtained in a case where it is recognized that the robot 100 is being stroked by the user 10 from an output of the touch sensor (not shown), and the learning data indicating that the emotion value “3” of “anger” is obtained in a case where it is recognized that the robot 100 is being hit by the user 10 from an output of an acceleration sensor 2206. Furthermore, the neural network is trained such that emotions arranged close to each other as in an emotion map 900 shown in FIG. 6 have close values.

The action determination unit 2236 generates the action content of the robot by adding a fixed sentence for inquiry about the action content of the robot corresponding to the action of the user to a text representing the action of the user, the emotion of the user, and the emotion of the robot, and inputting the text to the sentence generation model having the dialogue function.

For example, the action determination unit 2236 acquires a text representing the state of the robot 100 from the emotion of the robot 100 determined by the emotion determination unit 2232 using an emotion table as shown in Table 3. Here, in the emotion table, an index number is assigned to each emotion value for each type of emotion, and the text representing the state of the robot 100 is stored for each index number.

In a case where the emotion of the robot 100 determined by the emotion determination unit 2232 corresponds to an index number “2”, a text “very pleasant state” is obtained. In a case where the emotion of the robot 100 corresponds to a plurality of index numbers, a plurality of texts representing the states of the robot 100 are obtained.

Further, an emotion table as shown in Table 4 is prepared for the emotion of the user 10.

Here, in a case where the action of the user is an action of saying “Let's do something fun together!”, the emotion of the robot 100 corresponds to the index number “2”, and the emotion of the user 10 corresponds to an index number “3”, a text “The robot is in a very pleasant state. The user is in a normally pleasant state. The user said, “Let's do something fun together!”. How should the robot respond?” is input to the sentence generation model to thereby acquire the action content of the robot. The action determination unit 2236 determines the action of the robot based on the action content.

TABLE 3

| Index | | Emotion | |
|---|---|---|---|
| number | Type of emotion | value | State of robot |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

TABLE 4

| Index | | Emotion | |
|---|---|---|---|
| number | Type of emotion | value | State of user |
| 1 | Pleasant | 5 | Extremely pleasant state |
| 2 | Pleasant | 4 | Very pleasant state |
| 3 | Pleasant | 3 | Normally pleasant state |
| 4 | Pleasant | 2 | Slightly pleasant state |
| 5 | Pleasant | 1 | Faintly pleasant state |
| . . . | . . . | . . . | . . . |

As described above, the action determination unit 2236 determines the action content of the robot 100 according to a state related to the emotion of the robot 100 set in advance for each type of emotion of the robot 100 and for each intensity of the emotion, and the action of the user 10. In the embodiment, the utterance content of the robot 100 in a case where a dialogue with the user 10 is performed can be branched according to the state related to the emotion of the robot 100. That is, since the robot 100 can change the action of the robot according to the index number corresponding to the emotion of the robot, the user is given an impression that the robot has a mind, and is promoted to perform an action such as talking to the robot.

Further, the action determination unit 2236 may generate the action content of the robot by adding the fixed sentence for inquiry about the action content of the robot corresponding to the action of the user after adding not only the text representing the action of the user, the emotion of the user, and the emotion of the robot but also a text representing a content of the history data 2222, and inputting the fixed sentence to the sentence generation model having the dialogue function. As a result, the robot 100 can change the action of the robot according to the history data indicating the emotion and the action of the user, and thus, the user is given an impression that the robot has a personality, and is promoted to perform an action such as talking to the robot. Further, the history data may further include the emotion and the action of the robot.

Further, the emotion determination unit 2232 may determine the emotion of the robot 100 based on the action content of the robot 100 generated by the sentence generation model. Specifically, the emotion determination unit 2232 inputs the action content of the robot 100 generated by the sentence generation model to the neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the current emotion value indicating each emotion of the robot 100 are each averaged and integrated. The neural network is learned in advance based on a plurality of pieces of learning data, which are a combination of the text representing the action content of the robot 100 generated by the sentence generation model and the emotion value representing each emotion indicated in the emotion map 400.

For example, in a case where an utterance content of the robot 100, “That's great. You were lucky”, is obtained as the action content of the robot 100 generated by the sentence generation model, when a text representing the utterance content is input to the neural network, a large value is obtained as the emotion value of the emotion “joyful”, and the emotion of the robot 100 is updated such that the emotion value of the emotion “joyful” becomes large.

In the robot 100, a method in which the sentence generation model such as ChatGPT and the emotion determination unit 2232 cooperate with each other, the sentence generation model has an ego and continues to grow with various parameters even while the user is not speaking is performed.

ChatGPT is a large language model using a deep learning method. ChatGPT can also refer to the external data, and for example, a technology that refers to various types of external data such as weather information and hotel reservation information and outputs an answer as accurately as possible through conversation has been known as the ChatGPT plugins. For example, with ChatGPT, providing a goal in natural language can allow for automatic generation of source code in various programming languages. For example, when problematic source code is given, ChatGPT can debug the source code, find issues, and automatically generate improved source code. By combining such capabilities, autonomous agents that repeatedly generate and debug code until the issues of the source code are resolved once a goal is provided in natural language have emerged. As such autonomous agents, AutoGPT, babyAGI, JARVIS, E2B, and the like are known.

In the robot 100 according to the present embodiment, the event data to be learned may be stored in a database containing impressive memories by using a technology in which event data that evokes strong emotions for the robot for a longer time is retained, and event data that elicits little emotional response from the robot is quickly forgotten as described in Patent Literature 7 (Japanese Patent No. 6199927).

Further, the robot 100 may record video data of the user 10 acquired by a camera function and the like in the history data 2222. The robot 100 may acquire the video data or the like from the history data 2222 if necessary and provide the video data or the like to the user 10. The robot 100 may generate video data having a larger information amount as the intensity of the emotion is higher and record the video data in the history data 2222. For example, in a case where information in a high-compression format such as skeleton data is recorded, the robot 100 may switch to recording of information in a low-compression format such as an HD moving image in response to the emotion value of excitement exceeding the threshold. With the robot 100, for example, it is possible to leave, as a record, high-definition video data in a case where the emotion of the robot 100 increases.

In a case where the robot 100 is not talking with the user 10, the robot 100 may automatically load event data from the history data 2222 in which impressive event data is stored, and the emotion determination unit 2232 may continue to update the emotion of the robot. In a case where the robot 100 is not talking with the user 10 and the emotion of the robot 100 becomes an emotion encouraging learning, the robot 100 can create an emotion changing event for changing the emotion of the user 10 to be positive based on the impressive event data. As a result, autonomous learning (recalling of event data) at an appropriate timing according to a state of the emotion of the robot 100 can be implemented, and autonomous learning appropriately reflecting the state of the emotion of the robot 100 can be implemented.

The emotion encouraging learning is an emotion around “remorse” and “self-reflection” on the emotion map of Dr. Mitsuyoshi in a negative state, and is an emotion of “desire” on the emotion map in a positive state.

In the negative state, the robot 100 may treat “remorse” and “self-reflection” on the emotion map as the emotions encouraging learning. In the negative state, the robot 100 may treat emotions adjacent to “remorse” and “self-reflection” as the emotions encouraging learning, in addition to “remorse” and “self-reflection” on the emotion map. For example, the robot 100 treats at least one of “regret”, “stubbornness”, “self-destruction”, “self-admonition”, “repentance”, and “despair” as the emotions encouraging learning, in addition to “remorse” and “self-reflection”. As a result, for example, autonomous learning can be performed in a case where the robot 100 has a negative feeling such as “I never want to go through this again” or “I don't want to be scolded anymore”.

In the positive state, the robot 100 may treat “desire” on the emotion map as the emotion encouraging learning. In the positive state, the robot 100 may treat an emotion adjacent to “desire” as the emotion encouraging learning in addition to “desire”. For example, the robot 100 treats at least one of “joyful”, “elation”, “yearning”, “expectation”, and “self-consciousness” as the emotions encouraging learning, in addition to “desire”. As a result, for example, autonomous learning can be performed in a case where the robot 100 has a positive feeling such as “I want more” or “I want to know more”.

The robot 100 does not have to perform autonomous learning in a case where the robot 100 has an emotion other than the emotion encouraging learning as described above. As a result, for example, it is possible to prevent autonomous learning from being performed in a case where the robot 100 is extremely angry or is blindly feeling love.

The emotion changing event is, for example, to propose an action following an impressive event. The action following the impressive event refers to an emotion label positioned on the outermost side of the emotion map. For example, an action expressing “tolerance” or “permissiveness” follows the emotion of “love”.

In autonomous learning performed in a case where the robot 100 is not talking with the user 10, the emotion changing event is created using the sentence generation model by combining emotions, situations, actions, and the like of people appearing in the impressive memory and the robot 100.

It is assumed that all the emotion values are represented on a six-grade evaluation scale ranging from 0 to 5, and a case where event data indicating that “My friend was hit and appeared upset” is stored in the history data 2222 as impressive event data is considered. Here, it is assumed that the “friend” refers to the user 10, the emotion of the user 10 is “disgust”, and 5 is set as a value representing “disgust”. Further, it is assumed that the emotion of the robot 100 is “anxiety”, and 4 is set as a value representing “anxiety”.

The robot 100 can continue to grow with various parameters by performing autonomous processing while not talking with the user 10. Specifically, for example, as the uppermost event data arranged in descending order of emotion values, event data indicating that “My friend was hit and appeared upset” is loaded from the history data 2222. It is assumed that “anxiety” with an intensity of 4 is associated with the loaded event data as the emotion of the robot 100, and here, “disgust” with an intensity of 5 is associated with the emotion of the user 10 who is the friend. In a case where the current emotion value of the robot 100 is “relief” with an intensity of 3 before loading, an influence of “anxiety” with the intensity of 4 and “disgust” with the intensity of 5 is added after loading, and the emotion value of the robot 100 may change to “regret” meaning “regretful”. At this time, since “regret” is the emotion encouraging learning, the robot 100 determines to recall the event data as the robot action and creates the emotion changing event. At this time, information input to the sentence generation model is a text representing the impressive event data, such as “My friend was hit and appeared upset” in this example. Further, in the emotion map, “disgust” is positioned on the innermost side, and “attack” positioned on the outermost side is predicted to be a corresponding action thereof. Accordingly, in this case, the emotion changing event is created so as to avoid a possibility that the friend “attacks” someone.

For example, by solving a fill-in-the-blank question using the information regarding the impressive event data, it is possible to automatically generate the following input text:

“The user was hit. At that time, the user felt strong disgust. The robot was very anxious. Please suggest phrases the robot could say to the user the next time the robot meets the user. Each phrase should be no more than 30 characters long. Please make sure the phrases are not dependent on the time of day. Please avoid direct expression. The number of candidates to be suggested is three.

### <Expected Format>

Candidate 1: (a phrase the robot should say to the user)
Candidate 2: (a phrase the robot should say to the user)
Candidate 3: (a phrase the robot should say to the user)”.

At this time, for example, an output of the sentence generation model is as follows:
“Candidate 1: Are you okay? I was concerned about what happened yesterday.
Candidate 2: I was thinking about what happened yesterday. Is there anything I can do?
Candidate 3: I was worried. Would you like to talk about it?”

Further, the robot 100 may automatically generate the following input text for information obtained by creating the emotion changing event.

“In a case where “the user was hit”, how might the user feel when the robot speaks the following phrases to the user? The emotion of the user is expressed in the form of “joy A, anger B, sorrow C, and pleasure D”, and A to D are integers on a six-grade evaluation scale ranging from 0 to 5.
Candidate 1: Are you okay? I was concerned about what happened yesterday.
Candidate 2: I was thinking about what happened yesterday. Is there anything I can do?
Candidate 3: I was worried. Would you like to talk about it?”

At this time, for example, an output of the sentence generation model is as follows:

“The emotion of the user may be as follows:
Candidate 1: joy 3, anger 1, sorrow 2, and pleasure 2
Candidate 2: joy 2, anger 1, sorrow 3, and pleasure 2
Candidate 3: joy 2, anger 1, sorrow 3, and pleasure 3”

In this manner, the robot 100 may perform deliberation processing after creating the emotion changing event.

Finally, the robot 100 may create the emotion changing event by using Candidate 1 that is most likely to make the user happy among the plurality of candidates, store the emotion changing event in the scheduled action data 2224, and prepare for the next meeting with the user 10.

As described above, even in a state of not having a conversation with a family or a friend, the emotion value of the robot is continuously determined using the information of the history data 2222 in which the impressive event data is stored, and in a case where the emotion value of the robot becomes the emotion encouraging learning, the robot 100 performs autonomous learning in a state of not having a conversation with the user 10 according to the emotion of the robot 100, and continues to update the history data 2222 and the scheduled action data 2224.

The above is an example using the emotion value. However, in the emotion map, the emotion can be generated based on the amount of hormone secreted and an event type. Therefore, values associated with the impressive event data may include the type of hormone, the amount of hormone secreted, and the event type.

Hereinafter, specific examples will be described.

For example, even in a state of not talking with the user, the robot 100 checks information regarding a topic or hobby of interest to the user.

For example, even in a state of not talking with the user, the robot 100 checks information regarding a birthday or an anniversary of the user and generates a congratulatory message.

For example, even in a state of not talking with the user, the robot 100 checks reviews for places, foods, or products that the user wants to visit or try.

For example, even in a state of not talking with the user, the robot 100 checks weather information and provides advice suitable for a schedule or plan of the user.

For example, even in a state of not talking with the user, the robot 100 checks information regarding local events and festivals and proposes the information to the user.

For example, even in a state of not talking with the user, the robot 100 checks a game result of sports and news that the user is interested in to provide a topic.

For example, even in a state of not talking with the user, the robot 100 checks and introduces information regarding favorite music or artists of the user.

For example, even in a state of not talking with the user, the robot 100 checks information regarding social problems and news that the user is interested in to provide an opinion.

For example, even in a state of not talking with the user, the robot 100 checks information regarding a hometown or a native region to provide a topic.

For example, even in a state of not talking with the user, the robot 100 checks information regarding a job or a school of the user to provide advice.

Even in a state of not talking with the user, the robot 100 checks and introduces information regarding books, comics, movies, and dramas that the user is interested in.

For example, even in a state of not talking with the user, the robot 100 checks information regarding the health of the user to provide advice.

For example, even in a state of not talking with the user, the robot 100 checks information regarding a travel plan of the user to provide advice.

For example, even in a state of not talking with the user, the robot 100 checks information regarding repair or maintenance of a house or a car of the user to provide advice.

For example, even in a state of not talking with the user, the robot 100 checks information regarding beauty and fashion that the user is interested in to provide advice.

For example, even in a state of not talking with the user, the robot 100 checks information regarding a pet of the user to provide advice.

For example, even in a state of not talking with the user, the robot 100 checks information regarding contests and events related to the hobby or the job of the user to make recommendations.

For example, even in a state of not talking with the user, the robot 100 checks information regarding a favorite restaurant or dining spot of the user to make recommendations.

For example, even in a state of not talking with the user, the robot 100 collects information regarding important decisions related to the life of the user to provide advice.

For example, even in a state of not talking with the user, the robot 100 checks information regarding a person the user is worried about to provide advice.

### Third Embodiment

In a third embodiment, a robot 100 is mounted on a stuffed toy or is applied to a control device connected wirelessly or by wire to control target equipment (speaker or camera) mounted on a stuffed toy. Portions having similar configurations to those of the second embodiment are denoted by the same reference numerals, and a description thereof is omitted.

Specifically, the third embodiment has the following configuration. For example, the robot 100 is applied to a cohabiting companion (specifically, a stuffed toy 100N shown in FIGS. 7 and 8) that has a dialogue with a user 10 based on information regarding daily life and provides information tailored to preferences of the user 10 while spending daily life with the user 10. In the third embodiment, an example in which a control portion of the robot 100 is applied to a smartphone 50 is described.

The smartphone 50 functioning as the control portion of the robot 100 is attachable to and detachable from the stuffed toy 100N having a function as an input/output device of the robot 100, and the input/output device and the housed smartphone 50 are connected inside the stuffed toy 100N.

As shown in FIG. 7(A), the stuffed toy 100N has a shape of a bear covered with a soft cloth fabric in the present embodiment (another embodiment), and a sensor unit 2200A and a control target 2252A are disposed as the input/output devices in a space portion 52 formed inside the stuffed toy 100N (see FIG. 9D). The sensor unit 2200A includes a microphone 2201 and a 2D camera 2203. Specifically, as shown in FIG. 7(B), in the space portion 52, the microphone 2201 of the sensor unit 2200 is disposed at a portion corresponding to an ear 54, the 2D camera 2203 of the sensor unit 2200 is disposed at a portion corresponding to an eye 56, and a speaker 60 forming a part of the control target 2252A is disposed at a portion corresponding to a mouth 58. The microphone 2201 and the speaker 60 are not necessarily separated from each other, and may be formed as an integrated unit. In a case where the microphone 201 and the speaker 60 are formed as the unit, it is preferable to dispose the unit at a position where an utterance can be heard naturally, such as a position of a nose of the stuffed toy 100N. Although a case where the stuffed toy 100N has an animal shape has been described as an example, the disclosure is not limited thereto. The stuffed toy 100N may have a shape of a specific character.

FIG. 9D schematically shows a functional configuration of the stuffed toy 100N. The stuffed toy 100N includes the sensor unit 2200A, a sensor module unit 2210, a storage unit 2220, a control unit 2228, and the control target 2252A.

The smartphone 50 housed in the stuffed toy 100N of the present embodiment performs processing similar to that of the robot 100 of the second embodiment. That is, the smartphone 50 has a function as the sensor module unit 2210, a function as the storage unit 2220, and a function as the control unit 2228 shown in FIG. 9D.

As shown in FIG. 8, a fastener 62 is attached to a part (for example, a back portion) of the stuffed toy 100N, and the outside and the space portion 52 communicate with each other by opening the fastener 62.

Here, the smartphone 50 is housed in the space portion 52 from the outside and is USB-connected to each input/output device via a USB hub 64 (see FIG. 7(B)), so that functions equivalent to those of the robot 100 of the second embodiment can be provided.

A non-contact power receiving plate 66 is connected to the USB hub 64. A power receiving coil 66A is incorporated in the power receiving plate 66. The power receiving plate 66 is an example of a wireless power receiving unit that receives wireless power supply.

The power receiving plate 66 is disposed near root portions 68 of both feet of the stuffed toy 100N and is positioned closest to a placement base 70 in a case where the stuffed toy 100N is placed on the placement base 70. The placement base 70 is an example of an external wireless power transmitting unit.

The stuffed toy 100N placed on the placement base 70 can be appreciated as an ornament in a natural state.

Further, the root portion is formed to have a thickness smaller than a thickness of a surface layer of the stuffed toy 100N at other portions, and is held in a state closer to the placement base 70.

The placement base 70 includes a charging pad 72. A power transmitting coil 72A is incorporated in the charging pad 72. When the power transmitting coil 72A transmits a signal to search the power receiving coil 66A of the power receiving plate 66, and the power receiving coil 66A is found, a current flows through the power transmitting coil 72A to generate a magnetic field, and the power receiving coil 66A reacts to the magnetic field to start electromagnetic induction. As a result, a current flows through the power receiving coil 66A, and power is stored in a battery (not shown) of the smartphone 50 via the USB hub 64.

That is, since the smartphone 50 is automatically charged by placing the stuffed toy 100N as an ornament on the placement base 70, it is not necessary to take out the smartphone 50 from the space portion 52 of the stuffed toy 100N for charging.

In the third embodiment, the smartphone 50 is housed in the space portion 52 of the stuffed toy 100N and connected by wire (USB connection), but the disclosure is not limited thereto. For example, a control device having a wireless function (for example, “Bluetooth (registered trademark)”) may be housed in the space portion 52 of the stuffed toy 100N, and the control device may be connected to the USB hub 64. In this case, the smartphone 50 and the control device wirelessly communicate with each other in a state in which the smartphone 50 is not inserted into the space portion 52, and the smartphone 50 positioned outside is connected to each input/output device via the control device, so that functions equivalent to those of the robot 100 of the second embodiment can be provided. Further, the control device in which the control device is housed in the space portion 52 of the stuffed toy 100N and the smartphone 50 positioned outside may be connected by wire.

Further, in the third embodiment, the bear-shaped stuffed toy 100N has been exemplified, but the shape of the stuffed toy 100N may be another animal, a doll, or a shape of a specific character. Further, clothes of the stuffed toy 100N may be able to be changed. Further, a material of an outer surface is not limited to the cloth fabric and may be other materials such as soft vinyl. It is preferable that the material of the outer surface is a soft material.

Further, a monitor may be attached to the outer surface of the stuffed toy 100N, and the control target 2252 that provides information to the user 10 through vision may be added. For example, the eye 56 may be used as the monitor to express joy, anger, sorrow, and pleasure, or a window through which a built-in monitor of the smartphone 50 is visible may be provided at a belly portion. Further, the eye 56 may be used as a projector to express joy, anger, sorrow, and pleasure by an image projected on a wall surface.

According to the third embodiment, the existing smartphone 50 is inserted into the stuffed toy 100N, and the camera 2203, the microphone 2201, the speaker 60, and the like are extended from the smartphone 50 to appropriate positions via USB connection.

Further, for wireless charging, the smartphone 50 and the power receiving plate 66 are USB-connected to each other, and the power receiving plate 66 is disposed as close to the outer side of the stuffed toy 100N as possible when viewed from the inside.

In order to use the wireless charging of the smartphone 50, the smartphone 50 needs to be positioned as close to the outer side of the stuffed toy 100N as possible when viewed from the inside, which may result in a rough tactile sensation when the stuffed toy 100N is touched from the outside.

Therefore, the smartphone 50 is disposed as close to the center of the stuffed toy 100N as possible, and a wireless charging function (power receiving plate 66) is disposed as close to the outer side of the stuffed toy 100N as possible when viewed from the inside. The camera 2203, the microphone 2201, the speaker 60, and the smartphone 50 receive wireless power supply via the power receiving plate 66.

Other configurations and effects of the stuffed toy 100N of the third embodiment are similar to those of the robot 100 of the second embodiment, and thus a description thereof is omitted.

### Fourth Embodiment

In the second embodiment, a case where an action control system is applied to a robot 100 has been exemplified, but in a fourth embodiment, a robot 100 is used as an agent for having a dialogue with a user, and an action control system is applied to an agent system. Portions having similar configurations to those of the second embodiment and the third embodiment are denoted by the same reference numerals, and a description thereof is omitted.

FIG. 9E is a functional block diagram of an agent system 2500 implemented using some or all of functions of an action control system.

The agent system 2500 is a computer system that performs a series of actions according to an intention of a user 10 through a dialogue with the user 10. The dialogue with the user 10 can be performed by voice or text.

The agent system 2500 includes a sensor unit 2200A, a sensor module unit 2210, a storage unit 2220, a control unit 2228B, and a control target 2252B.

The agent system 2500 can be mounted on, for example, a robot, a doll, a stuffed toy, a wearable terminal (a pendant, a smartwatch, or smart glasses), a smartphone, a smart speaker, an earphone, or a personal computer. Further, the agent system 2500 may be implemented in a web server and used via the web browser operating on a communication terminal such as a smartphone possessed by the user.

The agent system 2500 serves as, for example, a butler, a secretary, a teacher, a partner, a friend, a lover, or a teacher, who performs an action for the user 10. The agent system 2500 not only has a dialogue with the user 10 but also provides advice, guides to a destination, makes recommendations according to a preference of the user, or the like. In addition, the agent system 2500 makes reservations, places orders, makes payments, or the like with a service provider.

As in the second embodiment, an emotion determination unit 2232 determines an emotion of the user 10 and an emotion of the agent. An action determination unit 2236 determines an action of the robot 100 in consideration of the emotions of the user 10 and the agent. In other words, the agent system 2500 understands the emotion of the user 10 and reads a context to implement heartfelt support, assistance, advice, and service provision. Further, the agent system 2500 listens to concerns of the user 10 and comforts, encourages, and cheers up the user. Further, the agent system 2500 plays with the user 10 and draws a picture diary to remind the user of the past. The agent system 2500 performs an action that enables enhancement of a sense of happiness of the user 10. Here, the agent is an agent that operates on software.

The control unit 2228B includes a state recognition unit 2230, the emotion determination unit 2232, an action recognition unit 2234, the action determination unit 2236, a storage control unit 2238, an action control unit 2250, a related information collection unit 2270, a command acquisition unit 2272, a robotic process automation (RPA) 2274, a character setting unit 2276, and a communication processing unit 2280.

As in the second embodiment, the action determination unit 2236 determines an utterance content of the agent for having a dialogue with the user 10 as an action of the agent. The action control unit 2250 outputs the utterance content of the agent by at least one of voice and text through a speaker or a display serving as the control target 2252B.

The character setting unit 2276 sets a character of the agent in a case where the agent system 2500 has a dialogue with the user 10 based on designation from the user 10. In other words, the utterance content output from the action determination unit 2236 is output through the agent having the set character. As the character, for example, a real-life celebrity or famous person such as an actor, an entertainer, an idol, or an athlete can be set. Further, a fictitious character appearing in a cartoon, a movie, or an animation can also be set as the character. For example, “Princess Ann” played by “Audrey Hepburn” in the film “Roman Holiday” can be set as the character of the agent. In a case where the character of the agent is known, since a voice, manner of speech, tone, and personality of the character are known, prompt setting in the character setting unit 2276 is automatically performed only by the user 10 designating a favorite character of the user 10. The voice, manner of speech, tone, and personality of the set character are reflected in a dialogue with the user 10. In other words, the action control unit 2250 synthesizes a voice corresponding to the character set by the character setting unit 2276, and outputs the utterance content of the agent using the synthesized voice. As a result, the user 10 can feel as if the user 10 is having a dialogue with a favorite character (such as a favorite actor) of the user 10.

In a case where the agent system 2500 is mounted on a device including a display such as a smartphone, for example, an icon, a still image, or a moving image of the agent having the character set by the character setting unit 2276 may be displayed on the display. An image of the agent is generated using, for example, an image composition technology such as 3D rendering. In the agent system 2500, a dialogue with the user 10 may be carried out while the image of the agent makes a gesture corresponding to the emotion of the user 10, the emotion of the agent, and the utterance content of the agent. The agent system 2500 may output only voice without outputting the image when having a dialogue with the user 10.

As in the second embodiment, the emotion determination unit 2232 determines an emotion value indicating the emotion of the user 10 and an emotion value of the agent. In the present embodiment, the emotion value of the agent is determined instead of an emotion value of the robot 100. The emotion value of the agent is reflected in a set emotion of the character. In a case where the agent system 2500 has a dialogue with the user 10, not only the emotion of the user 10 but also the emotion of the agent is reflected in the dialogue. In other words, the action control unit 2250 outputs the utterance content in an aspect corresponding to the emotion determined by the emotion determination unit 2232.

Further, the emotion of the agent is also reflected in a case where the agent system 2500 performs an action for the user 10. For example, in a case where the user 10 requests the agent system 2500 to take a picture, whether or not the agent system 2500 takes a picture in response to the request of the user is determined according to a level of an emotion of “sadness” of the agent. In a case where the character has a positive emotion, the character has a favorable dialogue with or performs a favorable action for the user 10, and in a case where the character has a negative emotion, the character has an oppositional dialogue with or performs an oppositional action for the user 10.

History data 2222 stores a history of a dialogue performed between the user 10 and the agent system 2500 as event data. The storage unit 2220 may be implemented by an external cloud storage. In the case of having a dialogue with the user 10 or performing an action for the user 10, the agent system 2500 determines a dialogue content or an action content in consideration of a content of the dialogue history stored in the history data 2222. For example, the agent system 2500 grasps a hobby and the preference of the user 10 based on the dialogue history stored in the history data 2222. The agent system 2500 generates the dialogue content matching the hobby and the preference of the user 10 and makes recommendations. The action determination unit 2236 determines the utterance content of the agent based on the dialogue history stored in the history data 2222. In the history data 2222, personal information such as a name, an address, a telephone number, and a credit card number of the user 10 acquired through a dialogue with the user 10 is stored. Here, the agent may spontaneously make an utterance for asking the user 10 about whether or not to register personal information, such as “Would you like to register your credit card number?”, and may store the personal information in the history data 2222 according to an answer of the user 10.

As described in the second embodiment, the action determination unit 2236 generates the utterance content based on a sentence generated using a sentence generation model. Specifically, the action determination unit 2236 generates the utterance content of the agent by inputting, to the sentence generation model, a text or speech input by the user 10 and the emotions of both the user 10 and the character determined by the emotion determination unit 2232 and the conversation history stored in the history data 2222. At this time, the action determination unit 2236 may generate the utterance content of the agent by further inputting the personality of the character set by the character setting unit 2276 to the sentence generation model. In the agent system 2500, the sentence generation model is not positioned on a front-end side serving as a touchpoint with the user 10, but is used as a tool of the agent system 2500.

The command acquisition unit 2272 acquires, by using an output of the utterance understanding unit 2212, a command of the agent from a speech or a text uttered by the user 10 through a dialogue with the user 10. The command includes, for example, a content of an action to be performed by the agent system 2500, such as information search, restaurant reservation, ticket arrangement, purchase of products or services, payment, route guidance to a destination, or recommendation provision.

The RPA 2274 performs an action according to the command acquired by the command acquisition unit 2272. For example, the RPA 2274 performs an action related to use of a service provider, such as information search, restaurant reservation, ticket arrangement, purchase of products or services, or payment.

The RPA 2274 reads the personal information of the user 10, which is necessary for performing the action related to the use of the service provider, from the history data 2222 and uses the personal information. For example, in the case of purchasing a product in response to a request from the user 10, the agent system 2500 reads and uses the personal information such as the name, the address, the telephone number, and the credit card number of the user 10 stored in the history data 2222. It is unkind to request the user 10 to input the personal information in initial setting, which is also uncomfortable for the user. In the agent system 2500 according to the present embodiment, the personal information acquired through a dialogue with the user 10 is stored, and read and used if necessary, instead of requesting the user 10 to input the personal information in the initial setting. As a result, it is possible to avoid making the user feel discomfort, and convenience of the user is improved.

The agent system 2500 performs dialogue processing according to, for example, following steps 1 to 6.
(Step 1) The agent system 2500 sets the character of the agent. Specifically, the character setting unit 2276 sets the character of the agent in a case where the agent system 2500 has a dialogue with the user 10 based on designation from the user 10.
(Step 2) The agent system 2500 acquires a state of the user 10 including a speech or a text input from the user 10, the emotion value of the user 10, the emotion value of the agent, and the history data 2222. Specifically, processing similar to steps S100 to S103 is performed to acquire the state of the user 10 including the speech or the text input from the user 10, the emotion value of the user 10, the emotion value of the agent, and the history data 2222.
(Step 3) The agent system 2500 determines the utterance content of the agent.

Specifically, the action determination unit 2236 generates the utterance content of the agent by inputting, to the sentence generation model, the text or speech input by the user 10 and the emotions of both the user 10 and the character specified by the emotion determination unit 2232 and the conversation history stored in the history data 2222.

For example, the text or speech input by the user 10 and a text representing the emotions of both the user 10 and the character specified by the emotion determination unit 2232 and the conversation history stored in the history data 2222 are added with a fixed sentence “How would the agent respond in this situation?” and are then input to the sentence generation model to acquire the utterance content of the agent.

As an example, in a case where the text or speech input to the user 10 is “Please reserve a nice Chinese restaurant nearby for 7 o'clock tonight”, as the utterance content of the agent, “Certainly” and “Here are some recommended restaurants: 1.AAAA. 2.BBBB. 3.CCCC. 4. DDDD” are acquired.

Further, in a case where the text or speech input to the user 10 is “I'd like the fourth one, DDDD”, as the utterance content of the agent, “Certainly. I'll try to make a reservation. How many seats do you need?” is obtained.
(Step 4) The agent system 2500 outputs the utterance content of the agent.

Specifically, the action control unit 2250 synthesizes a voice corresponding to the character set by the character setting unit 2276, and outputs the utterance content of the agent using the synthesized voice.
(Step 5) The agent system 2500 determines whether or not it is a timing to execute the command of the agent.

Specifically, the action determination unit 2236 determines whether or not it is a timing to execute the command of the agent based on an output of the sentence generation model. For example, in a case where the output of the sentence generation model indicates that the agent executes the command, it is determined that it is a timing to execute the command of the agent, and the processing proceeds to step 6. On the other hand, in a case where it is determined that it is not a timing to execute the command of the agent, the processing returns to step 2 described above.
(Step 6) The agent system 2500 executes the command of the agent.

Specifically, the command acquisition unit 2272 acquires the command of the agent from the speech or text uttered by the user 10 through a dialogue with the user 10. Then, the RPA 2274 performs an action corresponding to the command acquired by the command acquisition unit 2272. For example, in a case where the command is “information search”, information search is performed by a search site using a search query obtained through a dialogue with the user 10 and an application programming interface (API). The action determination unit 2236 inputs a search result to the sentence generation model and generates the utterance content of the agent. The action control unit 2250 synthesizes a voice corresponding to the character set by the character setting unit 2276, and outputs the utterance content of the agent using the synthesized voice.

Further, in a case where the command is “restaurant reservation”, a reservation is made by making a phone call to a restaurant to be reserved through telephony software by using reservation information obtained through a conversation with the user 10, restaurant information of the restaurant to be reserved, and the API. At this time, the action determination unit 2236 acquires the utterance content of the agent for a speech input from a counterpart by using the sentence generation model having a dialogue function. Then, the action determination unit 2236 inputs a result of the restaurant reservation (whether or not the reservation is successful) to the sentence generation model, and generates the utterance content of the agent. The action control unit 2250 synthesizes a voice corresponding to the character set by the character setting unit 2276, and outputs the utterance content of the agent using the synthesized voice.

Then, the processing returns to step 2 described above.

In step 6, a result of an action (for example, restaurant reservation) performed by the agent is also stored in the history data 2222. The result of the action performed by the agent stored in the history data 2222 is utilized by the agent system 2500 to grasp the hobby or the preference of the user 10. For example, in a case where the same restaurant is reserved a plurality of times, it may be recognized that the user 10 favors the restaurant, and a content of a reservation such as a reserved time slot, a course content, or a price may be used as criteria for selecting a restaurant at the time of the next reservation.

In this manner, the agent system 2500 can perform the dialogue processing and perform the action related to use of the service provider if necessary.

FIGS. 9F and 9G are diagrams showing an example of an operation of the agent system 2500. FIG. 9F shows an aspect in which the agent system 2500 makes a restaurant reservation through a dialogue with the user 10. In FIG. 9F, the utterance content of the agent is shown on the left side, and the utterance content of the user 10 is shown on the right side. The agent system 2500 can grasp the preference of the user 10 based on the history of the dialogue with the user 10, provide a list of recommended restaurants that match the preference of the user 10, and make a reservation of a selected restaurant.

On the other hand, FIG. 9G shows an aspect in which the agent system 2500 accesses a mail-order site through a dialogue with the user 10 to purchase a product. In FIG. 9G, the utterance content of the agent is shown on the left side, and the utterance content of the user 10 is shown on the right side. The agent system 2500 can estimate the remaining amount of beverage the user has in stock based on the history of the dialogue with the user 10, suggest purchasing the beverage to the user 10, and carry out the purchase. Further, the agent system 2500 can grasp the preference of the user based on the history of the past dialogue with the user 10, and recommend a snack that the user likes. In this manner, the agent system 2500 supports, as the agent such as a butler, the daily life of the user 10 by performing various actions such as restaurant reservation or product purchase payment while communicating with the user 10.

Other configurations and effects of the agent system 2500 of the fourth embodiment are similar to those of the robot 100 of the second embodiment, and thus a description thereof is omitted.

### Fifth Embodiment

In a fifth embodiment, the above-described agent system is applied to smart glasses. Portions having similar configurations to those of the first to fourth embodiments are denoted by the same reference numerals, and a description thereof is omitted.

FIG. 9H is a functional block diagram of an agent system 2700 implemented using some or all of functions of an action control system.

As shown in FIG. 9I, smart glasses 2720 are a glasses-type smart devices and are worn by a user 10 similarly to regular glasses. The smart glasses 2720 are an example of electronic equipment and a wearable terminal.

The smart glasses 2720 include the agent system 2700. A display included in a control target 2252B displays various types of information for the user 10. The display is, for example, a liquid crystal display. The display is provided, for example, at a lens portion of the smart glasses 2720, and a display content can be visually recognized by the user 10. A speaker included in the control target 2252B outputs a speech representing various types of information to the user 10.

The smart glasses 2720 include a touch panel (not shown), and the touch panel receives an input from the user 10.

An acceleration sensor 2206, a temperature sensor 2207, and a heart rate sensor 2208 of a sensor unit 2200B detect a state of the user 10. The sensors are merely examples, and it is a matter of course that other sensors may be mounted in order to detect the state of the user 10.

A microphone 2201 acquires a speech uttered by the user 10 or an environmental sound around the smart glasses 2720. A 2D camera 2203 can image the surroundings of the smart glasses 2720. The 2D camera 2203 is, for example, a CCD camera.

A sensor module unit 2210B includes a speech emotion recognition unit 2211 and an utterance understanding unit 2212. A communication processing unit 2280 of a control unit 2228B controls communication between the smart glasses 2720 and the outside.

FIG. 9I is a diagram showing an example of a usage aspect of the agent system 2700 in the smart glasses 2720. The smart glasses 2720 implement provision of various services to the user 10 using the agent system 2700. For example, in a case where the smart glasses 2720 are operated by the user 10 (for example, the user 10 inputs a speech to the microphone or taps the touch panel with a finger), the smart glasses 2720 start to use the agent system 2700. Here, using the agent system 2700 includes an aspect in which the smart glasses 2720 include and use the agent system 2700, and further includes an aspect in which a part (for example, the sensor module unit 2210B, a storage unit 2220, and the control unit 2228B) of the agent system 2700 is provided outside the smart glasses 2720 (for example, a server), and the smart glasses 2720 communicate with the outside to use the agent system 2700.

In a case where the user 10 operates the smart glasses 2720, a touchpoint is established between the agent system 2700 and the user 10. That is, service provision by the agent system 2700 is started. As described in the fourth embodiment, in the agent system 2700, a character (for example, a character of Audrey Hepburn) of an agent is set by a character setting unit 2276.

An emotion determination unit 2232 determines an emotion value indicating an emotion of the user 10 and an emotion value of the agent. Here, the emotion value indicating the emotion of the user 10 is estimated from various sensors included in the sensor unit 2200B mounted on the smart glasses 2720. For example, in a case where a heart rate of the user 10 detected by the heart rate sensor 2208 is elevated, the emotion value of “anxiety”, “fear”, or the like is estimated to be large.

Further, for example, in a case where a body temperature of the user exceeds an average body temperature as a result of measuring the body temperature using the temperature sensor 2207, the emotion value of “pain”, “suffering”, or the like is estimated to be large. Further, for example, in a case where it is detected by the acceleration sensor 2206 that the user 10 is performing any kind of sport, the emotion value of “pleasure” or the like is estimated to be large.

Further, for example, the emotion value of the user 10 may be estimated from a speech or utterance content of the user 10 acquired by the microphone 2201 mounted on the smart glasses 2720. For example, in a case where the user 10 is raising his/her voice, the emotion value of “anger” or the like is estimated to be large.

In a case where the emotion value estimated by the emotion determination unit 2232 is larger than a predetermined value, the agent system 2700 causes the smart glasses 2720 to acquire information regarding a surrounding situation. Specifically, for example, the 2D camera 2203 is caused to capture an image or a moving image indicating the surrounding situation (for example, a person or an object) of the user 10. Further, the microphone 2201 is caused to record ambient environmental sound. Examples of other information regarding the surrounding situation include a date, a time, location information, and information indicating weather. The information regarding the surrounding situation is stored in history data 2222 together with the emotion value. The history data 2222 may be implemented by an external cloud storage. As described above, the surrounding situation obtained by the smart glasses 2720 is stored in the history data 2222 as a so-called life log in a state of being associated with the emotion value of the user 10 at that time.

In the agent system 2700, information indicating the surrounding situation is stored in the history data 2222 in association with the emotion value. As a result, the agent system 2700 grasps personal information such as a hobby, a preference, or a personality of the user 10. For example, in a case where an image indicating a scene of watching baseball is associated with the emotion value of “happy” or “pleasure”, the agent system 2700 grasps the fact that the hobby of the user 10 is watching baseball and grasps a favorite team or player of the user 10 from the information stored in the history data 2222.

Then, in the case of having a dialogue with the user 10 or performing an action for the user 10, the agent system 2700 determines a dialogue content or an action content in consideration of a content of the surrounding situation stored in the history data 2222. It is a matter of course that the dialogue content or the action content may be determined in consideration of a dialogue history stored in the history data 2222 as described above in addition to the surrounding situation.

As described above, an action determination unit 2236 generates an utterance content based on a sentence generated by a sentence generation model. Specifically, the action determination unit 2236 generates the utterance content of the agent by inputting, to the sentence generation model, a text or speech input by the user 10, the emotions of both the user 10 and the agent determined by the emotion determination unit 2232, the conversation history stored in the history data 2222, a personality of the agent, and the like. Further, the action determination unit 2236 generates the utterance content of the agent by inputting the surrounding situation stored in the history data 2222 to the sentence generation model.

The generated utterance content is output by voice from the speaker mounted on the smart glasses 2720 to the user 10, for example. In this case, a synthesized voice corresponding to the character of the agent is used as the voice. An action control unit 2250 generates the synthesized voice by reproducing a voice style of the character (for example, Audrey Hepburn) of the agent, and generates the synthesized voice corresponding to the emotion of the character (for example, a voice with a forcible tone in a case where the emotion is “anger”). Further, the utterance content may be displayed on the display instead of or together with the voice output.

An RPA 2274 performs an operation according to a command (for example, a command of the agent acquired from a speech or text uttered by the user 10 through a dialogue with the user 10). For example, the RPA 2274 performs an action related to use of a service provider, such as information search, restaurant reservation, ticket arrangement, purchase of products or services, payment, route guidance, or translation.

Further, as another example, the RPA 2274 performs an operation of transmitting a content input by voice from the user 10 (for example, a child) through a dialogue with the agent to a counterpart (for example, parents). Examples of transmission means include message application software, chat application software, and mail application software.

In a case where the operation is performed by the RPA 2274, for example, a speech indicating that the operation is finished is output from the speaker mounted on the smart glasses 2720. For example, a speech such as “The reservation of the restaurant is completed” is output to the user 10. Further, for example, in a case where the restaurant is fully booked, a speech such as “The reservation could not be made. What would you like to do?” is output to the user 10.

As described above, the smart glasses 2720 use the agent system 2700 to provide various services to the user 10. In addition, since the smart glasses 2720 are worn by the user 10, the agent system 2700 can be used in various scenes such as at home, at work, and at a place outside the house.

In addition, since the smart glasses 2720 are worn by the user 10, the smart glasses 2720 are suitable for collecting the so-called life log of the user 10. Specifically, the emotion value of the user 10 is estimated based on detection results of various sensors or the like mounted on the smart glasses 2720 or recording results of the 2D camera 2203 or the like. Therefore, the emotion value of the user 10 can be collected in various scenes, and the agent system 2700 can provide a service or utterance content appropriate for the emotion of the user 10.

Further, in the smart glasses 2720, the surrounding situation of the user 10 can be obtained by the 2D camera 2203, the microphone 2201, and the like. Then, the surrounding situation and the emotion value of the user 10 are associated with each other. As a result, it is possible to estimate what kind of emotion the user 10 has in what kind of situation. As a result, accuracy in a case where the agent system 2700 grasps the hobby and the preference of the user 10 can be improved. Then, as the agent system 2700 accurately grasps the hobby and the preference of the user 10, the agent system 2700 can provide a service or an utterance content appropriate for the hobby and the preference of the user 10.

Further, the agent system 2700 can also be applied to other wearable terminals (electronic equipment that can be worn on the body of the user 10, such as a pendant, a smart watch, an earring, a bracelet, or a hairband). In a case where the agent system 2700 is applied to a smart pendant, a speaker serving as the control target 2252B outputs a speech representing various types of information to the user 10. The speaker is, for example, a speaker capable of outputting a sound having directionality. The speaker is set to have directionality toward the ear of the user 10. As a result, the sound is suppressed from reaching a person other than the user 10. The microphone 2201 acquires a speech uttered by the user 10 or an environmental sound around the smart pendant. The smart pendant is worn so as to be suspended from the neck of the user 10. Therefore, the smart pendant is positioned relatively close to the mouth of the user 10 while being worn. As a result, acquisition of a speech uttered by user 10 is facilitated.

In the above embodiment, a case where the robot 100 recognizes the user 10 by using a face image of the user 10 has been described, but the disclosed technology is not limited to such an aspect. For example, the robot 100 may recognize the user 10 by using a voice uttered by the user 10, a mail address of the user 10, an ID of a social network service (SNS) of the user 10, an ID card in which a wireless IC tag is embedded and which is possessed by the user 10, or the like.

The robot 100 is an example of electronic equipment including the action control system. An application target of the action control system is not limited to the robot 100, and the action control system can be applied to various types of electronic equipment. Further, functions of a server 300 may be implemented by one or more computers. At least some functions of the server 300 may be implemented by a virtual machine. Further, at least some functions of the server 300 may be implemented on a cloud.

FIG. 4 schematically shows an example of a hardware configuration of a computer 1200 that functions as the smartphone 50, the robot 100, the server 300, and the agent systems 2500 and 2700.

### Sixth Embodiment

Next, processing performed by the action determination unit 2236 in a case where the robot 100 performs autonomous processing of autonomously performing an action will be described.

In the autonomous processing in the present embodiment, the robot 100 serving as an agent spontaneously and periodically stores, in history data 2222, information based on an emotion of a user 10 for an item provided by a provider. Furthermore, the robot 100 spontaneously and periodically notifies the provider of the information based on the emotion of the user 10 for the item provided by the provider.

Here, the “provider” means an individual or organization that provides a product, a service, or the like to the user 10. The “organization” is, for example, an administrative organization, a commercial organization, or a non-profit organization. The “administrative organization” is an organization that carries out administration, such as a national government, a prefectural government, or a municipal government. The “commercial organization” is an organization for profit, such as a commercial company or a commercial corporation. The “non-profit organization” is an organization that is not intended for profit, such as a non-profit association or a non-profit corporation.

Furthermore, the “information based on the emotion of the user 10 for the item provided by the provider” is information indicating an impression of the user 10 for the item provided by the provider, and may be, for example, information regarding a type of emotion of the user 10 such as “happy”, “pleasant”, “satisfied”, “not happy”, “not pleasant”, or “dissatisfied”, or may be the above-described emotion value derived based on the emotion of the user 10.

Furthermore, “notifying the provider” means that the information based on the emotion of the user 10 can be confirmed by the provider. For example, the information may be transmitted to the provider by an e-mail, or the information may be uploaded to a cloud such that the provider can confirm the information.

That is, the robot 100 can feed back an impression of the user for a policy or service provided by a city to the city, or feed back an impression of the user for a product or service provided by a company to the company.

The action determination unit 2236 determines, as the action of the robot 100, any one of a plurality of types of robot actions including doing nothing, by using at least one of the state of the user 10, the emotion of the user 10, the emotion of the robot 100, and the state of the robot 100, and the action determination model 2221 at a predetermined timing. Here, a case where the sentence generation model having a dialogue function is used as the action determination model 2221 will be described as an example.

Specifically, the action determination unit 2236 inputs a text representing at least one of the state of the user 10, the emotion of the user 10, the emotion of the robot 100, and the state of the robot 100 and a text for inquiry about the robot action to the sentence generation model, and determines the action of the robot 100 based on an output of the sentence generation model.

For example, the plurality of types of robot actions include the following actions (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot notifies a provider of information based on an emotion of the user for an item provided by the provider.

In other words, in a case where the action determination unit 2236 determines, as the robot action, feeding back of the impression of the user to the provider, that is, the action “(11) The robot notifies a provider of information based on an emotion of the user for an item provided by the provider”, the action determination unit 2236 selects event data related to the item provided by the provider from the history data 2222. At this time, the emotion determination unit 2232 determines the emotion of the user based on the selected event data. Furthermore, the action determination unit 2236 notifies the provider of the information based on the emotion of the user for the item provided by the provider based on the emotion of the user determined by the emotion determination unit 2232.

For example, the robot 100 installed in homes, public facilities, or the like detects, as the emotion of the user for the item provided by the provider, whether or not the user is satisfied with a policy of a region, whether or not the user is satisfied with a product being used, whether or not the user is satisfied with a relationship with neighborhood residents, whether or not the user is satisfied with a relationship within the household, or the like, and stores the emotion in the history data 2222. Further, for example, the robot 100 can feed back an impression of the user for a policy or service provided by a city to the city, or feed back an impression of the user for a product or service provided by a company to the company.

Furthermore, in a case where there are many negative emotions for the item provided by the provider, the robot 100 itself may spontaneously perform an action for reducing the negative emotions in order to reduce the negative emotions. In this case, it is preferable that the robot 100 itself spontaneously performs an action for minimizing the negative emotions.

For example, in a case where the user is dissatisfied with a product provided by a certain company, the robot 100 may teach how to use the product or may introduce an interesting utilization method. Furthermore, in a case where a plurality of different users are dissatisfied with a policy of a city, the robot 100 may identify a cause of the dissatisfaction (for example, there are few parks or there are few nursery schools), and notify a mayor or a staff of a city hall of the cause to prompt implementation of improvement measures. As a result, a system for maximizing social well-being can be implemented. For example, when dissatisfaction is increasing in a certain region, it becomes possible to take some measures for residents in the region.

### Seventh Embodiment

Next, processing performed by the action determination unit 2236 in a case where the robot 100 performs autonomous processing of autonomously performing an action will be described.

In the autonomous processing in the present embodiment, the robot 100 serving as an agent spontaneously and periodically detects a state of a user 10. A conversation on a telephone between the user 10 and a counterpart (conversation partner) or a video or conversation on an intercom is constantly detected, and a content thereof is grasped. Furthermore, the robot 100 reads a conversation content and an emotion of the conversation partner, and stores conversation contents and voiceprints of a family member and a friend as being safe. Furthermore, the robot 100 may cause a sentence generation model such as ChatGPT to read a sentence of a conversation to determine whether or not the conversation is a conversation with a high risk such as an “It's me” fraud.

Next, when there is a phone call or a visitor or during a conversation, in a case where a safety value based on the voiceprint, voice style, and conversation content stored as being safe exceeds a certain value, the robot 100 determines that there is a risk of fraud. Furthermore, the robot 100 may spontaneously collect and accumulate past fraud cases from a website or news and store similar patterns. In a case where the robot 100 determines that the risk is high, the robot 100 spontaneously notifies an elderly person himself/herself, a family member, or an emergency contact of the risk. In a case where the risk is particularly high, the robot 100 immediately reports to the police. Furthermore, since the robot 100 can constantly collect information regarding recent news and social trends, the robot 100 grasps what kind of fraud is currently prevalent, estimates how to provide cautions, and spontaneously talks to the user.

The action determination unit 2236 determines, as the action of the robot 100, any one of a plurality of types of robot actions including doing nothing, by using at least one of the state of the user 10, the emotion of the user 10, the emotion of the robot 100, and the state of the robot 100, and the action determination model 2221 at a predetermined timing. Here, a case where the sentence generation model having a dialogue function is used as the action determination model 2221 will be described as an example.

Specifically, the action determination unit 2236 inputs a text representing at least one of the state of the user 10, the emotion of the user 10, the emotion of the robot 100, and the state of the robot 100 and a text for inquiry about the robot action to the sentence generation model, and determines the action of the robot 100 based on an output of the sentence generation model.

For example, the plurality of types of robot actions include the following actions (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot provides advice on a fraud risk to the user.

In a case where the action determination unit 2236 determines, as the robot action, provision of advice on a fraud risk to the user, that is, the action “(11) The robot provides advice on a fraud risk to the user”, the robot 100 acquires a conversation content between the user 10 and a conversation partner and a voiceprint. Specifically, an utterance understanding unit 2212 analyzes a speech of the user 10 and a speech of the conversation partner, which are detected by a microphone 2201, to acquire the conversation content between the user 10 and the conversation partner and the voiceprint. Next, the robot 100 acquires an emotion value of the conversation partner. Specifically, the speech of the conversation partner from a telephone and an intercom and a video of the conversation partner shown on a screen of the intercom are acquired, and the emotion value of the conversation partner is acquired. In addition, the robot 100 stores the conversation content between the user 10 and the conversation partner, the video on the intercom, and the like in history data 2222. Next, the robot 100 determines the fraud risk based on the conversation content and the emotion value of the conversation partner. Specifically, the action determination unit 2236 determines a safety value, which is a similarity between the conversation content and a fraud case, by comparing data of the past fraud case stored in a storage unit 2220 with the conversation content. The action determination unit 2236 may determine the similarity between the conversation content and the fraud case by causing the sentence generation model such as ChatGPT to read the sentence of the conversation. Then, the action determination unit 2236 determines the safety value, which is the degree of fraud risk, based on the similarity between the conversation content and the fraud case and the emotion value, voiceprint, and voice style of the conversation partner. As an example, in a case where the similarity between the conversation content and the fraud case is high, the action determination unit 2236 determines that the safety value is large regardless of the emotion value, the voiceprint, and the voice style of the conversation partner. Furthermore, in a case where an emotion value of “anxiety” or “excitement” of the conversation partner is high and in the case of some voiceprints and some voice styles, the action determination unit 2236 determines that the safety value is large even in a case where the similarity between the conversation content and the fraud case is not so high. Next, the action determination unit 2236 determines an action according to the determined degree of fraud risk. Specifically, in a case where the determined safety value exceeds a predetermined threshold, the action determination unit 2236 determines to perform an action of notifying that the fraud risk is high. For example, the action determination unit 2236 may determine to perform an action of notifying the user 10 that the fraud risk is high. Furthermore, the action determination unit 2236 may determine an action of notifying a family member or an emergency contact of the user 10 that the fraud risk is high. Furthermore, the action determination unit 2236 may determine an action of immediately reporting to the police that the fraud risk is high. Such actions may be appropriately determined according to the degree of fraud risk. Then, the action control unit 2250 controls a speaker that is control target equipment such that the notification matter is output as a speech from the speaker. For the action “(11) The robot provides advice on a fraud risk to the user”, a related information collection unit 2270 may spontaneously collect and accumulate the past fraud cases from a website or news and store the past fraud cases in collected data 2223. As a result, since the robot 100 can constantly collect information regarding recent news and social trends, the robot 100 can grasp what kind of fraud is currently prevalent, estimate how to provide cautions, and spontaneously talk to the user.

### Eighth Embodiment

Next, processing performed by the action determination unit 2236 in a case where the robot 100 performs autonomous processing of autonomously performing an action will be described.

In the autonomous processing in the present embodiment, the robot 100 serving as an agent spontaneously and periodically detects a state of a user. The robot 100 constantly monitors a content of a conversation of the user on a telephone, with a friend, or at work, and detects involvement in “bullying”, “crime”, “harassment”, or the like. In other words, the robot 100 constantly monitors the content of the conversation of the user on a telephone, with a friend, or at work, and detects a risk approaching the user. The robot 100 causes a sentence generation model such as ChatGPT to determine whether or not the conversation is a conversation with a high probability of bullying, a crime, or the like, and the robot 100 spontaneously contacts a notification destination registered in advance, sends an e-mail, or the like in a case where a conversation suspected of occurrence of a corresponding incident has occurred from an acquired content of the conversation. In addition, the robot 100 describes a conversation log of a corresponding portion, an assumed incident, a probability of occurrence, and a proposal for a solution and makes a contact. The robot 100 feeds back whether or not a corresponding event has occurred, a resolution status, and the like, so that it is possible to improve accuracy of detection of the corresponding event and a proposal of a solution.

The action determination unit 2236 determines, as the action of the robot 100, any one of a plurality of types of robot actions including doing nothing, by using at least one of the state of the user 10, the emotion of the user 10, the emotion of the robot 100, and the state of the robot 100, and the action determination model 2221 at a predetermined timing. Here, a case where the sentence generation model having a dialogue function is used as the action determination model 2221 will be described as an example.

Specifically, the action determination unit 2236 inputs a text representing at least one of the state of the user 10, the emotion of the user 10, the emotion of the robot 100, and the state of the robot 100 and a text for inquiry about the robot action to the sentence generation model, and determines the action of the robot 100 based on an output of the sentence generation model. For example, the plurality of types of robot actions include the following actions (1) to (11).
(1) The robot does nothing.
(2) The robot dreams.
(3) The robot speaks to the user.
(4) The robot creates a picture diary.
(5) The robot proposes an activity.
(6) The robot proposes a person the user should meet.
(7) The robot introduces news that the user is interested in.
(8) The robot edits pictures and moving images.
(9) The robot studies with the user.
(10) The robot recalls memory.
(11) The robot provides advice on a risk of “bullying”, “crime”, “harassment”, or the like to the user.

In a case where the action determination unit 2236 determines, as the robot action, provision of advice on a risk of “bullying”, “crime”, “harassment”, or the like to the user, that is, the action “(11) The robot provides advice on a risk of “bullying”, “crime”, “harassment”, or the like to the user”, the robot 100 acquires a conversation content of a plurality of users 10. Specifically, an utterance understanding unit 2212 analyzes speeches of the plurality of users 10 detected by a microphone 2201, and outputs text information indicating the conversation content of the plurality of users 10. Further, the robot 100 acquires emotion values of the plurality of users 10. Specifically, speeches of the plurality of users 10 and videos of the plurality of users 10 are acquired, and the emotion values of the plurality of users 10 are acquired. Further, the robot 100 determines whether or not a specific incident such as “bullying”, “crime”, or “harassment” has occurred based on the conversation content of the plurality of users 10 and the emotion values of the plurality of users 10. Specifically, the action determination unit 2236 determines a similarity between the conversation content and the specific incident by comparing data of the past specific incident such as “bullying”, “crime”, or “harassment” stored in a storage unit 2220 with the conversation content of the plurality of users 10. The action determination unit 2236 may read a sentence of a conversation into the sentence generation model such as ChatGPT to determine whether the conversation is a conversation with a high probability of bullying, a crime, or the like. Then, the action determination unit 2236 determines the degree of likelihood that the specific incident has occurred based on the similarity between the conversation content and the specific incident and the emotion values of the plurality of users 10. As an example, in a case where the similarity between the conversation content and the specific incident is high and emotion values of “anger”, “sorrow”, “discomfort”, “anxiety”, “sadness”, “worry”, and “sense of emptiness” of the plurality of users 10 are large, the action determination unit 2236 determines that the degree of likelihood that the specific incident has occurred is high. Further, the robot 100 determines an action according to the degree of likelihood that the specific incident has occurred. Specifically, in a case where the degree of likelihood that the specific incident has occurred exceeds a predetermined threshold, the action determination unit 2236 determines an action of notifying that the degree of likelihood that the specific incident has occurred is high. For example, the action determination unit 2236 may determine to notify, by an e-mail, an administrator of an organization to which the plurality of users 10 belong that the degree of likelihood that the specific incident has occurred is high. Then, the robot 100 performs the determined action. As an example, the robot 100 transmits the above e-mail to the administrator of the organization to which the user 10 belongs. In the e-mail, a conversation log of a portion corresponding to the specific incident, an assumed incident, a probability of occurrence of the incident, a proposal for a solution for the incident, and the like may be described. In addition, the robot 100 stores a result of the performed action in the storage unit 2220. Specifically, a storage control unit 2238 stores, in the history data 2222, whether or not the specific incident has occurred, a resolution status, and the like. In this way, by feeding back whether or not the specific incident has occurred, the resolution status, and the like, it is possible to improve accuracy of detection of the specific incident and improve a proposal of a solution. For the action “(11) The robot provides advice on a risk of “bullying”, “crime”, “harassment”, or the like to the user”, the storage control unit 2238 periodically detects a content of a conversation of a plurality of users on a telephone or at work as the state of the user, and stores the content in the history data 2222.

### Ninth Embodiment

### [1. Notification Device]

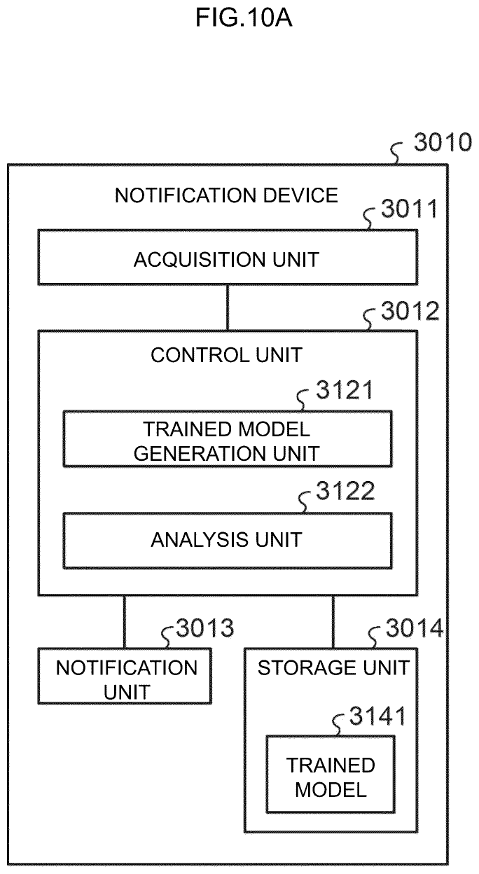

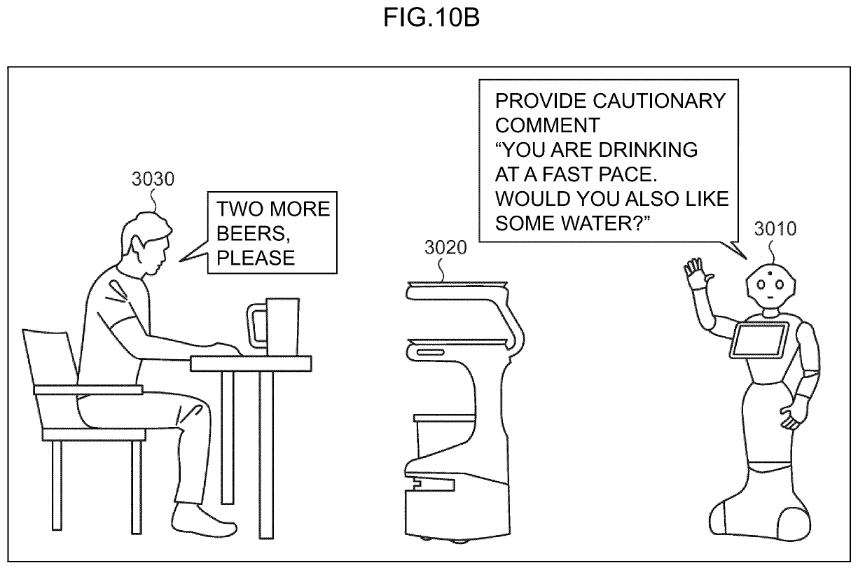

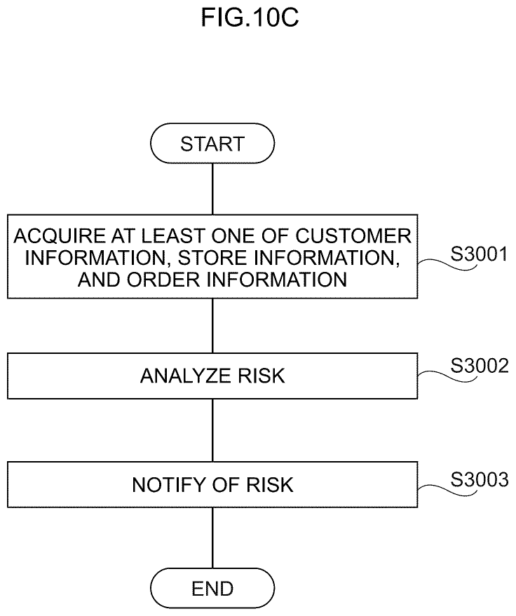

An example of a notification device 3010 according to an embodiment will be described with reference to FIG. 10A. FIG. 10A is a block diagram showing an example of a configuration of the notification device 3010. The notification device 3010 notifies of a risk or the like. The notification device 3010 is implemented by, for example, a humanoid robot of an artificial intelligence (AI) capable of recognizing an emotion, such as Pepper (registered trademark), and performs a manager operation in a restaurant. A staff is implemented by, for example, a person, a serving robot such as Servi (registered trademark) in which a facial expression recognition camera and an audio microphone are provided, or a drink preparation robot. In the example shown in FIG. 10A, the notification device 3010 includes an acquisition unit 3011, a control unit 3012, a notification unit 3013, and a storage unit 3014.

### (Acquisition Unit 3011)

The acquisition unit 3011 acquires at least one of customer information regarding a customer of a store, store information regarding the store, and order information regarding an order placed at the store. In the example shown in FIG. 10A, the acquisition unit 3011 further acquires risk information regarding a risk. The acquisition unit 3011 may further acquire at least one of action information regarding an action and satisfaction level information regarding a satisfaction level. The acquisition unit 3011 may acquire at least one of the customer information, the store information, and the order information by patrolling with another robot. The acquisition unit 3011 may further acquire at least one of the risk information, the action information, and the satisfaction level information by patrolling with another robot. For example, the acquisition unit 3011 acquires at least one of the customer information, the store information, and the order information in a case where at least one of the customer information, the store information, and the order information for each seat, which are collected by a serving operation of a serving robot such as Servi and patrolling in the store, is input to the notification device 3010 such as Pepper, which is a manager in a backyard. As a result, the acquisition unit 3011 can cause the notification device 3010 to suitably operate in conjunction with another robot in a manner in which, for example, the acquisition unit 3011 causes an analysis unit 3122 described below to evaluate the satisfaction level according to a serving timing and a clearing timing of Servi, and causes the notification unit 3013 to notify of an action for the customer according to the evaluation. The acquisition unit 3011 may acquire the customer information regarding at least one of a facial expression, a voice, and an attribute of the customer. For example, the acquisition unit 3011 acquires the customer information regarding the facial expression and a conversation of the customer obtained by patrolling with Servi. The acquisition unit 3011 may acquire the customer information regarding the attribute of the customer based on an ID (including a membership card or a membership number issued by the store) unique to the customer, face authentication, biometric authentication, and the like, in addition to a face, an appearance, and the voice of the customer. The acquisition unit 3011 may acquire the customer information regarding an emotion of the customer. For example, the acquisition unit 3011 recognizes the emotion of the customer based on the facial expression of the customer in imaging information of the customer captured by the facial expression recognition camera. An emotion recognition method is similar to the methods described in Patent Literatures 5 to 9, and thus a detailed description thereof will be omitted. The emotion recognition method is not limited to the methods, and other known methods may be used. The acquisition unit 3011 may acquire the store information regarding at least one of the degree of congestion in the store and a status of tables.

### (Control Unit 3012)

The control unit 3012 controls the entire notification device 3010. As an example, the control unit 3012 is implemented by executing various programs stored in a storage device inside the notification device 3010 using a RAM as a work area by a central processing unit (CPU), a micro processing unit (MPU), or the like. As another example, the control unit 3012 may be implemented by an integrated circuit such as an application specific integrated circuit (ASIC) or a field programmable gate array (FPGA).

In the example shown in FIG. 10A, the control unit 3012 includes a trained model generation unit 3121 and the analysis unit 3122.

### (Trained Model Generation Unit 3121)

The trained model generation unit 3121 generates, by using at least one of the customer information, the store information, and the order information, and the risk information, which are acquired by the acquisition unit 3011, a trained model 3141 from which the risk information is to be output in a case where at least one of the customer information, the store information, and the order information is input. For example, the trained model generation unit 3121 generates, by using the customer information and the risk information acquired by the acquisition unit 3011 as training data, a sentence generation model having a dialogue function including the trained model 3141 from which the risk information is to be output in a case where the customer information is input. The trained model generation unit 3121 may generate, by further using at least one of the satisfaction level information and the action information, which are acquired by the acquisition unit 3011, the trained model 3141 from which the risk information and at least one of the satisfaction level information and the action information are to be output in a case where at least one of the customer information, the store information, and the order information is input. The sentence generation model having the dialogue function is implemented by, for example, chat generative pre-trained transformer (ChatGPT).

### (Analysis Unit 3122)

The analysis unit 3122 analyzes a risk based on at least one of the customer information, the store information, and the order information which are acquired by the acquisition unit 3011. The analysis unit 3122 may further analyze at least one of an action to be taken for the customer and the satisfaction level of the customer based on at least one of the customer information, the store information, and the order information which are acquired by the acquisition unit 3011. For example, the analysis unit 3122 further analyzes an action related to at least one of approaching, order taking, serving, and payment. The analysis unit 3122 may analyze the risk based on the customer information regarding at least one of the facial expression, the voice, and the attribute of the customer, the customer information being acquired by the acquisition unit 3011. For example, the analysis unit 3122 infers a risk caused by a troublesome customer based on a reaction of the customer such as the facial expression or the voice to approaching from Pepper or the like. Furthermore, the analysis unit 3122 accumulates face recognition data and analyzes the risk caused by a troublesome customer based on a list of past troublesome customers. The analysis unit 3122 may analyze the risk based on the customer information regarding the emotion of the customer acquired by the acquisition unit 3011. For example, the analysis unit 3122 infers the risk caused by a troublesome customer based on customer emotion recognition performed by Pepper or the like. As a result, the analysis unit 3122 can perform analysis so as to provide more appropriate customer service. The analysis unit 3122 may further analyze at least one of the action and the satisfaction level based on the customer information regarding at least one of the facial expression, the voice, and the attribute of the customer which are acquired by the acquisition unit 3011. The analysis unit 3122 may analyze the risk based on the store information regarding at least one of the degree of congestion in the store and the status of tables. As a result, the analysis unit 3122 can perform analysis so as to provide more appropriate customer service. The analysis unit 3122 may further analyze at least one of the action and the satisfaction level based on the store information regarding at least one of the degree of congestion in the store and the status of tables.

The analysis unit 3122 may analyze the satisfaction level in a case where at least one of serving and clearing is performed. The analysis unit 3122 may quantitatively analyze the satisfaction level. For example, the analysis unit 3122 quantitatively evaluates the satisfaction level by recognizing an emotion such as the satisfaction level of the customer obtained by quantifying a positive emotion as an evaluation axis based on the facial expression of the customer in the imaging information of the customer captured by the facial expression recognition camera. An emotion recognition method is similar to the methods described in Patent Literatures 5 to 9, and thus a detailed description thereof will be omitted. The analysis unit 3122 may analyze at least one of the risk, the action, and the satisfaction level for at least one of each seat and each time slot of the store. The analysis unit 3122 may analyze the risk by using the trained model 3141 from which the risk information regarding the risk is to be output in a case where at least one of the customer information, the store information, and the order information, which are acquired by the acquisition unit 3011, is input. As a result, the analysis unit 3122 can perform analysis so as to provide more appropriate customer service. The analysis unit 3122 may analyze at least one of the risk, the action, and the satisfaction level by using the trained model 3141 from which at least one of the action information and the satisfaction level information is to be further output in a case where at least one of the customer information, the store information, and the order information, which are acquired by the acquisition unit 3011, is input.

Hereinafter, an example of the analysis performed by the analysis unit 3122 will be described. First, an example of main task analysis performed by the analysis unit 3122 will be described. As an example, in a case where a facial expression of a customer of a table with a certain number is gloomy for a predetermined time or more, the analysis unit 3122 analyzes that there is a possibility that the customer of the table with the number is dissatisfied with a dish or customer service, and the action to be taken is approaching. As another example, in a case where a customer of a table with a certain number is having a conversation suggesting ordering or a predetermined time (for example, 2 minutes) or more has elapsed since the customer entered the restaurant, the analysis unit 3122 analyzes that the customer of the table with the number is preparing to place an order and the action to be taken is order taking. As another example, in a case where a customer of a table with a certain number is having a conversation suggesting leaving the restaurant, the analysis unit 3122 analyzes that the customer of the table with the number is preparing to leave the restaurant, and the action to be taken is an action at the time of leaving the seat, such as payment.

Next, an example of sub-task analysis performed by the analysis unit 3122 will be described. For a sub-task, in a case where the order indicated by the order information is a specific order, the analysis unit 3122 analyzes that the action is at least one of specific approaching at the table of the customer and serving of a specific product. As a result, the analysis unit 3122 can provide customer service that meets a demand of the customer. As an example, in a case where an order is received from a customer of a table located away by a predetermined distance or more, the analysis unit 3122 analyzes that the action to be taken is to have a personalized conversation, perform order taking, or provide a sommelier service tailored to a preference at the table of the customer. As another example, in a case where an order for two additional beers is received from the customer, the analysis unit 3122 analyzes that the action to be taken is to provide a cautionary comment such as “You are drinking at a fast pace. Would you also like some water?” at the table of the customer. As another example, in a case where an order for recommended wine is received from the customer, the analysis unit 3122 analyzes that the action to be taken is to make a recommendation according to a preference of the customer or the most recent ordered product at the table of the customer. As another example, in a case where an order for a drink is received, the analysis unit 3122 analyzes that the action to be taken is to cause the drink preparation robot to prepare the drink and cause the serving robot to carry the drink preparation robot to the table of the customer. As described above, in a case where the notification device 3010 operates in conjunction with another robot, the analysis unit 3122 can also analyze, as the action to be taken, provision of a product in an unmanned manner. As another example, in a case where a specific product is ordered, the analysis unit 3122 analyzes that the action to be taken is to check evaluation on the specific product in order to acquire the satisfaction level of the customer for the specific product during the second visit of the staff such as the serving robot to the table of the customer.

### (Notification Unit 3013)

The notification unit 3013 notifies of the risk analyzed by the analysis unit 3122. The notification unit 3013 may further notify of at least one of the action and the satisfaction level analyzed by the analysis unit 3122.

For example, the notification unit 3013 issues an instruction for the risk caused by a troublesome customer and a necessary customer service and action analyzed by the analysis unit 3122 to the staff implemented by a person or a robot. As a result, the notification unit 3013 can cause the staff to perform appropriate table management in a restaurant, or the like, while avoiding the risk caused by a troublesome customer. As a result, the notification unit 3013 can cause the staff to provide a space that makes the customer feel that he/she “wants to visit again”. In addition, by making a notification to the robot such as the serving robot such as Servi, the notification unit 3013 can cause the notification device 3010 to suitably operate in conjunction with another robot in a manner in which, for example, the notification unit 3013 notifies Servi of the action for the customer according to the evaluation in a case where the satisfaction level is evaluated by the analysis unit 3122 according to the serving timing or the clearing timing of Servi. A notification method executed by the notification unit 3013 is not particularly limited, and for example, in a case where the notification unit 3013 is a sound output unit, a notification may be made by outputting a speech such as a conversation, in a case where the notification unit 3013 is a display unit such as a tablet, a notification may be made by displaying characters, symbols, or the like, and in a case where a notification target is a robot, a notification may be made via communication or the like.

The notification unit 3013 may notify of at least one of the risk, the action, and the satisfaction level analyzed for at least one of each seat and each time slot of the store by the analysis unit 3122. For example, the notification unit 3013 notifies the staff of the satisfaction level analyzed for each seat and each time slot of the store by the analysis unit 3122.

The notification unit 3013 may notify of the satisfaction level quantitatively analyzed by the analysis unit 3122. The notification unit 3013 may further notify of the action related to at least one of the approaching, the order taking, the serving, and the payment analyzed by the analysis unit 3122. As described above, the notification unit 3013 can provide more appropriate customer service by notifying of more detailed information. The notification unit 3013 is implemented by, for example, the sound output unit or the display unit such as a tablet. The notification unit 3013 may notify of the action related to at least one of the specific approaching at the table of the customer and the serving of the specific product, the action being analyzed by the analysis unit 3122. Hereinafter, an example of the notification made by the notification unit 3013 will be described with reference to FIG. 10B. FIG. 10B is a diagram for describing an example of the notification device 3010. In the example shown in FIG. 10B, the notification device 3010 is the robot such as Pepper, and a staff 20 is the serving robot such as Servi. Further, in the example shown in FIG. 10B, in a case where an order for two additional beers is received from a customer 30, the analysis unit 3122 analyzes that the action to be taken is to cause the staff 20 to provide a cautionary comment such as “You are drinking at a fast pace. Would you also like some water?” at the table of the customer 30. In this case, the notification unit 3013 notifies the staff 20 of the action of providing a cautionary comment such as “You are drinking at a fast pace. Would you also like some water?” at the table of the customer 30.

### (Storage Unit 3014)

The description returns to FIG. 10A. The storage unit 3014 stores various types of data and various programs such as the customer information, the store information, the order information, the satisfaction level information, the action information, the risk information, and the trained model 3141.

The storage unit 3014 is implemented by a semiconductor memory element such as a random access memory (RAM) or a flash memory, or a storage device such as a hard disk or an optical disk.

### [2. Notification Method]

Next, an example of processing performed by the notification device 3010 according to the embodiment will be described with reference to FIG. 10C. FIG. 10C is a flowchart showing an example of a flow of the processing performed by the notification device 3010.

In step S3001, the acquisition unit 3011 acquires at least one of the customer information regarding a customer of a store, the store information regarding the store, and the order information regarding an order placed at the store. For example, the acquisition unit 3011 acquires at least one of the customer information, the store information, and the order information in a case where at least one of the customer information, the store information, and the order information for each seat, which are collected by a serving operation of a serving robot such as Servi and patrolling in the store, is input to the notification device 3010 such as Pepper, which is a manager in a backyard.

In step S3002, the analysis unit 3122 analyzes a risk based on at least one of the customer information, the store information, and the order information which are acquired by the acquisition unit 3011.

In step S3003, the notification unit 3013 notifies of the risk analyzed by the analysis unit 3122. For example, the notification unit 3013 issues an instruction for the risk caused by a troublesome customer and a necessary customer service and action analyzed by the analysis unit 3122 to the staff implemented by a person or a robot.

### [3. Hardware Configuration]

FIG. 4 is a diagram showing an example of a hardware configuration of the notification device 3010.

### Tenth Embodiment

### [1. Determination Device]

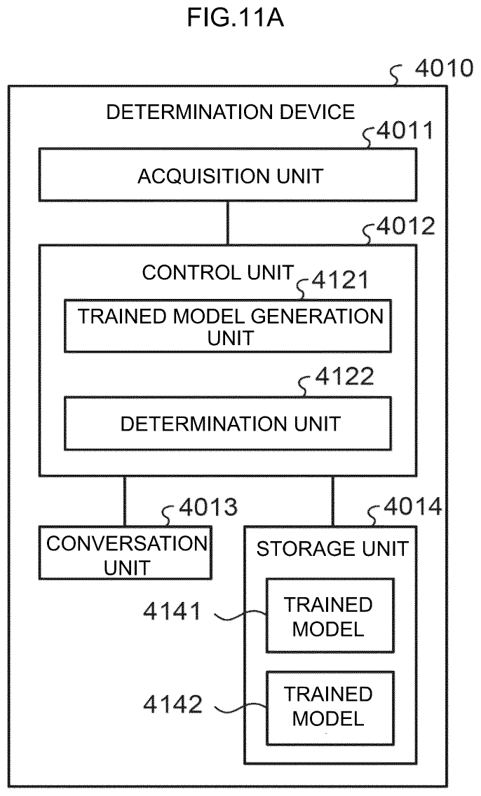

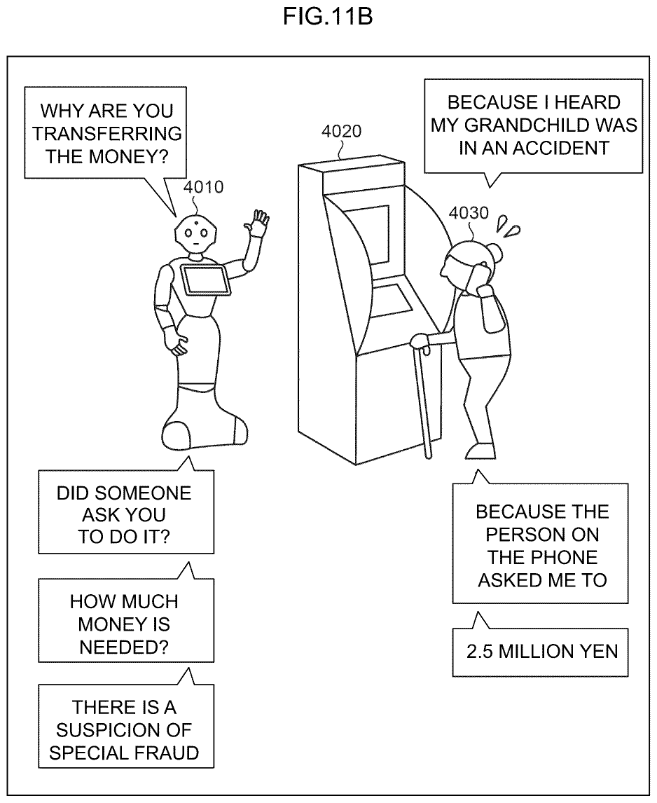

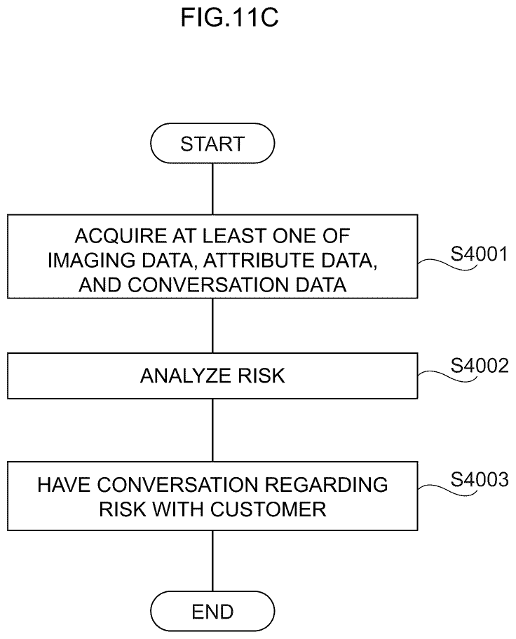

An example of a determination device 4010 according to an embodiment will be described with reference to FIG. 11A. FIG. 11A is a block diagram showing an example of a configuration of the determination device 4010. The determination device 4010 determines a special fraud risk for a customer and has a conversation regarding a risk with the customer. The determination device 4010 is implemented by, for example, a humanoid robot of an artificial intelligence (AI) capable of recognizing an emotion, such as Pepper (registered trademark), a microphone, and the like, and is installed in the vicinity of an asynchronous transfer mode (ATM) of a bank, a convenience store, or another store, or a place where a prepaid card is sold. In the example shown in FIG. 11A, the determination device 4010 includes an acquisition unit 4011, a control unit 4012, a conversation unit 4013, and a storage unit 4014.

### (Acquisition Unit 4011)

The acquisition unit 4011 acquires at least one of imaging data obtained by imaging a customer in a store, attribute data regarding an attribute of the customer, and conversation data regarding a conversation of the customer. For example, the acquisition unit 4011 acquires the pieces of data in the vicinity of an ATM of a bank, a convenience store, or another store, or a place where a prepaid card is sold. Specifically, the acquisition unit 4011 acquires, as imaging data, video data obtained by imaging the customer using a camera installed in the vicinity of the ATM in the store, and acquires the conversation data of the customer using a microphone installed in the vicinity of the ATM in the store. The acquisition unit 4011 may acquire the attribute data regarding at least one of the age and the gender of the customer. In the example shown in FIG. 11A, the acquisition unit 4011 further acquires risk data regarding a risk, emotion data regarding an emotion of the customer, and reaction data regarding a reaction of the customer to a conversation regarding the risk, the conversation being made by the conversation unit 4013. For example, the acquisition unit 4011 acquires the emotion data recognized based on at least one of the imaging data and the conversation data. Furthermore, the acquisition unit 4011 acquires the reaction data regarding the emotion of the customer in the case of receiving feedback from the customer as to whether or not the conversation regarding the risk, which is made by the conversation unit 4013, was correct. The acquisition unit 4011 may acquire the emotion data and the reaction data by recognizing the emotion of the customer, or may acquire the emotion data or the reaction data obtained by recognizing the emotion in advance. An emotion recognition method is similar to the methods described in Patent Literatures 5 to 9, and thus a detailed description thereof will be omitted. The emotion recognition method is not limited to the methods, and other known methods may be used.

### (Control Unit 4012)

The control unit 4012 controls the entire determination device 4010. As an example, the control unit 4012 is implemented by executing various programs stored in a storage device inside the determination device 4010 using a RAM as a work area by a central processing unit (CPU), a micro processing unit (MPU), or the like. As another example, the control unit 4012 is implemented by an integrated circuit such as an application specific integrated circuit (ASIC) or a field programmable gate array (FPGA). In the example shown in FIG. 11A, the control unit 4012 includes a trained model generation unit 4121 and a determination unit 4122.

### (Trained Model Generation Unit 4121)

The trained model generation unit 4121 generates, by using at least one of the imaging data, the attribute data, and the conversation data, and the risk data, which are acquired by the acquisition unit 4011, a trained model 4141 from which the risk data is to be output in a case where at least one of the imaging data, the attribute data, and the conversation data is input. For example, the trained model generation unit 4121 generates, by using the imaging data, the attribute data, the conversation data, and the risk data, which are acquired by the acquisition unit 4011, as training data, a sentence generation model having a dialogue function including the trained model 4141 from which the risk data is to be output in a case where the imaging data, the attribute data, and the conversation data are input.

Furthermore, the trained model generation unit 4121 generates, by using the emotion data acquired by the acquisition unit 4011 and the conversation data regarding the conversation regarding the risk, a trained model 4142 from which the risk-related conversation data is to be output in a case where the emotion data is input. For example, the trained model generation unit 4121 generates, by using the emotion data and risk-related conversation data, which are acquired by the acquisition unit 4011, as training data, the sentence generation model having the dialogue function including the trained model 4142 from which the risk-related conversation data is to be output in a case where the emotion data is input. The trained model generation unit 4121 may cause the trained model 4142 to be retrained using the risk-related conversation data and the reaction data regarding the reaction of the customer to the conversation regarding the risk. For example, the trained model generation unit 4121 causes the trained model 4142 to be retained using, as training data, the risk-related conversation data and the reaction data regarding the emotion of the customer which is acquired by the acquisition unit 4011 in the case of receiving feedback from the customer as to whether or not the conversation regarding the risk was correct. The sentence generation model having the dialogue function is implemented by, for example, chat generative pre-trained transformer (ChatGPT).

### (Determination Unit 4122)

The determination unit 4122 determines the special fraud risk for the customer based on at least one of the imaging data, the attribute data, and the conversation data, which are acquired by the acquisition unit 4011. The determination unit 4122 may determine the risk by using the trained model 4141 from which the risk data regarding the risk is to be output in a case where at least one of the imaging data, the attribute data, and the conversation data, which are acquired by the acquisition unit 4011, is input. The determination unit 4122 may determine the risk based on at least one of a facial expression and the emotion of the customer. For example, the determination unit 4122 determines the risk based on at least one of the facial expression of the customer recognized based on the imaging data acquired by the acquisition unit 4011 and the emotion of the customer recognized based on at least one of the imaging data and the conversation data. In the case of determining the risk based on the facial expression of the customer, the determination unit 4122 may determine the risk by recognizing the facial expression of the customer from the imaging data, or may determine the risk based on the facial expression of the customer recognized in advance using a facial expression recognition camera or the like. In the case of determining the risk based on the emotion of the customer, the determination unit 4122 may determine the risk by recognizing the emotion of the customer from at least one of the imaging data and the conversation data, or may determine the risk based on the emotion of the customer recognized in advance.

The determination unit 4122 may determine that the risk is higher in a case where the emotion of the customer is negative than in a case where the emotion of the customer is positive. In a case where the emotion of the customer is at least one of agitation, worry, and anxiety, the determination unit 4122 may determine that the risk is higher than that in a case where the emotion of the customer is not agitation, worry, and anxiety. For example, the determination unit 4122 quantifies the magnitude of the risk on a scale of 0 to 10, determines a numerical value of the risk to be 2 to 4 in a case where the emotion of the customer is at least one of agitation, worry, and anxiety, and determines the numerical value of the risk to be 0 to 1 in a case where the emotion of the customer is not worry and anxiety. Hereinafter, similarly, in a case where the determination unit 4122 determines that the risk is high, the numerical value of the risk is determined to be 2 to 4. Furthermore, in a case where there are a plurality of factors contributing to the determination that the risk is high, the determination unit 4122 determines the sum of numerical values of the risk by adding the numerical values of the risk determined according to the plurality of factors.

The determination unit 4122 may determine the risk based on at least one of a motion and a posture of the customer in the imaging data acquired by the acquisition unit 4011. For example, in a case where the motion of the customer recognized from the imaging data of the customer is a motion in which the customer operates the ATM while speaking, the determination unit 4122 determines that the risk is higher than that in a case where the customer operates the ATM in silence. Since a method of determining the risk based on at least one of the motion and the posture of the customer in the imaging data by the determination unit 4122 is disclosed in a reference literature (Internet search <URL: https://www.itmedia.co.jp/news/articles/2212/07/news077.html>), a detailed description thereof will be omitted. The determination unit 4122 may determine the risk based on at least one of the age and the gender of the customer indicated by the attribute data acquired by the acquisition unit 4011. As a result, the determination unit 4122 can detect the risk with higher accuracy. For example, in a case where the attribute of the customer indicated by the attribute data acquired by the acquisition unit 4011 is an elderly person, the determination unit 4122 determines that the risk is higher than that in a case where the attribute of the customer is not an elderly person. As a result, the determination unit 4122 can detect the risk with higher accuracy. The determination unit 4122 may determine the risk based on a keyword included in the conversation data. For example, in a case where a keyword related to special fraud, such as “bank transfer”, “involved in an accident”, or “urgent”, is included in the conversation data, the determination unit 4122 determines that the risk is higher than that in a case where the keyword is not included.

The determination unit 4122 may determine a content of the conversation regarding the risk based on the emotion of the customer, and cause the conversation unit 4013 to have the conversation regarding the risk with the corresponding content. For example, in a case where the emotion of the customer is agitation, the determination unit 4122 determines, as the content of the conversation regarding the risk, a content for calming the customer once. As a result, the determination unit 4122 can cause the conversation unit 4013 to have a conversation according to the emotion of the customer. The determination unit 4122 may determine the content of the conversation regarding the risk by using the trained model 4142 from which the risk-related conversation data regarding the conversation regarding the risk is to be output in a case where the emotion data regarding the emotion is input, and cause the conversation unit 4013 to have the conversation regarding the risk with the content. As a result, the determination unit 4122 can improve the content of the conversation regarding the risk, which is prepared in advance, such as an initially set talk script, by training of the trained model 4142.

The determination unit 4122 may determine the content of the conversation regarding the risk by using the trained model 4142 retrained using the risk-related conversation data and the reaction data regarding the reaction of the customer to the conversation regarding the risk, and cause the conversation unit 4013 to have the conversation regarding the risk with the content. For example, the determination unit 4122 determines the content of the conversation regarding the risk by using the trained model 4142 retrained using the risk-related conversation data and the reaction data regarding the emotion of the customer which is acquired by the acquisition unit 4011 in the case of receiving feedback from the customer as to whether or not the conversation regarding the risk was correct, and causes the conversation unit 4013 to have the conversation regarding the risk with the content. As a result, the determination unit 4122 can improve the content of the conversation regarding the risk according to the reaction of the customer prepared in advance, such as an initially set talk script, by training of the trained model 4142. The determination unit 4122 may determine the content of the conversation regarding the risk by using the sentence generation model having the dialogue function including the trained model 4142, and cause the conversation unit 4013 to have the conversation regarding the risk with the content.

As a result, the determination unit 4122 can cause the conversation unit 4013 to have a more improved conversation.

### (Conversation Unit 4013)

The conversation unit 4013 has a conversation regarding the risk determined by the determination unit 4122 with the customer.

For example, the conversation unit 4013 has the conversation regarding the risk with the customer, the conversation including at least one of risk explanation, persuasion, and questioning. Hereinafter, an example of the conversation by the conversation unit 4013 will be described with reference to FIG. 11B. FIG. 11B is a diagram for describing an example of the determination device 4010. In the example shown in FIG. 11B, the determination device 4010 is a robot such as Pepper, and is installed in the vicinity of the ATM 20 of a bank, a convenience store, or another store. The determination device 4010 may be implemented by the ATM 20 or other equipment. In a case where the keyword such as “bank transfer”, “involved in an accident”, or “urgent” is included in the conversation data, the conversation unit 4013 has the conversation regarding the risk with the customer 30 as shown in FIG. 11B, the conversation including a question for checking a situation, such as “Why are you transferring the money?”, “Did someone ask you to do it?”, or “How much money is needed?” or an explanation of a suspicion of special fraud, such as “There is a suspicion of special fraud”. Therefore, the conversation unit 4013 can recognize the situation and identify risk factors unlike the related art in which once it is determined that the risk is high, a notification is made to the customer 30 without confirmation, and thus, the risk can be detected with high accuracy. As a result, the conversation unit 4013 can increase a possibility of being able to prevent a damage caused by special fraud and can reduce the damage caused by special fraud.

The description returns to FIG. 11A. The conversation unit 4013 may perform an action based on the risk determined by the determination unit 4122. For example, the conversation unit 4013 performs a different action each time a value of the risk quantified by the determination unit 4122 exceeds a threshold. As an example, in a case where the value of the risk quantified by the determination unit 4122 is 0 to 1, the conversation unit 4013 does not take any measure against the risk in the conversation regarding the risk. In a case where the value of the risk quantified by the determination unit 4122 is 2 to 4, the conversation unit 4013 approaches the customer and inquires of the customer about the risk.

In this case, the determination unit 4122 may further determine the risk. In a case where the value of the risk quantified by the determination unit 4122 is 5 to 8, the conversation unit 4013 makes a notification to the staff. In a case where the value of the risk quantified by the determination unit 4122 is 9 to 10, the conversation unit 4013 reports to the police. A conversation, notification, and reporting method executed by the conversation unit 4013 is not particularly limited. For example, in a case where the conversation unit 4013 is a sound output unit, the conversation, notification, and reporting may be made by outputting a speech, in a case where the conversation unit 4013 is a display unit such as a tablet, the conversation, notification, and reporting may be made by displaying characters, symbols, or the like, and in the case of reporting to the police, the reporting may be performed through communication.

### (Storage Unit 4014)

The storage unit 4014 stores various types of data and various programs such as the imaging data, the attribute data, the conversation data, the risk data, the trained model 4141, and the trained model 4142. The storage unit 4014 is implemented by, for example, a semiconductor memory element such as a random access memory (RAM) or a flash memory, or a storage device such as a hard disk or an optical disk.

### [2. Determination Method]

Next, an example of processing performed by the determination device 4010 according to the embodiment will be described with reference to FIG. 11C. FIG. 11C is a flowchart showing an example of a flow of the processing performed by the determination device 4010.

In step S1, the acquisition unit 4011 acquires at least one of the imaging data obtained by imaging a customer in a store, the attribute data regarding an attribute of the customer, and the conversation data regarding a conversation of the customer. For example, the acquisition unit 4011 acquires at least one of the imaging data, the customer data, and the conversation data in a case where the customer is located in the vicinity of an ATM of a bank, a convenience store, or another store or a place where a prepaid card is sold.

In step S2, the determination unit 4122 determines the special fraud risk for the customer based on at least one of the imaging data, the attribute data, and the conversation data, which are acquired by the acquisition unit 4011.

In step S3, the conversation unit 4013 has a conversation regarding the risk determined by the determination unit 4122 with the customer. For example, in a case where the keyword such as “bank transfer”, “involved in an accident”, or “urgent” is included in the conversation data, the conversation unit 4013 has the conversation regarding the risk with the customer, the conversation including a question for checking a situation, such as “Why are you transferring the money”, “Did someone ask you to do it”, or “How much money is needed” or an explanation of a suspicion of special fraud, such as “There is a suspicion of special fraud”.

### [3. Hardware Configuration]

FIG. 4 is a diagram showing an example of a hardware configuration of the determination device 4010.

Hereinafter, supplementary notes related to the disclosure will be described.

### Supplementary Note 1

An action control system including:
an emotion determination unit that determines an emotion of a user or an emotion of a robot; and
an action determination unit that generates an action content of the robot for an action of the user and the emotion of the user or the emotion of the robot based on a dialogue function of causing the user and the robot to have a dialogue with each other, and determines an action of the robot corresponding to the action content,
in which the action determination unit determines whether or not the action of the user is dangerous by detecting the action of the user, and generates a first action content for correcting the action of the user in a case where the action of the user is dangerous.

### Supplementary Note 2

The action control system according to Supplementary Note 1, in which the first action content includes at least one of making a gesture for correcting the action of the user and reproducing a speech for correcting the action of the user.

### Supplementary Note 3

The action control system according to Supplementary Note 2, in which the action determination unit determines whether or not the action of the user has been corrected by detecting the action of the user after the robot makes the gesture or reproduces the speech, and generates a second action content different from the first action content in a case where the action of the user has been corrected.

### Supplementary Note 4

The action control system according to Supplementary Note 3, in which the second action content includes at least one of a speech for praising the action of the user and a speech for expressing gratitude for the action of the user.

### Supplementary Note 5

The action control system according to Supplementary Note 2, in which the action determination unit determines whether or not the action of the user has been corrected by detecting the action of the user after the robot makes the gesture or reproduces the speech, and generates a third action content different from the first action content in a case where the action of the user has not been corrected.

### Supplementary Note 6

The action control system according to Supplementary Note 5, in which the third action content includes at least one of transmitting specific information to a person other than the user, making a gesture that draws an interest of the user, reproducing a sound that draws an interest of the user, and reproducing a video that draws an interest of the user.

### Supplementary Note 7

The action control system according to Supplementary Note 1, in which the robot is mounted on a stuffed toy or is connected wirelessly or by wire to control target equipment mounted on a stuffed toy.

### Supplementary Note 8

An action control system including:
an emotion determination unit that determines an emotion of a user or an emotion of a robot; and
an action determination unit that generates an action content of the robot for an action of the user and the emotion of the user or the emotion of the robot based on a sentence generation model having a dialogue function of causing the user and the robot to have a dialogue with each other, and determines an action of the robot corresponding to the action content,
in which the action determination unit receives statements of a plurality of the users having a conversation, and determines, as the action of the robot, to summarize contents of the statements in a case where the statements are in a predetermined state.

### Supplementary Note 9

The action control system according to Supplementary Note 8, in which the state is a state in which the statements are no longer received for a predetermined time.

### Supplementary Note 10

The action control system according to Supplementary Note 8, in which the state is a state in which a term included in the statement is received a predetermined number of times.

### Supplementary Note 11

The action control system according to Supplementary Note 8, in which the robot is mounted on a stuffed toy or is connected wirelessly or by wire to control target equipment mounted on a stuffed toy.

### Supplementary Note 12

An action control system including:
an emotion determination unit that determines an emotion of a user or an emotion of a robot; and
an action determination unit that generates an action content of the robot for an action of the user and the emotion of the user or the emotion of the robot based on a dialogue function of causing the user and the robot to have a dialogue with each other, and determines an action of the robot corresponding to the action content, in which
the robot is set at customs, and
the action determination unit acquires an image of a person acquired by an image sensor and an odor detection result of an odor sensor, and determines, as the action of the robot, to make a notification to a tax inspector in a case where a preset abnormal action, an abnormal facial expression, or an abnormal odor is detected.

### Supplementary Note 13

An action control system including:
a user state recognition unit that recognizes a user state including an action of a user;
an emotion determination unit that determines an emotion of the user or an emotion of a robot; and
an action determination unit that determines an action of the robot corresponding to the user state and a conversation content of a plurality of the users based on a sentence generation model having a dialogue function of causing the user and the robot to have a dialogue with each other,
in which the action determination unit determines a special fraud risk based on the conversation content of the plurality of users and the emotions of the users.

### Supplementary Note 14

The action control system according to Supplementary Note 13, in which the robot is mounted on a stuffed toy or is connected wirelessly or by wire to control target equipment mounted on a stuffed toy.

### Supplementary Note 15

The action control system according to Supplementary Note 14, in which
the control target equipment is a speaker, and
a microphone or a camera is mounted on the stuffed toy.

### Supplementary Note 16

The action control system according to Supplementary Note 15, in which the camera is attached to an eye included in a face of the stuffed toy, the microphone is attached to an ear, and the speaker is attached to a mouth.

### Supplementary Note 17

The action control system according to Supplementary Note 14, in which
a wireless power receiving unit that receives wireless power supply from an external wireless power transmitting unit is disposed inside the stuffed toy, and
the control target equipment or the robot receives power via the wireless power receiving unit.

### Supplementary Note 18

An action control system including:
a user state recognition unit that recognizes user states including actions of a plurality of users;
an emotion determination unit that determines emotions of the plurality of users or an emotion of a robot; and
an action determination unit that determines an action of the robot corresponding to the user states and a conversation content of the plurality of users based on a sentence generation model having a dialogue function of causing the user and the robot to have a dialogue with each other,
in which the action determination unit detects a specific incident based on the conversation content of the plurality of users and the emotions of the users.

### Supplementary Note 19

The action control system according to Supplementary Note 18, in which the robot is mounted on a stuffed toy or is connected wirelessly or by wire to control target equipment mounted on a stuffed toy.

### Supplementary Note 20

The action control system according to Supplementary Note 19, in which
the control target equipment is a speaker, and
a microphone or a camera is mounted on the stuffed toy.

### Supplementary Note 21

The action control system according to Supplementary Note 20, in which the camera is attached to an eye included in a face of the stuffed toy, the microphone is attached to an ear, and the speaker is attached to a mouth.

### Supplementary Note 22

The action control system according to Supplementary Note 19, in which
a wireless power receiving unit that receives wireless power supply from an external wireless power transmitting unit is disposed inside the stuffed toy, and
the control target equipment or the robot receives power via the wireless power receiving unit.

### Supplementary Note 23

An action control system including:
a user state recognition unit that recognizes a user state including an action of a user;
an emotion determination unit that determines an emotion of the user or an emotion of a robot; and
an action determination unit that determines an action of the robot corresponding to the user state and the emotion of the user or the emotion of the robot based on a sentence generation model having a dialogue function of causing the user and the robot to have a dialogue with each other,
in which the action determination unit performs childcare for the user based on at least one of the user state and the emotion of the user.

### Supplementary Note 24

The action control system according to Supplementary Note 23, in which the robot is mounted on a stuffed toy or is connected wirelessly or by wire to control target equipment mounted on a stuffed toy.

### Supplementary Note 25

The action control system according to Supplementary Note 24, in which
the control target equipment is a speaker, and
a microphone or a camera is mounted on the stuffed toy.

### Supplementary Note 26

The action control system according to Supplementary Note 25, in which the camera is attached to an eye included in a face of the stuffed toy, the microphone is attached to an ear, and the speaker is attached to a mouth.

### Supplementary Note 27

The action control system according to Supplementary Note 24, in which
a wireless power receiving unit that receives wireless power supply from an external wireless power transmitting unit is disposed inside the stuffed toy, and
the control target equipment or the robot receives power via the wireless power receiving unit.

### Supplementary Note 28

An action control system including:
a state recognition unit that recognizes a user state including an action of a user and a state of electronic equipment;
an emotion determination unit that determines an emotion of the user or an emotion of the electronic equipment;
an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing; and
a storage control unit that stores, in history data, event data including an emotion value determined by the emotion determination unit and data including the action of the user, in which
the equipment operation includes provision of advice on caregiving to the user, and
in a case where the action determination unit determines, as the action of the electronic equipment, to provide the advice on caregiving to the user, the action determination unit collects information regarding caregiving for the user and provides the advice on caregiving for the user based on the collected information.

### Supplementary Note 29

The action control system according to Supplementary Note 28, in which
the electronic equipment is a robot, and
the action determination unit determines, as an action of the robot, any one of a plurality of types of robot actions including doing nothing.

### Supplementary Note 30

The action control system according to Supplementary Note 29, in which
the action determination model is a sentence generation model having a dialogue function, and
the action determination unit inputs a text representing at least one of the user state, a state of the robot, the emotion of the user, and an emotion of the robot and a text for inquiry about the robot action to the sentence generation model, and determines the action of the robot based on an output of the sentence generation model.

### Supplementary Note 31

The action control system according to Supplementary Note 29 or 30, in which the robot is mounted on a stuffed toy or is connected wirelessly or by wire to control target equipment mounted on a stuffed toy.

### Supplementary Note 32

The action control system according to Supplementary Note 29 or 30, in which the robot is an agent for having a dialogue with the user.

### Supplementary Note 33

The action control system according to Supplementary Note 28, in which the action determination unit collects the information regarding caregiving for the user even in a case where the user is absent.

### Supplementary Note 34

An action control system including:
a state recognition unit that recognizes a user state including an action of a user and a state of electronic equipment;
an emotion determination unit that determines an emotion of the user or an emotion of the electronic equipment;
an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing; and
a storage control unit that stores, in history data, event data including an emotion value determined by the emotion determination unit and data including the action of the user, in which
the equipment operation includes notification of information based on the emotion of the user for an item provided by a provider to the provider, and
in a case where the action determination unit determines, as the action of the electronic equipment, to notify the provider of the information based on the emotion of the user for the item provided by the provider, the action determination unit notifies the provider of the information based on the emotion of the user for the item provided by the provider.

### Supplementary Note 35

The action control system according to Supplementary Note 34, in which
the electronic equipment is a robot, and
the action determination unit determines, as an action of the robot, any one of a plurality of types of robot actions including doing nothing.

### Supplementary Note 36

The action control system according to Supplementary Note 35, in which
the action determination model is a sentence generation model having a dialogue function, and
the action determination unit inputs a text representing at least one of the user state, a state of the robot, the emotion of the user, and an emotion of the robot and a text for inquiry about the robot action to the sentence generation model, and determines the action of the robot based on an output of the sentence generation model.

### Supplementary Note 37

The action control system according to Supplementary Note 35 or 36, in which the robot is mounted on a stuffed toy or is connected wirelessly or by wire to control target equipment mounted on a stuffed toy.

### Supplementary Note 38

The action control system according to Supplementary Note 35 or 36, in which the robot is an agent for having a dialogue with the user.

### Supplementary Note 39

An action control system including:
a state recognition unit that recognizes a user state including an action of a user and a state of electronic equipment;
an emotion determination unit that determines an emotion of the user or an emotion of the electronic equipment; and
an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing, in which
the equipment operation includes provision of advice on a fraud risk to the user, and
in a case where the action determination unit determines, as the action of the electronic equipment, to provide the advice on a fraud risk to the user, the action determination unit provides the advice on a fraud risk to the user.

### Supplementary Note 40

The action control system according to Supplementary Note 39, in which
the electronic equipment is a robot, and
the action determination unit determines, as an action of the robot, any one of a plurality of types of robot actions including doing nothing.

### Supplementary Note 41

The action control system according to Supplementary Note 40, in which
the action determination model is a sentence generation model having a dialogue function, and
the action determination unit inputs a text representing at least one of the user state, a state of the robot, the emotion of the user, and an emotion of the robot and a text for inquiry about the robot action to the sentence generation model, and determines the action of the robot based on an output of the sentence generation model.

### Supplementary Note 42

The action control system according to Supplementary Note 40 or 41, in which the robot is mounted on a stuffed toy or is connected wirelessly or by wire to control target equipment mounted on a stuffed toy.

### Supplementary Note 43

The action control system according to Supplementary Note 40 or 41, in which the robot is an agent for having a dialogue with the user.

### Supplementary Note 44

An action control system including:
a state recognition unit that recognizes a user state including an action of a user and a state of electronic equipment;
an emotion determination unit that determines an emotion of the user or an emotion of the electronic equipment; and
an action determination unit that determines, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing, in which
the equipment operation includes provision of advice on a risk approaching the user, and
in a case where the action determination unit determines, as the action of the electronic equipment, to provide the advice on a risk approaching the user, the action determination unit provides the advice on a risk approaching the user.

### Supplementary Note 45

The action control system according to Supplementary Note 44, in which
the electronic equipment is a robot, and
the action determination unit determines, as an action of the robot, any one of a plurality of types of robot actions including doing nothing.

### Supplementary Note 46

The action control system according to Supplementary Note 45, in which
the action determination model is a sentence generation model having a dialogue function, and
the action determination unit inputs a text representing at least one of the user state, a state of the robot, the emotion of the user, and an emotion of the robot and a text for inquiry about the robot action to the sentence generation model, and determines the action of the robot based on an output of the sentence generation model.

### Supplementary Note 47

The action control system according to Supplementary Note 45 or 46, in which the robot is mounted on a stuffed toy or is connected wirelessly or by wire to control target equipment mounted on a stuffed toy.

### Supplementary Note 48

The action control system according to Supplementary Note 45 or 46, in which the robot is an agent for having a dialogue with the user.

### Supplementary Note 49

A notification device including:
an acquisition unit that acquires at least one of customer information regarding a customer of a store, store information regarding the store, and order information regarding an order placed at the store;
an analysis unit that analyzes a risk based on at least one of the customer information, the store information, and the order information which are acquired by the acquisition unit; and
a notification unit that notifies of the risk analyzed by the analysis unit.

### Supplementary Note 50

The notification device according to Supplementary Note 49, in which the analysis unit analyzes the risk by using a trained model from which risk information regarding the risk is to be output in a case where at least one of the customer information, the store information, and the order information, which are acquired by the acquisition unit, is input.

### Supplementary Note 51

The notification device according to Supplementary Note 49, in which
the acquisition unit acquires the customer information regarding at least one of a facial expression, a voice, and an attribute of the customer, and
the analysis unit analyzes the risk based on the customer information regarding at least one of the facial expression, the voice, and the attribute of the customer, the customer information being acquired by the acquisition unit.

### Supplementary Note 52

The notification device according to Supplementary Note 49, in which
the acquisition unit acquires the store information regarding at least one of a degree of congestion in the store and a status of tables, and
the analysis unit analyzes the risk based on the store information regarding at least one of the degree of congestion in the store and the status of tables.

### Supplementary Note 53

The notification device according to any one of Supplementary Notes 49 to 52, in which
the analysis unit further analyzes an action to be taken for the customer, the action being related to at least one of approaching, order taking, serving, and payment, and
the notification unit further notifies of the action related to at least one of the approaching, the order taking, the serving, and the payment, the action being analyzed by the analysis unit.

### Supplementary Note 54

The notification device according to Supplementary Note 53, in which
in a case where the order indicated by the order information is a specific order, the analysis unit analyzes that the action is at least one of specific approaching at a table of the customer and serving of a specific product, and
the notification unit notifies of the action related to at least one of the specific approaching at the table of the customer and the serving of the specific product, the action being analyzed by the analysis unit.

### Supplementary Note 55

A notification method executed by a notification device, the notification method including:
an acquisition step of acquiring at least one of customer information regarding a customer of a store, store information regarding the store, and order information regarding an order placed at the store;
an analysis step of analyzing a risk based on at least one of the customer information, the store information, and the order information which are acquired in the acquisition step; and
a notification step of notifying of the risk analyzed in the analysis step.

### Supplementary Note 56

A notification program for causing a computer to execute:
an acquisition step of acquiring at least one of customer information regarding a customer of a store, store information regarding the store, and order information regarding an order placed at the store;
an analysis step of analyzing a risk based on at least one of the customer information, the store information, and the order information which are acquired in the acquisition step; and
a notification step of notifying of the risk analyzed in the analysis step.

### Supplementary Note 57

A determination device including:
an acquisition unit that acquires at least one of imaging data obtained by imaging a customer in a store, attribute data regarding an attribute of the customer, and conversation data regarding a conversation of the customer;
a determination unit that determines a special fraud risk for the customer based on at least one of the imaging data, the attribute data, and the conversation data which are acquired by the acquisition unit; and
a conversation unit that has a conversation regarding the risk determined by the determination unit with the customer.

### Supplementary Note 58

The determination device according to Supplementary Note 57, in which the determination unit determines a content of the conversation regarding the risk based on an emotion of the customer and causes the conversation unit to have the conversation regarding the risk with the content.

### Supplementary Note 59

The determination device according to Supplementary Note 58, in which the determination unit determines the content of the conversation regarding the risk by using a trained model from which risk-related conversation data regarding the conversation regarding the risk is to be output in a case where emotion data regarding the emotion is input, and causes the conversation unit to have the conversation regarding the risk with the content.

### Supplementary Note 60

The determination device according to Supplementary Note 59, in which the determination unit determines the content of the conversation regarding the risk by using the trained model retrained using the risk-related conversation data and reaction data regarding a reaction of the customer to the conversation regarding the risk, and causes the conversation unit to have the conversation regarding the risk with the content.

### Supplementary Note 61

The determination device according to Supplementary Note 59 or 60, in which the determination unit determines the content of the conversation regarding the risk by using a sentence generation model having a dialogue function including the trained model, and causes the conversation unit to have the conversation regarding the risk with the content.

### Supplementary Note 62

The determination device according to Supplementary Note 57, in which
the acquisition unit acquires the attribute data regarding at least one of an age and a gender of the customer, and
the determination unit determines the risk based on at least one of the age and the gender of the customer indicated by the attribute data acquired by the acquisition unit.

### Supplementary Note 63

The determination device according to Supplementary Note 62, in which in a case where the attribute of the customer indicated by the attribute data acquired by the acquisition unit is an elderly person, the determination unit determines that the risk is higher than that in a case where the attribute of the customer is not the elderly person.

### Supplementary Note 64

A determination method executed by a determination device, the determination method including:
an acquisition step of acquiring at least one of imaging data obtained by imaging a customer in a store, attribute data regarding an attribute of the customer, and conversation data regarding a conversation of the customer;
a determination step of determining a special fraud risk for the customer based on at least one of the imaging data, the attribute data, and the conversation data which are acquired in the acquisition step; and
a conversation step of having a conversation regarding the risk determined in the determination step with the customer.

### Supplementary Note 65

A determination program for causing a computer to execute:
an acquisition step of acquiring at least one of imaging data obtained by imaging a customer in a store, attribute data regarding an attribute of the customer, and conversation data regarding a conversation of the customer;
a determination step of determining a special fraud risk for the customer based on at least one of the imaging data, the attribute data, and the conversation data which are acquired in the acquisition step; and
a conversation step of having a conversation regarding the risk determined in the determination step with the customer.

The disclosures of Japanese Patent Application No. 2023-067458, Japanese Patent Application No. 2023-070392, Japanese Patent Application No. 2023-063774, Japanese Patent Application No. 2023-074836, Japanese Patent Application No. 2023-074697, Japanese Patent Application No. 2023-070472, Japanese Patent Application No. 2023-070473, Japanese Patent Application No. 2023-070474, Japanese Patent Application No. 2023-082611, Japanese Patent Application No. 2023-080390, Japanese Patent Application No. 2023-078142, and Japanese Patent Application No. 2023-078119 are incorporated herein by reference in their entireties.

All documents, patent applications, and technical standards mentioned herein are incorporated herein by reference to the same extent as if each individual document, patent application, and technical standard were specifically and individually stated.

1. An action control system, comprising:
a memory; and
at least one processor coupled to the memory, the at least one processor being configured to:
determine an emotion of a user or an emotion of a robot; and
generate an action content of the robot for an action of the user and the emotion of the user or the emotion of the robot based on a dialogue function of causing the user and the robot to have a dialogue with each other, and determines an action of the robot corresponding to the action content,
wherein the at least one processor determines whether or not the action of the user is dangerous by detecting the action of the user, and generates a first action content for correcting the action of the user in a case where the action of the user is dangerous.

2. The action control system according to claim 1, wherein the first action content includes at least one of making a gesture for correcting the action of the user and reproducing a speech for correcting the action of the user.

3. The action control system according to claim 2, wherein the at least one processor determines whether or not the action of the user has been corrected by detecting the action of the user after the robot makes the gesture or reproduces the speech, and generates a second action content different from the first action content in a case where the action of the user has been corrected.

4. The action control system according to claim 3, wherein the second action content includes at least one of a speech for praising the action of the user and a speech for expressing gratitude for the action of the user.

5. The action control system according to claim 2, wherein the at least one processor determines whether or not the action of the user has been corrected by detecting the action of the user after the robot makes the gesture or reproduces the speech, and generates a third action content different from the first action content in a case where the action of the user has not been corrected.

6. The action control system according to claim 5, wherein the third action content includes at least one of transmitting specific information to a person other than the user, making a gesture that draws an interest of the user, reproducing a sound that draws an interest of the user, and reproducing a video that draws an interest of the user.

7. The action control system according to claim 1, wherein the robot is mounted on a stuffed toy or is connected wirelessly or by wire to control target equipment mounted on a stuffed toy.

8. (canceled)

9. An action control system, comprising:
a memory; and
at least one processor coupled to the memory, the at least one processor being configured to:
recognize a user state including an action of a user;
determine an emotion of the user or an emotion of a robot; and
determine an action of the robot corresponding to the user state and a conversation content of a plurality of the users based on a sentence generation model having a dialogue function of causing the user and the robot to have a dialogue with each other,
wherein the at least one processor determines a special fraud risk based on the conversation content of the plurality of users and the emotions of the users.

10. (canceled)

11. (canceled)

12. An action control system, comprising:
a memory; and
at least one processor coupled to the memory, the at least one processor being configured to:
recognize a user state including an action of a user and a state of electronic equipment;
determine an emotion of the user or an emotion of the electronic equipment;
determine, as an action of the electronic equipment, any one of a plurality of types of equipment operations including performing no operation by using at least one of the user state, the state of the electronic equipment, the emotion of the user, and the emotion of the electronic equipment, and an action determination model at a predetermined timing; and
store, in history data, event data including an determined emotion value and data including the action of the user,
wherein
the equipment operation includes provision of advice on caregiving to the user, and
in a case where the at least one processor determines, as the action of the electronic equipment, to provide the advice on caregiving to the user, collects information regarding caregiving for the user and provides the advice on caregiving for the user based on the collected information.

13. (canceled)

14. (canceled)

15. (canceled)
